(19) United States
(12) Patent Application Publication
(10) Pub. No.: US 2024/0262635 A1
(43) Pub. Date: Aug. 8, 2024

(54) CONVEYANCE SYSTEM FOR MOVING OBJECT BASED ON IMAGE OBTAINED BY IMAGE CAPTURING DEVICE

(71) Applicant: Panasonic Intellectual Property Management Co., Ltd., Osaka (JP)

(72) Inventors: Tsukasa Okada, Osaka (JP); Tomohide ISHIGAMI, Osaka (JP); Yoshinari MATSUYAMA, Osaka (JP); Yuma YAMAKURA, Osaka (JP); Yuzuka ISOBE, Osaka (JP)

(21) Appl. No.: 18/635,298

(22) Filed: Apr. 15, 2024

Related U.S. Application Data
(63) Continuation of application No. PCT/JP22/36161, filed on Sep. 28, 2022.

(30) Foreign Application Priority Data
Oct. 27, 2021 (JP) 2021-175592

(51) Int. Cl. B65G 43/00

(52) U.S. Cl. CPC B65G 43/00; B65G 2203/041

(57) ABSTRACT

A storage device stores a first and a second feature point maps of an object in advance, the first feature point map detected by image processing not based on deep learning, and the second feature point map detected using a deep learning model trained in advance. A processing circuit detects first feature points of the object by the image processing on a captured image. The processing circuit detects second feature points of the object from the captured image using the deep learning model. The processing circuit calculates a position of a target object based on the first feature points and the first feature point map. When the position cannot be calculated based on the first feature points and the first feature point map, the processing circuit calculates the position of the target object based on the first and second feature points, and he first and second feature point maps.

### CROSS REFERENCE TO RELATED APPLICATION

This is a continuation application of International Application No. PCT/JP2022/036161, with an international filing date of Sep. 28, 2022, which claims priority of Japanese Patent Application No. 2021-175592 filed on Oct. 27, 2021, each of which is incorporated herein by reference.

### BACKGROUND

### 1. Technical Field

The present disclosure relates to a control apparatus and a control method for a conveyance apparatus, and relates to a conveyance system.

### 2. Description of Related Art

In order to solve the shortage of workers due to the low birth rate and the population aging, and in order to reduce labor costs, conveyance apparatuses, such as a robot arm apparatus or a robot hand apparatus, are used in various fields to automate works conventionally performed by a person. An operation of a conveyance apparatus may be controlled based on, for example, images of a work object captured by an image capturing device.

For example, International Application WO 2018/207426 A discloses estimating a position and an attitude of a target objected object in a real space, by extracting feature points and feature values from images captured by a plurality of image capturing units, and comparing the extracted feature points and feature values with feature points and feature values stored in advance. In addition, International Application WO 2017/168899 A discloses providing more accurate position information according to the actual environment, by associating a feature point list of coordinates and feature values for feature points, with environmental information, such as weather and lighting environment, and obtaining a recommended feature point list based on the environmental information.

### SUMMARY

In a case where an operation of a conveyance apparatus is controlled based on captured images, a feature point map is generated in advance, the feature point map including positions and feature values of feature points in a plurality of images obtained by capturing a work object from a plurality of different positions, and correspondence (matching) is determined between the feature points included in the captured image, and the feature points included in the feature point map. A position of the work object is estimated based on the feature point matching. However, in a case where environmental conditions vary, the conditions including weather, time, date, location and direction of the work object, etc., illuminance around the work object may vary. In a case where environmental conditions at the time of estimating a position of the work object using the feature point map vary from those at the time of when generating the feature point map, the feature point matching may fail, and as a result, the position of the work object may not be estimated.

In order to address variations in the environmental conditions, for example, it may be supposed to generate a plurality of feature point maps in advance based on images obtained by capturing a work object with a plurality of different illuminances. However, since it takes a long processing time to compare feature points included in the captured images with a large number of feature point maps, it is difficult to control a conveyance apparatus in real time. In addition, it takes much time and effort to create the large number of feature point maps in advance.

An object of the present disclosure is to provide a control apparatus and control method for a conveyance apparatus, capable of controlling the conveyance apparatus to accurately move an object, even when environmental conditions vary, without significantly increasing a processing time. In addition, another object of the present disclosure is to provide a conveyance system including such a control apparatus and a conveyance apparatus.

According to one aspect of the present disclosure, a control apparatus for controlling a conveyance apparatus that moves a first object is provided. The control apparatus is provided with: a processing circuit and a storage device. The storage device stores a first feature point map and a second feature point map in advance, the first feature point map including positions of feature points of a second object detected by performing first image processing on a plurality of images of the second object, the first image processing being not based on deep learning, and the second feature point map including positions of feature points of the second object detected using a first deep learning model trained in advance based on a plurality of images of the second object. The processing circuit sets a position of at least one target object in the second object. The processing circuit detects first feature points of the second object by performing the first image processing on a captured image including at least a part of the second object obtained by an image capturing device. The processing circuit detects second feature points of the second object from the captured image using the first deep learning model. The processing circuit calculates a position of the target object based on the first feature points and the first feature point map without referring to the second feature points and the second feature point map, and when the position of the target object can not be calculated based on the first feature points and the first feature point map without referring to the second feature points and the second feature point map, the processing circuit calculates the position of the target object based on the first feature points, the first feature point map, the second feature points, and the second feature point map. The processing circuit generates a control signal for moving the first object to the position of the target object, based on the position of the target object and the position of the first object, and outputs the control signal to the conveyance apparatus.

These general and specific aspects may be implemented by a system, a method, a computer program, and any combination of the system, the method, and the computer program.

According to one aspect of the present disclosure, it is possible to control the conveyance apparatus to accurately move the object, even when environmental conditions vary, without significantly increasing a processing time.

### BRIEF DESCRIPTION OF DRAWINGS

FIG. 1 is a schematic diagram illustrating a configuration of a robot arm system according to a first embodiment;

FIG. 2 is a partially enlarged view of a power screwdriver 5 and a marker 6 in FIG. 1;

FIG. 3 is a perspective view illustrating a circuit board 8 in FIG. 1;

FIG. 4 is a diagram illustrating feature points F included in the circuit board 8 in FIG. 3;

FIG. 5 is a block diagram illustrating a configuration of a control apparatus 1 in FIG. 1;

FIG. 6 is a block diagram illustrating a configuration of a feature point recognizer 11 in FIG. 5;

FIG. 7 is a diagram illustrating an example of a neural network used in a feature point recognizer 12 in FIG. 5;

FIG. 8 is a view illustrating an exemplary captured image 70 obtained by an image capturing device 7 in FIG. 1;

FIG. 9 is a diagram for explaining map points and key frames of a feature point map stored in a storage device 16 in FIG. 5;

FIG. 10 is a diagram illustrating an exemplary feature point map stored in the storage device 16 in FIG. 5;

FIG. 11 is a flowchart illustrating a robot arm control process executed by the control apparatus 1 in FIG. 1;

FIG. 12 is a flowchart illustrating a subroutine of step S4 (position calculation process for target object) in FIG. 11;

FIG. 13 is a diagram for explaining calculation of a position of a target object in a camera coordinate system, executed in step S13 in FIG. 12;

FIG. 14 is a flowchart illustrating a subroutine of step S12 (position calculation process based on first feature points) in FIG. 12;

FIG. 15 is a flowchart illustrating a subroutine of step S23 (global feature point matching process based on first feature points) in FIG. 14;

FIG. 16 is a diagram for explaining feature point matching executed in step S23 in FIG. 14, in which FIG. 16(a) illustrates a captured image 70A obtained by the image capturing device 7, and FIG. 16(b) illustrates a similar image 70B read from the storage device 16;

FIG. 17 is a flowchart illustrating a subroutine of step S30 (tracked feature point matching process based on first feature points) in FIG. 14;

FIG. 18 is a diagram for explaining prediction of a current capturing condition based on a previous capturing condition, executed in step S52 in FIG. 17;

FIG. 19 is a diagram for explaining feature point matching executed in step S30 in FIG. 14, in which FIG. 19(a) illustrates a current captured image 70C obtained by the image capturing device 7, and FIG. 19(b) illustrates a previous captured image 70D obtained by the image capturing device 7;

FIG. 20 is a flowchart illustrating subroutines of steps S25 and S32 (tracked feature point matching process based on first and second feature points) in FIG. 14;

FIG. 21 is a flowchart illustrating a subroutine of step S62 (key frame search process) in FIG. 20;

FIG. 22 is a flowchart illustrating a subroutine of step S15 (position calculation process based on second feature points) in FIG. 12;

FIG. 23 is a flowchart illustrating a subroutine of step S6 (position calculation process for holdable object) in FIG. 11;

FIG. 24 is a diagram for explaining calculation of a position of a tip of a holdable object in the camera coordinate system, executed in step S114 in FIG. 23;

FIG. 25 is a diagram illustrating an exemplary image 30 displayed on a display device 3 in FIG. 1;

FIG. 26 is a schematic diagram illustrating a configuration of a control apparatus 1A for a robot arm apparatus 4 according to a first modified embodiment of the first embodiment;

FIG. 27 is a schematic diagram illustrating a configuration of a control apparatus 1B for a robot arm apparatus 4 according to a second modified embodiment of the first embodiment;

FIG. 28 is a schematic diagram illustrating a configuration of a robot arm system according to a second embodiment;

FIG. 29 is a block diagram illustrating a configuration of a control apparatus 1C in FIG. 28;

FIG. 30 is a flowchart illustrating a robot arm control process executed by the control apparatus 1C in FIG. 28;

FIG. 31 is a flowchart illustrating a subroutine of step S6C (position calculation process for holdable object) in FIG. 30;

FIG. 32 is a view illustrating an exemplary image 30C displayed on a display device 3 in FIG. 28;

FIG. 33 is a schematic diagram illustrating a configuration of a robot arm system according to a third embodiment;

FIG. 34 is a block diagram illustrating a configuration of a control apparatus 1D in FIG. 33;

FIG. 35 is an enlarged view illustrating a tip of an arm 4b in FIG. 33;

FIG. 36 is a flowchart illustrating a robot arm control process executed by the control apparatus 1D in FIG. 33;

FIG. 37 is a schematic diagram illustrating a configuration of a conveyance system according to a fourth embodiment;

FIG. 38 is a block diagram illustrating a configuration of a vehicle 100 according to a fifth embodiment;

FIG. 39 is a block diagram illustrating a configuration of a control apparatus 101 in FIG. 38; and

FIG. 40 is a flowchart illustrating a vehicle control process executed by a position calculator 113 in FIG. 39.

### DETAILED DESCRIPTION

Hereinafter, embodiments according to the present disclosure will be described with reference to the drawings. In the following embodiments, the similar constituents are denoted by the same reference numerals.

### First Embodiment

Hereinafter, a robot arm system according to a first embodiment will be described.

A work object to be worked by a robot arm apparatus does not have a known position in a world coordinate system. In addition, when the robot arm apparatus holds some holdable object for a work on the work object, the holdable object also does not have a known position in the world coordinate system. Further, the positions of the work object and the holdable object may vary during work. For example, consider a case in which the robot arm apparatus holds a power screwdriver as the holdable object, and using the power screwdriver, inserts a screw into a screw hole of a circuit board as the work object, thus automatically fastening the circuit board to other components. In this case, the circuit board is not necessarily fixed to a workbench. In addition, the position of the power screwdriver held by the robot arm apparatus varies each time the power screwdriver is held. Therefore, the power screwdriver and the circuit board do not have known fixed positions in the world coordinate system.

When the position of the holdable object or the work object is unknown, it is not possible to accurately perform the work on the work object using the holdable object held by the robot arm apparatus. Therefore, even when at least one of the holdable object and the work object does not have a known fixed position in the world coordinate system, it is required to accurately perform the work on the work object using the holdable object held by the robot arm apparatus.

In the first embodiment, a robot arm system will be described which is capable of controlling the robot arm apparatus to accurately perform the work on the work object using the holdable object, even when at least one of the holdable object and the work object does not have a known fixed position in the world coordinate system.

### [Configuration of First Embodiment]

### [Overall Configuration]

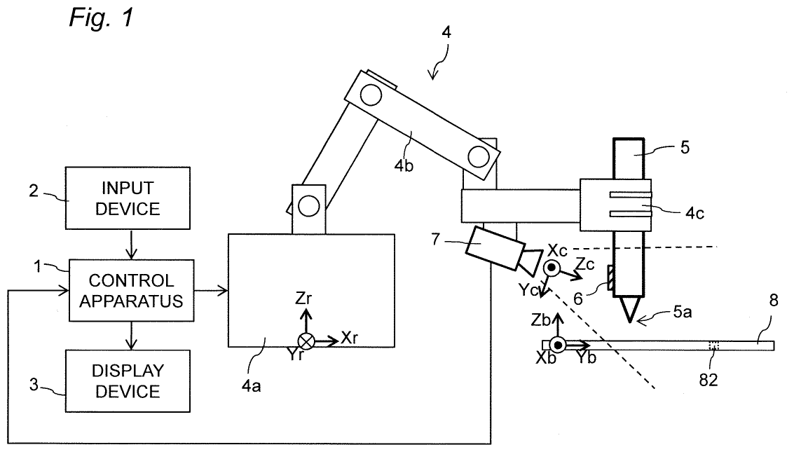

FIG. 1 is a schematic view illustrating a configuration of a robot arm system according to the first embodiment. The robot arm system in FIG. 1 is provided with: a control apparatus 1, an input device 2, a display device 3, a robot arm apparatus 4, a power screwdriver 5, a marker 6, an image capturing device 7, and a circuit board 8.

The robot arm apparatus 4 moves a holdable object held by the robot arm apparatus 4, to a position of at least one target object in a work object, under the control of the control apparatus 1. In the example of FIG. 1, the power screwdriver 5 is the holdable object (or “first object”) held by the robot arm apparatus 4, and the circuit board 8 is the work object (or “second object”) to be worked by the robot arm apparatus 4 using the power screwdriver 5. When at least one screw hole 82 in the circuit board 8 is set as the target object, the robot arm apparatus 4 moves the tip of the power screwdriver 5 to the position of the screw hole 82, and inserts a screw into the screw hole 82 using the power screwdriver 5 to fasten the circuit board 8 to other components. The robot arm apparatus 4 is an example of a conveyance apparatus that moves the first object to the position of the target object in the second object.

The control apparatus 1 controls the robot arm apparatus 4 holding the power screwdriver 5, based on a captured image obtained by the image capturing device 7, and/or based on user inputs inputted through the input device 2. The control apparatus 1 is, for example, a general-purpose personal computer or a dedicated apparatus.

The input device 2 includes a keyboard and a pointing device, and obtains user inputs for controlling the robot arm apparatus 4.

The display device 3 displays the captured image obtained by the image capturing device 7, the status of the robot arm apparatus 4, information related to the control of the robot arm apparatus 4, and others.

The input device 2 may be configured as a touch panel integrated with the display device 3.

The robot arm apparatus 4 is provided with: a main body 4a, an arm 4b, and a hand 4c. The main body 4a is fixed to a floor (or a wall, a ceiling, or the like). The hand 4c is coupled to the main body 4a via the arm 4b. In addition, the hand 4c holds an arbitrary item, e.g., the power screwdriver 5 in the example of FIG. 1. The arm 4b is provided with a plurality of links and a plurality of joints, and the links are rotatably coupled to each other via the joints. With such a configuration, the robot arm apparatus 4 can move the power screwdriver 5 within a predetermined range around the main body 4a.

As described above, the power screwdriver 5 is held by the hand 4c of the robot arm apparatus 4.

The marker 6 is fixed at a known position of the power screwdriver 5. The marker 6 is fixed to the power screwdriver 5 such that the image capturing device 7 can capture the marker 6 when the robot arm apparatus 4 holds the power screwdriver 5. The marker 6 has a pattern formed such that the direction and the distance of the marker 6 as seen from the image capturing device 7 can be calculated, in a manner similar to that of, for example, a marker used in the field of augmented reality (also referred to as “AR marker”).

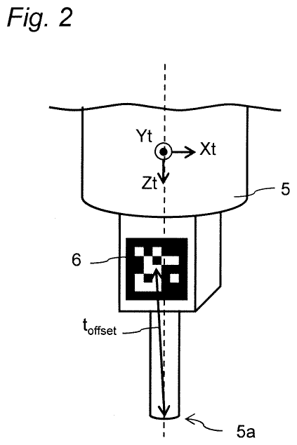

FIG. 2 is a partially enlarged view of the power screwdriver 5 and the marker 6 in FIG. 1. As described above, the marker 6 has a pattern formed such that the direction and the distance of the marker 6 as seen from the image capturing device 7 can be calculated. A tip 5a of the power screwdriver 5 has a known offset with respect to a predetermined position (for example, the center) of the marker 6. This offset is represented by a vector t_{offset}. Therefore, the relative position (i.e., the direction and the distance) of the tip 5a of the power screwdriver 5 with respect to the marker 6 is known, and therefore, if the position of the marker 6 is known, then it is possible to calculate the position (i.e., the direction and the distance) of the tip 5a of the power screwdriver 5. The power screwdriver 5 contacts with the circuit board 8 at the tip 5a thereof.

The image capturing device 7 obtains a captured image including the tip 5a of the power screwdriver 5 and at least a part of the circuit board 8. The image capturing device 7 may be a monocular camera or the like, without function of detecting distances from the image capturing device 7 to points captured by the image capturing device 7. Further, the image capturing device 7 may be a stereo camera, an RGB-D camera, or the like, capable of detecting distances from the image capturing device 7 to points captured by the image capturing device 7. The image capturing device 7 may capture still images at predetermined time intervals, or may extract frames at predetermined time intervals from a series of frames of a video. The image capturing device 7 gives, to each image, a time stamp of the time when the image is captured.

The image capturing device 7 may be fixed to the robot arm apparatus 4 such that when the robot arm apparatus 4 holds the power screwdriver 5, a relative position of the image capturing device 7 with respect to the power screwdriver 5 is fixed, and the image capturing device 7 can capture the tip 5a of the power screwdriver 5. In this case, the image capturing device 7 is fixed to the same link as that to which the hand 4c is connected, among the plurality of links of the arm 4b. As a result, there is no movable part, such as the joint of the arm 4b, between the image capturing device 7 and the hand 4c, and therefore, the relative position of the image capturing device 7 with respect to the power screwdriver 5 is fixed when the robot arm apparatus 4 holds the power screwdriver 5. Further, if the image capturing device 7 can capture the tip 5a of the power screwdriver 5 and the marker 6 when the robot arm apparatus 4 holds the power screwdriver 5, the image capturing device 7 may be fixed to the robot arm apparatus 4 such that the relative position of the image capturing device 7 with respect to the power screwdriver 5 may vary.

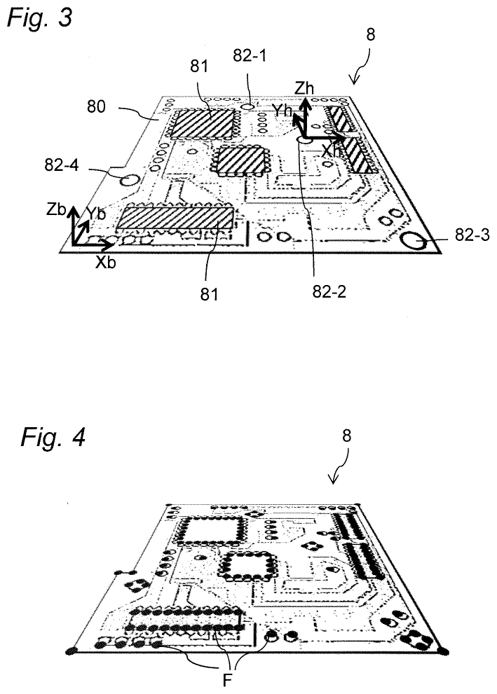

FIG. 3 is a perspective view illustrating the circuit board 8 in FIG. 1. The circuit board 8 is provided with a printed wiring board 80, a plurality of circuit elements 81, and a plurality of screw holes 82-1 to 82-4 (also collectively referred to as the “screw hole 82”). In the present embodiment, at least one of the screw holes 82-1 to 82-4 is set as the target object.

FIG. 4 is a diagram illustrating feature points F included in the circuit board 8 in FIG. 3. The feature points F are points whose luminance or color can be distinguished from that of surrounding pixels, and whose positions can be accurately determined. The feature points F are detected from, for example, vertices or edges of structures, such as the printed wiring board 80, the circuit elements 81, and the screw holes 82.

The circuit board 8 is disposed on a workbench, a belt conveyor, or the like (not shown).

In order to describe the operation of the robot arm system in FIG. 1, reference is made to a plurality of coordinate systems, that is, a coordinate system of the robot arm apparatus 4, a coordinate system of the image capturing device 7, a coordinate system of the power screwdriver 5, a work object coordinate system, and a coordinate system of the screw hole 82.

As shown in FIG. 1, the robot arm apparatus 4 has a three-dimensional coordinate system based on the position or attitude of a non-movable part of the apparatus, such as the main body 4a or a base (“coordinate system of robot arm apparatus” or “world coordinate system”). The world coordinate system has coordinate axes Xr, Yr, and Zr. For example, the origin of the world coordinate system is provided at the center of the bottom surface of the main body 4a of the robot arm apparatus 4, and the direction of the world coordinate system is set such that two of the coordinate axes are parallel to the floor, and the remaining one coordinate axis is perpendicular to the floor.

In addition, as shown in FIG. 1, the image capturing device 7 has a three-dimensional coordinate system based on the position and the attitude of the image capturing device 7 {hereinafter referred to as “coordinate system of image capturing device” or “camera coordinate system”). The camera coordinate system has coordinate axes Xc, Yc, and Zc. For example, the origin of the camera coordinate system is provided on the optical axis of the image capturing device 7, and the direction of the camera coordinate system is set such that one of the coordinate axes matches with the optical axis, and the remaining two coordinate axes are perpendicular to the optical axis. The position in the camera coordinate system indicates a position as seen from the image capturing device 7.

Furthermore, as shown in FIG. 2, the power screwdriver 5 has a three-dimensional coordinate system based on the position and the attitude of the power screwdriver 5 {hereinafter referred to as “holdable object coordinate system”). The holdable object coordinate system has coordinate axes Xt, Yt, and Zt. For example, the origin of the holdable object coordinate system is provided at the center of the power screwdriver 5, and the direction of the holdable object coordinate system is set such that one of the coordinate axes matches with the rotation axis of the tip 5a of the power screwdriver 5, and the remaining two coordinate axes are perpendicular to the rotation axis. Further, the origin of the holdable object coordinate system may be provided at the tip 5a of the power screwdriver 5.

In addition, as shown in FIGS. 1 and 3, the circuit board 8 has a three-dimensional coordinate system based on the position and the attitude of the circuit board 8 {hereinafter referred to as “work object coordinate system”). The work object coordinate system has coordinate axes Xb, Yb, and Zb. For example, the origin and the direction of the work object coordinate system may be set based on design data of the circuit board 8. In this case, the origin of the work object coordinate system may be set at any position on the circuit board 8, and the direction of the work object coordinate system may be set such that the coordinate axes are parallel or perpendicular to the sides of the circuit board 8. In addition, the origin and the direction of the work object coordinate system may be set based on a key frame obtained when generating a feature point map of the circuit board 8 as described below. In this case, the origin of the work object coordinate system may be provided on the optical axis of the image capturing device 7 associated with a key frame firstly obtained when generating a feature point map of the circuit board 8, and the direction of the work object coordinate system may be set such that one of the coordinate axes matches with the optical axis of the image capturing device 7 associated with the same key frame, and the remaining two coordinate axes are perpendicular to the optical axis.

In addition, as shown in FIG. 3, each screw hole 82 set as a target object has a three-dimensional coordinate system based on the position and the direction of the screw hole 82 {hereinafter referred to as “target object coordinate system”). FIG. 3 shows a case where the screw hole 82-2 is set as the target object. The target object coordinate system has coordinate axes Xh, Yh, and Zh. For example, the origin of the target object coordinate system is provided at the center of the screw hole 82-2, and the direction of the target object coordinate system is set such that two of the coordinate axes are parallel to the surface of the circuit board 8, and the remaining one coordinate axis is set perpendicular to the surface of the circuit board 8.

The positions of the origins and the directions of the coordinate axes of the world coordinate system, the camera coordinate system, the holdable object coordinate system, the work object coordinate system, and the target object coordinate system shown in FIGS. 1 to 3 are merely examples, and these coordinate systems may have different positions of the origin and/or different directions of the coordinate axes.

Since the position of the power screwdriver 5 in the camera coordinate system varies each time the robot arm apparatus 4 holds the power screwdriver 5, the power screwdriver 5 does not have a known position in the camera coordinate system.

### [Configuration of Control Apparatus]

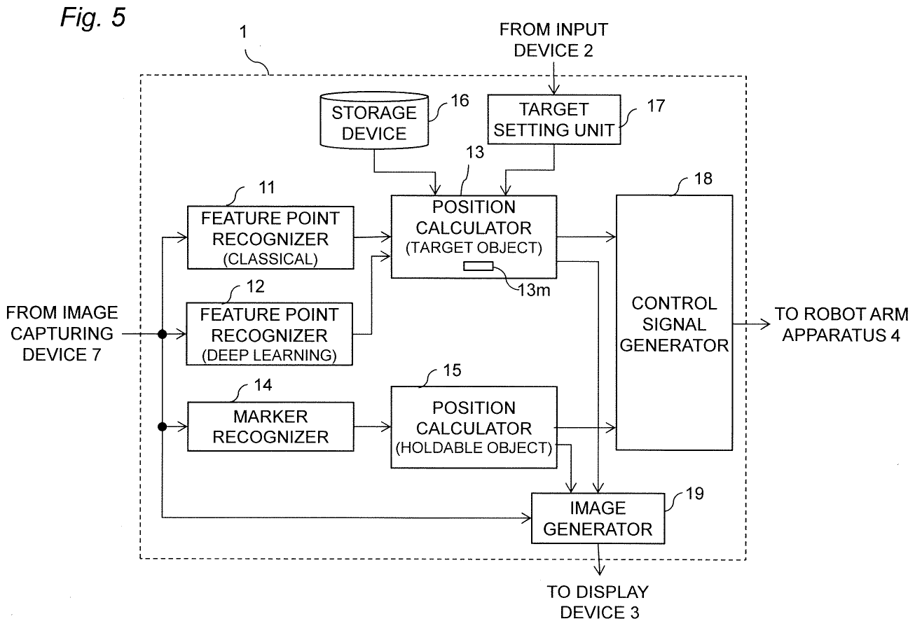

FIG. 5 is a block diagram illustrating a configuration of the control apparatus 1 in FIG. 1. The control apparatus 1 is provided with: a feature point recognizer (first feature point recognizer) 11, a feature point recognizer (second feature point recognizer) 12, a position calculator (first position calculator) 13, a marker recognizer 14, a position calculator (second position calculator) 15, a storage device (first storage device) 16, a target setting unit 17, a control signal generator 18, and an image generator 19.

The control apparatus 1 obtains a captured image obtained by the image capturing device 7, the captured image including the tip 5a of the power screwdriver 5 and at least a part of the circuit board 8.

The feature point recognizer 11 detects first feature points of the circuit board 8 by performing classical image processing on the captured image obtained by the image capturing device 7, the classical image processing being not based on deep learning, the captured image including at least a part of the circuit board 8 and the tip 5a of the power screwdriver 5. Classical image processing not based on deep learning includes, for example, Scale Invariant Feature Transform (SIFT), or Oriented FAST and Rotated BRIEF (ORB). The feature point recognizer 11 calculates a position and a feature value of each feature point included in the captured image. The feature value is, for example, a feature vector calculated from pixels within a predetermined region near a feature point in an image, under a certain rule. The feature value is used to determine whether or not a feature point included in an image corresponds to a feature point included in another image (that is, whether or not the feature points are of the same pixel).

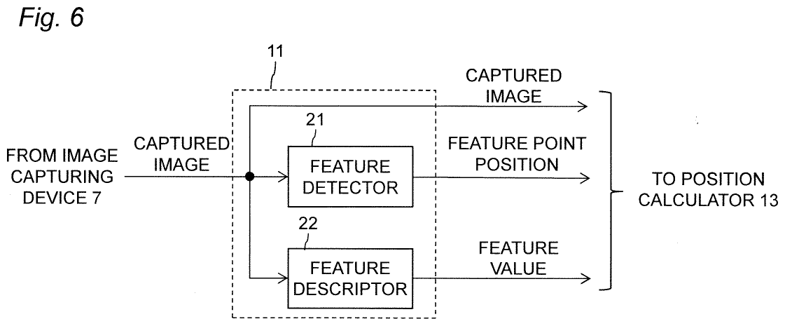

FIG. 6 is a block diagram illustrating a configuration of the feature point recognizer 11 in FIG. 5. In this case, an exemplary case is described where the feature point recognizer 11 detects feature points using the ORB. The feature point recognizer 11 is provided with a feature detector 21 and a feature descriptor 22. The feature detector 21 calculates positions of the feature points in the captured image, by performing Features from Accelerated Segment Test (FAST) on the captured image inputted from the image capturing device 7. The feature descriptor 22 calculates feature values of the feature points, by performing Binary Robust Independent Elementary Features (BRIEF) on the captured image inputted from the image capturing device 7.

The feature point recognizer 11 sends the positions and the feature values of the detected feature points to the position calculator 13, and further sends the captured image inputted from the image capturing device 7, to the position calculator 13, without any change.

The feature point recognizer 12 detects second feature points of the circuit board 8 from the captured image using a deep learning model trained in advance based on a plurality of images of the circuit board 8. The deep learning model may be trained according to, for example: SuperPoint in Daniel DeTone, et al., “SuperPoint: Self-Supervised Interest Point Detection and Description”, CVPR 2018 Deep Learning for Visual SLAM Workshop, [retrieved on Sep. 30, 2021], Internet <URL: https://arxiv.org/abs/1712.07629>; or D2-Net in Mihai Dusmanu, et al., “D2-Net: A Trainable CNN for Joint Detection and Description of Local Features”, CVPR 2019, [retrieved on Sep. 30, 2021], Internet <URL: https://arxiv.org/abs/1905.03561>. The deep learning model may be trained based on the plurality of images obtained by capturing the circuit board 8 from a plurality of different positions. Further, the deep learning model may be trained based on the plurality of images obtained by capturing the circuit board 8 with a plurality of different illuminances. By training the deep learning model based on the plurality of captured images obtained by capturing the circuit board 8 from the plurality of different positions, it is possible to obtain deep learning data robust to variations in relative positions of the image capturing device 7 and the circuit board 8. Further, by training the deep learning model based on the plurality of captured images obtained by capturing the circuit board 8 with the plurality of different illuminances, it is possible to obtain deep learning data robust to variations in environmental conditions. Therefore, by training based on the plurality of captured images having different capturing positions and different illuminances, it is possible to obtain deep learning data robust to variations in both relative positions and environmental conditions.

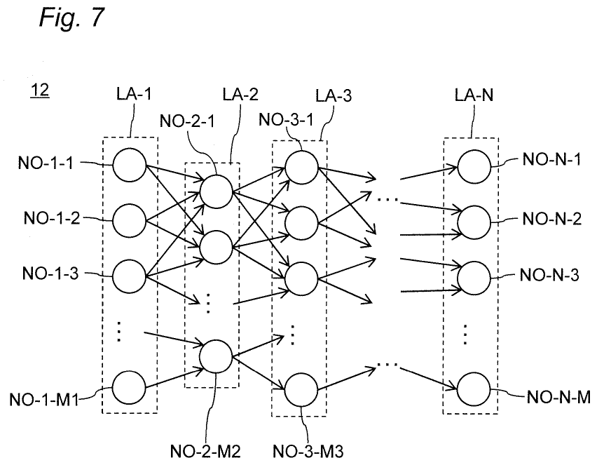

FIG. 7 is a diagram illustrating an example of a neural network used in the feature point recognizer 12 in FIG. 5. The deep learning model may is provided with a deep neural network including three or more layers as illustrated in FIG. 7. The neural network in FIG. 7 is provided with: nodes NO-1-1 to NO-1-M1 of an input layer LA-1, nodes NO-2-1 to NO-2-M2 of an intermediate layer LA-2, nodes NO-3-1 to NO-3-M3 of an intermediate layer LA-3, . . . , and nodes NO-N-1 to NO-N-M of an output layer LA-N. The neural network is trained in advance such that, when pixel values of the whole or a part of a captured image are inputted to the input layer LA-1, positions and feature values of feature points included in the captured image are outputted from the output layer LA-N. Each node of the intermediate layer LA-2 is set with weighting coefficients trained in advance so as to output the positions and the feature values of the feature points in response to the inputted captured image. The deep learning model may be trained with or without training data. The feature point recognizer 12 is implemented using certain hardware, software, or a combination thereof so as to operate as the deep neural network in FIG. 7.

The deep learning model is not limited to the models of Daniel DeTone, et al and Mihai Dusmanu, et al., and any other model can be used. In order to obtain positions of feature points, for example, a technique similar to segmentation of deep learning can be used. Specifically, positions of feature points may be determined by expressing a probability that each pixel of the inputted captured image can be used as a feature point. In addition, in order to obtain feature values, for example, a technique similar to metric learning of deep learning can be used. Specifically, a feature vector may be generated based on a part of the captured image centered at a feature point, thus distinguishing whether the feature point is similar to or different from other feature points.

The feature point recognizer 12 sends the positions and the feature values of the detected feature points to the position calculator 13.

The feature point recognizers 11 and 12 operate in parallel to detect the first and second feature points from the same captured image, respectively. Since the feature point recognizers 11 and 12 detect feature points using different algorithms, a set of first feature points detected from a certain captured image is different from a set of second feature points detected from the same captured image. In general, the feature point recognizer 12 using the deep learning model detects more feature points than those of the feature point recognizer 11 using classical image processing not based on deep learning. It should be noted that the detection of the second feature points by the feature point recognizer 12 takes more computational complexity and longer processing time than those of the detection of the first feature points by the feature point recognizer 11.

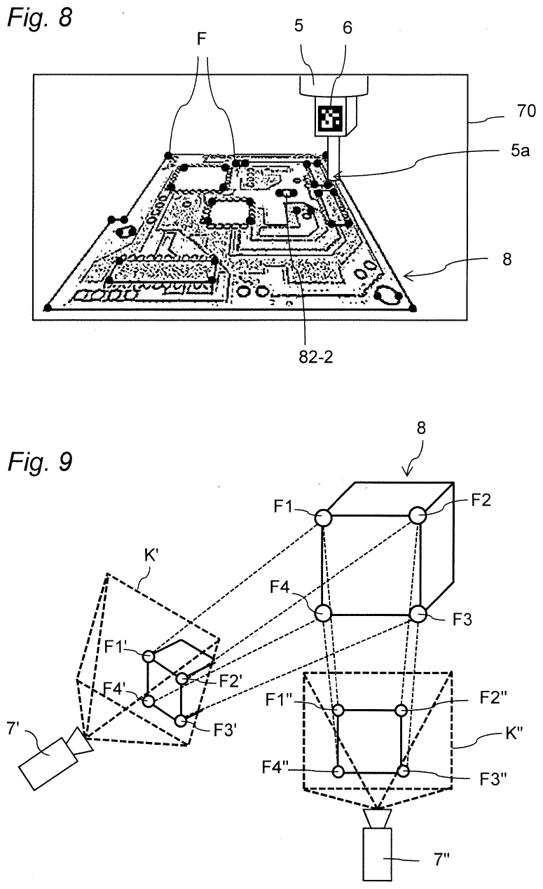

FIG. 8 illustrates an exemplary captured image 70 obtained by the image capturing device 7 in FIG. 1. In the example in FIG. 8, the captured image 70 includes the circuit board 8 and the tip 5a of the power screwdriver 5. For purpose of explanation, FIG. 8 further illustrates the feature points F of the circuit board 8 detected by the feature point recognizer 11 or 12.

The storage device 16 stores in advance a first feature point map including positions and feature values of feature points of the circuit board 8 detected by performing the image processing on a plurality of images of the circuit board 8, the image processing being not based on deep learning, in a manner similar to that of the feature point recognizer 11. In addition, the storage device 16 stores in advance a second feature point map including positions and feature values of feature points of the circuit board 8 detected using the deep learning model trained in advance based on a plurality of images of the circuit board 8, in a manner similar to that of the feature point recognizer 12. Each of the first and second feature point maps includes a plurality of map points and a plurality of key frames, related to the plurality of feature points included in the circuit board 8. Each map point includes a position (three-dimensional coordinates) of a feature point of the circuit board 8 in the work object coordinate system, a feature value of the feature point, and an index number of the feature point. The index number is uniquely assigned to distinguish the feature point. The map points are generated based on a plurality of images obtained by capturing the circuit board 8 from a plurality of different positions. Each key frame indicates a status of the image capturing device 7 at which the circuit board 8 is captured from one of the different positions to generate the map points, and also indicates a captured image. That is, each key frame includes the position (three-dimensional coordinates) and the attitude of the image capturing device 7 in the work object coordinate system, the positions (two-dimensional coordinates) of the feature points in one of the images of the circuit board 8, and the index numbers of the map points corresponding to the feature points in one of the images.

The first feature point map is generated from a plurality of images of the circuit board 8 provided in advance (also referred to as “first reference images”). In addition, the first feature point map includes a plurality of feature points (also referred to as “first reference feature points”) to be compared (matched) with the first feature points in the captured image detected by the feature point recognizer 11. Similarly, the second feature point map is generated from a plurality of images of the circuit board 8 provided in advance (also referred to as “second reference images”). In addition, the second feature point map includes a plurality of feature points (also referred to as “second reference feature points”) to be compared (matched) with the second feature points in the captured image detected by the feature point recognizer 12. The first and second feature point maps may be generated from the same set of images of the circuit board 8, or may be generated from different sets of images, respectively. In addition, the plurality of images of the circuit board 8 for generating the first and second feature point maps may be obtained by an image capturing device having the same model number and the same specifications as those of the image capturing device 7, or may be obtained by other one or more image capturing devices.

As described above, since a set of first feature points detected from a certain captured image are different from a set of second feature points detected from the same captured image, the map points and the key frames of the first feature point map are different from the map points and the key frames of the second feature point map.

Hereinafter, the map points of the first feature point map will be referred to as “first map points”, and the map points of the second feature point map will be referred to as “second map points”. The key frames of the first feature point map will be referred to as “first key frames” or “key frames K1”, and the key frames of the second feature point map will be referred to as “second key frames” or “key frames K2”.

FIG. 9 is a diagram illustrating map points and key frames of the feature point map stored in the storage device 16 in FIG. 5. In the example in FIG. 9, the circuit board 8 having feature points F1 to F4 is schematically illustrated. In this case, the map points include positions (three-dimensional coordinates) of the feature points F1 to F4 of the circuit board 8 in the work object coordinate system, feature value of the feature points, and index numbers of the feature points. The key frame K′ indicates a status of the image capturing device 7 at which the circuit board 8 is captured from a first position (indicated as an image capturing device 7′), and indicates a captured image. The captured image from the image capturing device 7′ includes first or second feature points F1′ to F4′ corresponding to the feature points F1 to F4 of the circuit board 8, respectively. That is, the key frame K′ includes a position (three-dimensional coordinates) and an attitude of the image capturing device 7′ in the work object coordinate system, positions (two-dimensional coordinates) of the feature points F1′ to F4′ in the captured image, and index numbers of map points corresponding to the feature points F1′ to F4′ in the captured image. In addition, the key frame K″ indicates a status of the image capturing device 7 at which the circuit board 8 is captured from a second position (indicated as the image capturing device 7″), and indicates a captured image. The captured image from the image capturing device 7″ includes first or second feature points F1″ to F4″ corresponding to the feature points F1 to F4 of the circuit board 8, respectively. That is, the key frame K″ includes a position (three-dimensional coordinates) and an attitude of the image capturing device 7″ in the work object coordinate system, positions (two-dimensional coordinates) of the feature points F1″ to F4″ in the captured image, and index numbers of map points corresponding to the feature points F1″ to F4″ in the captured image.

The feature point F1′ included in the key frame K′ and the feature point F1″ included in the key frame K″ indicate the same feature point F1 included in the map points, and thus, ideally, these feature points have the same feature value. Therefore, the common index number representing the feature point F1 among the map points is assigned to the feature point F1′ on the key frame K′, and to the feature point F1″ on the key frame K″.

The storage device 16 may store the captured images themselves, which are obtained to generate the map points, in association with the key frames, respectively.

Each of the first and second feature point maps is generated using, for example, Visual Simultaneous Localization and Mapping (Visual-SLAM), based on a plurality of captured images obtained by capturing the circuit board 8 from a plurality of different positions. According to Visual-SLAM, the positions of the map points are calculated as follows.

(1) The feature points of the circuit board 8 are detected from the captured image obtained by the image capturing device 7 having a predetermined position and attitude. A translation vector T1 and a rotation matrix R1, indicating the position and the attitude of the image capturing device 7 occurring when capturing the detected feature points, are calculated with reference to a point having known three-dimensional coordinates.

(2) The image capturing device 7 is moved, and then, the feature points of the circuit board 8 are detected from the captured image obtained by the image capturing device 7 having a different position and a different attitude. A translation vector T2 and a rotation matrix R2, indicating the position and the attitude of the image capturing device 7 occurring when capturing the detected feature points, are calculated with reference to the point having known three-dimensional coordinates.

(3) The three-dimensional coordinates of the map points corresponding to the feature points included in both the captured images obtained before and after the movement of the image capturing device 7 are calculated.

(4) The image capturing device 7 is moved, and then, the feature points of the circuit board 8 are detected from the captured image obtained by the image capturing device 7 having a further different position and a further different attitude. A translation vector T3 and a rotation matrix R3, indicating the position and the attitude of the image capturing device 7 occurring when capturing the detected feature points, are calculated with reference to the point having known three-dimensional coordinates. Thereafter, steps (3) to (4) are repeatedly performed.

Scales of the first and second feature point maps, that is, distances among the feature points of the circuit board 8 in the work object coordinate system may be calibrated based on, for example, design data of the circuit board 8.

In order to generate the first and second feature point maps, other image processing and positioning techniques, such as Structure from Motion (SfM), may be used instead of Visual-SLAM.

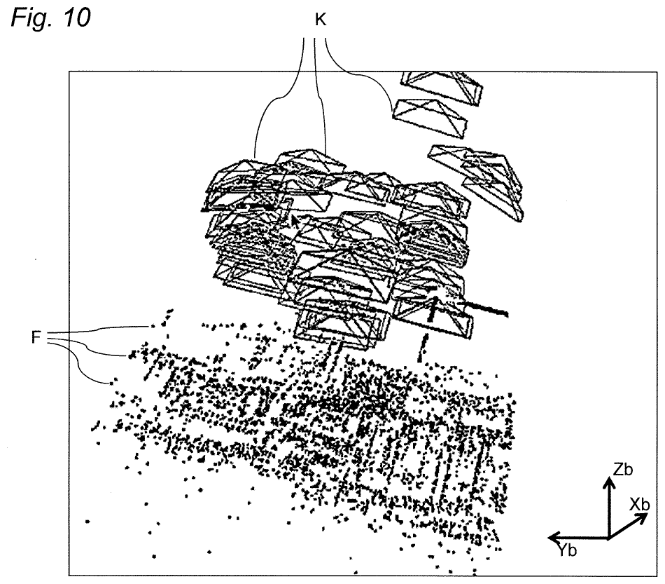

FIG. 10 is a diagram illustrating an exemplary feature point map stored in the storage device 16 in FIG. 5. FIG. 10 is a perspective view of a three-dimensional plot of positions (three-dimensional coordinates) of the feature points F of the map points, and positions (three-dimensional coordinates) and attitudes of the image capturing device 7 associated with the plurality of key frames K. It is assumed that the image capturing device 7 captures the circuit board 8 in various positions and attitudes during operation of the robot arm apparatus 4, and each of the first and second feature point maps includes a large number of keyframes K.

The target setting unit 17 sets the position of at least one screw hole 82 in the circuit board 8, as the position of the target object. The target setting unit 17 sets a target object by selecting at least one of the plurality of map points stored in the storage device 16, based on, for example, user inputs obtained through the input device 2. The target setting unit 17 may store information on the target object having been set, in the storage device 16.

The position calculator 13 calculates a position and a direction of the screw hole 82 in the camera coordinate system, based on the first feature points of the circuit board 8 detected by the feature point recognizer 11, and the second feature points of the circuit board 8 detected by the feature point recognizer 12, and with reference to the first and second feature point maps read from the storage device 16. At first, the position calculator 13 calculates the position and the direction of the screw hole 82 based on the first feature points and the first feature point map without referring to the second feature points and the second feature point map. When the position and the direction of the screw hole 82 can not be calculated based on the first feature points and the first feature point map without referring to the second feature points and the second feature point map, the position calculator 13 calculates the position and the direction of the screw hole 82 based on the first feature points, the first feature point map, the second feature points, and the second feature point map. The direction of the screw hole 82 is represented by, for example, a direction of an axis passing through the screw hole 82 and perpendicular to the surface of the circuit board 8.

In addition, as will be detailed below, the position calculator 13 refers to a capturing condition indicating the three-dimensional position and attitude of the image capturing device 7 at which the captured image is obtained, in order to calculate the position and the direction of the screw hole 82 in the camera coordinate system. To this end, based on the first feature points and the first feature point map, the position calculator 13 calculates a first capturing condition indicating the position and the attitude of the image capturing device 7 at which the captured image is obtained, and performs matching between the first feature points detected from the captured image, and the feature points of the first feature point map. The first capturing condition indicates the position and the attitude of the image capturing device 7 in the work object coordinate system. In addition, based on the second feature points and the second feature point map, the position calculator 13 calculates a second capturing condition indicating the position and the attitude of the image capturing device 7 at which the captured image is obtained, and performs matching between the second feature points detected from the captured image, and the feature points of the second feature point map. The second capturing condition also indicates the position and the attitude of the image capturing device 7 in the work object coordinate system. The position calculator 13 is provided with a memory 13m that stores the first and second capturing conditions, and feature point matching results.

The marker recognizer 14 detects, from the captured image, the marker 6 fixed at the known position of the power screwdriver 5.

Based on an image of the marker 6 recognized by the marker recognizer 14, the position calculator 15 calculates a direction of the power screwdriver 5 in the camera coordinate system, and calculates a position of the tip 5a of the power screwdriver 5 in the camera coordinate system. The direction of the power screwdriver 5 is represented by, for example, a direction of the rotation axis of the tip 5a of the power screwdriver 5.

The control signal generator 18 transforms the position and direction of the screw hole 82 in the camera coordinate system calculated by the position calculator 13, into a position and a direction in the world coordinate system. In addition, the control signal generator 18 transforms the direction of the power screwdriver 5 and the position of the tip 5a of the power screwdriver 5 in the camera coordinate system calculated by the position calculator 15, into a direction and a position in the world coordinate system. Since the robot arm apparatus 4 operates under the control of the control apparatus 1, and the image capturing device 7 is fixed to the arm 4b of the robot arm apparatus 4, the image capturing device 7 has a known position and attitude in the world coordinate system. Therefore, the control signal generator 18 can transform the coordinates of the screw hole 82 and the power screwdriver 5, based on the position and the attitude of the image capturing device 7. In addition, the control signal generator 18 outputs a control signal to the robot arm apparatus 4 based on the transformed position and direction of the screw hole 82, the transformed direction of the power screwdriver 5, and the transformed position of the tip 5a of the power screwdriver 5, the control signal for moving the tip 5a of the power screwdriver 5 to the position of the screw hole 82. Consequently, the control apparatus 1 automatically controls the robot arm apparatus 4.

In response to the control signal from the control apparatus 1, the robot arm apparatus 4 moves the tip 5a of the power screwdriver 5 to the screw hole 82, such that the power screwdriver 5 has a predetermined angle with respect to the screw hole 82. In this case, the robot arm apparatus 4 moves the tip 5a of the power screwdriver 5 to the screw hole 82, such that, for example, the direction of the power screwdriver 5 matches with the direction of the screw hole 82.

The image generator 19 outputs the captured image to the display device 3. In addition, the image generator 19 may output the feature points of the circuit board 8, the position of the screw hole 82, and the position of the tip 5a of the power screwdriver 5, to the display device 3, such that the feature points of the circuit board 8, the position of the screw hole 82, and the position of the tip 5a of the power screwdriver 5 overlap the captured image.

At least a part of the constituents 11 to 19 of the control apparatus 1 may be integrated with each other. The constituents 11 to 15 and 17 to 19 of the control apparatus 1 may be implemented as dedicated circuits, or may be implemented as programs executed by a general-purpose processor.

### [Operation of First Embodiment]

As described above, in a case where environmental conditions, such as weather, time, date, and location and direction of a work object, vary, illuminance around the work object may vary. Classical image processing not based on deep learning can be executed at high speed, but when the illuminance varies, it becomes likely to fail to calculate a position of a target object based on the first feature points detected using such classical image processing. On the other hand, calculation of a position of a target object based on the second feature points detected using the deep learning model is less likely to be affected by variations in illuminance, and can be performed more reliably, but it requires more computational complexity and longer processing time than those of the classical image processing. Therefore, while using both the classical image processing and the deep learning model, it is required to control the robot arm apparatus to accurately move a holdable object and perform a work on a work object, even when environmental conditions vary, without significantly increasing the processing time. Hereinafter, an operation of the control apparatus for the robot arm apparatus according to the present embodiment will be described, which solves the above-described problem.

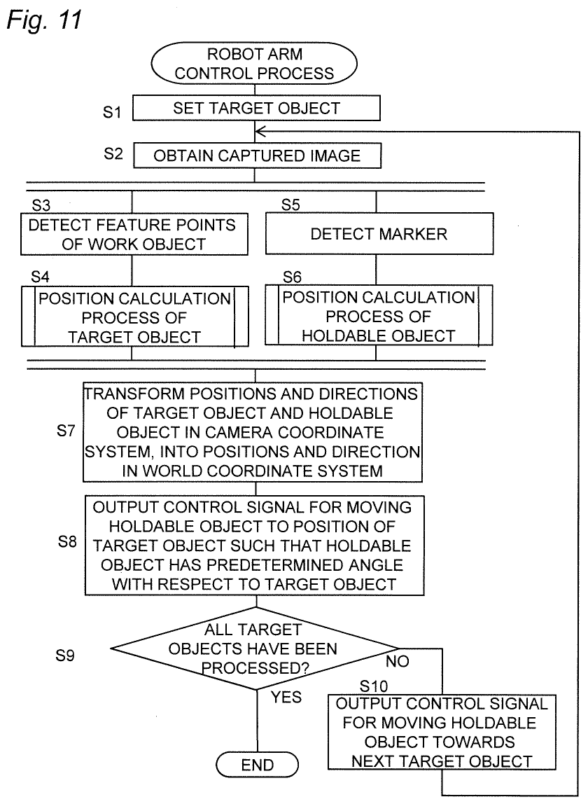

FIG. 11 is a flowchart illustrating a robot arm control process executed by the control apparatus 1 in FIG. 1.

The target setting unit 17 sets at least one screw hole 82 in the circuit board 8, as a target object (step S1).

Next, the control apparatus 1 obtains a captured image from the image capturing device 7 (step S2). In the following description, the control apparatus 1 extracts frames at predetermined time intervals from a series of frames of a video captured by the image capturing device 7, and processes the extracted frames as captured images.

The feature point recognizer 11 detects first feature points of the circuit board 8 from the captured image, and the feature point recognizer 12 detects second feature points of the circuit board 8 from the captured image (step S3).

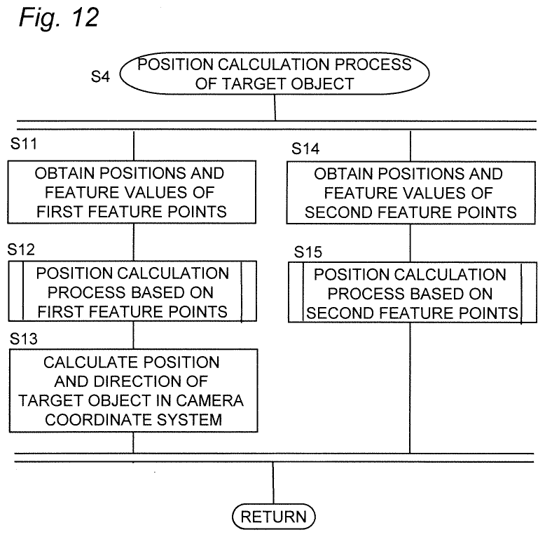

Next, the position calculator 13 executes a position calculation process for target object, to calculate a position and a direction of the screw hole 82 in the camera coordinate system (step S4). The position calculation process for target object will be described below with reference to FIG. 12.

The marker recognizer 14 detects an image of the marker 6 from the captured image (step S5).

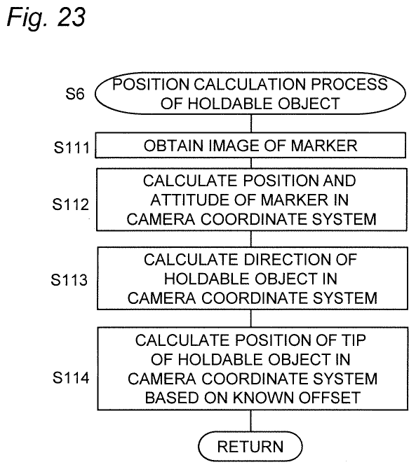

Next, the position calculator 15 executes a position calculation process for holdable object, to calculate a direction of the power screwdriver 5 and a position of the tip 5a of the power screwdriver 5 in the camera coordinate system (step S6). The position calculation process for holdable object will be described below with reference to FIG. 23.

Steps S3 to S6 may be executed in parallel as illustrated in FIG. 11, or may be executed sequentially.

Next, the control signal generator 18 transforms the position and the direction of the screw hole 82, the direction of the power screwdriver 5, and the position of the tip 5a of the power screwdriver 5 in the camera coordinate system, into positions and directions in the world coordinate system (step S7).

The coordinate transformation from a position (xc, yc, zc) in the camera coordinate system to a position (xr, yr, zr) in the world coordinate system is expressed, for example, using a homogeneous coordinate transformation matrix, as follows.

$$\begin{matrix}[ Mathematical Expression 1 ] & \\ ( \begin{matrix}x r \\ y r \\ z r \\ 1\end{matrix} ) = {( \begin{matrix}{R}_{c r} & {t}_{c r} \\ 0 & 1\end{matrix} )}^{- 1} ( \begin{matrix}x c \\ y c \\ zc \\ 1\end{matrix} ) & ( 1 )\end{matrix}$$

Here, R_{cr} denotes a matrix indicating a direction of the world coordinate system with reference to the direction of the camera coordinate system, and t_{cr} denotes a vector indicating a position of the origin of the world coordinate system in the camera coordinate system. The matrix R_{cr} can be decomposed into matrices R_{α}, R_{β}, and R_{γ} representing rotation angles α, β, and γ around the X axis, the Y axis, and the Z axis, respectively.

$$\begin{matrix}[ Mathematical Expression 2 ] & \\ {R}_{cr} = {R}_{α} {R}_{β} {R}_{γ} & ( 2 )\end{matrix}$$

$$\begin{matrix}[ Mathematical Expression 3 ] & \\ {R}_{α} = ( \begin{matrix}1 & 0 & 0 \\ 0 & cos α & - sin α \\ 0 & sin α & cos α\end{matrix} ) & ( 3 )\end{matrix}$$

$$\begin{matrix}[ Mathematical Expression 4 ] & \\ {R}_{β} = ( \begin{matrix}cos β & 0 & sin β \\ 0 & 1 & 0 \\ - sin β & 0 & cos β\end{matrix} ) & ( 4 )\end{matrix}$$

$$\begin{matrix}[ Mathematical Expression 5 ] & \\ {R}_{γ} = ( \begin{matrix}cos γ & - sin γ & 0 \\ sin γ & cos γ & 0 \\ 0 & 0 & 1\end{matrix} ) & ( 5 )\end{matrix}$$

The matrix R_{cr} and the vector t_{cr} can be obtained from design data of the robot arm apparatus 4, and from a current status (that is, the content of a control signal).

Next, the control signal generator 18 outputs a control signal for moving the tip 5a of the power screwdriver 5 to the position of the screw hole 82, such that the power screwdriver 5 has a predetermined angle with respect to the screw hole 82 (for example, the direction of the power screwdriver 5 matches with the direction of the screw hole 82) (step S8).

The control apparatus 1 may repeatedly execute steps S2 to S8, while moving the tip 5a of the power screwdriver 5 to the position of the screw hole 82.

When a plurality of screw holes 82 in the circuit board 8 are set as target objects, the control signal generator 18 determines whether or not all the target objects have been processed (step S9): if YES, the process ends; and if NO, the process proceeds to step S10.

The control signal generator 18 outputs a control signal for moving the tip 5a of the power screwdriver 5 toward the next screw hole 82 (step S10). Thereafter, the control apparatus 1 repeatedly executes steps S2 to S10.

### [Position Calculation Process for Target Object]

FIG. 12 is a flowchart illustrating a subroutine of step S4 (position calculation process for target object) in FIG. 11.

The position calculator 13 obtains positions and feature values of the first feature points from the feature point recognizer 11 (step S11). In this case, the position calculator 13 further obtains the captured image from the feature point recognizer 11.

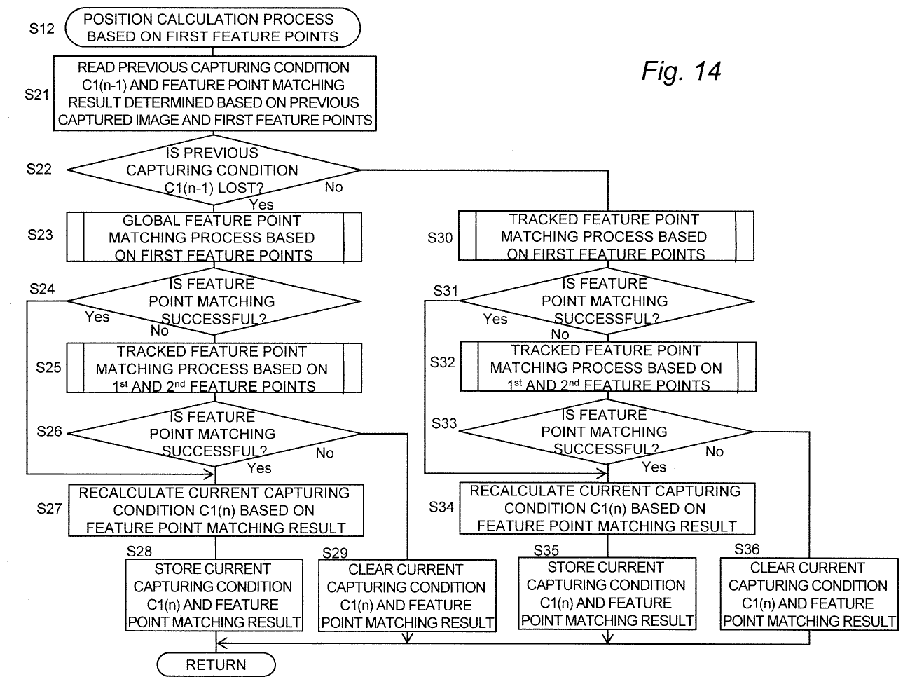

Next, the position calculator 13 executes a position calculation process based on first feature points (step S12). In this case, the position calculator 13 calculates a first capturing condition C1 based on the first feature points and the first feature point map, the first capturing condition C1 indicating a position and an attitude of the image capturing device 7 at which the captured image is obtained. In addition, the position calculator 13 performs matching between the first feature points detected from the captured image, and the feature points of the first feature point map. The position calculation process based on first feature points will be described below with reference to FIG. 14.

Next, the position calculator 13 calculates a position and a direction of the screw hole 82 in the camera coordinate system based on the first capturing condition C1, that is, the position and the attitude of the image capturing device 7 in the work object coordinate system (step S13).

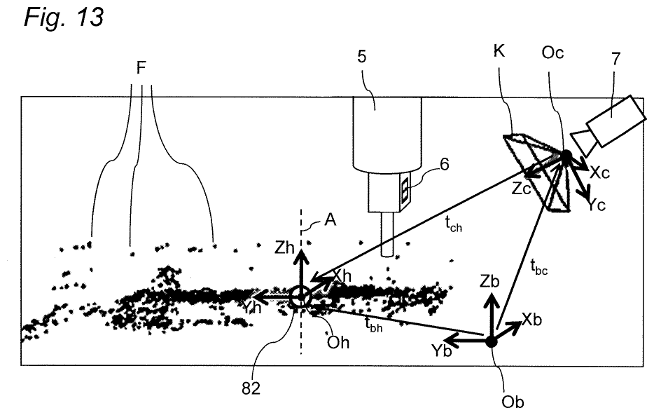

FIG. 13 is a diagram for explaining calculation of a position of a target object in the camera coordinate system, executed in step S13 in FIG. 12. FIG. 13 illustrates an exemplary feature point map in a manner similar to that in FIG. 10, and it is a perspective view of a three-dimensional plot of positions (three-dimensional coordinates) of the feature points F included in the map points, and a position and an attitude of the image capturing device 7 associated with the key frame K. In addition, FIG. 13 illustrates an origin Ob and coordinate axes Xb, Yb, and Zb of the work object coordinate system, and an origin Oc and coordinate axes Xc, Yc, and Ze of the camera coordinate system. The direction of the screw hole 82 is represented by a direction of an axis A passing through the screw hole 82 and perpendicular to the surface of the circuit board 8. The vector t_{bh} indicates a position of the screw hole 82 in the work object coordinate system. Since the position of the screw hole 82 is set by the target setting unit 17, the vector t_{bh} is known. The vector t_{bc} and the matrix R_{bc} (not shown) indicate the position and the attitude of the image capturing device 7 in the work object coordinate system, respectively. Since the position and the attitude of the image capturing device 7 in the work object coordinate system can be calculated by performing the feature point matching in step S13 in FIG. 12, the vector t_{bc} and the matrix R_{bc} are known. The vector t_{ch} indicates a position of the screw hole 82 in the camera coordinate system. Although the vector t_{ch} is unknown, the vector t_{ch} is calculated according to t_{ch}=R_{bc}⁻¹(t_{bh}−t_{bc}).

Returning to FIG. 12, the position calculator 13 obtains positions and feature values of the second feature points from the feature point recognizer 12 (step S14).

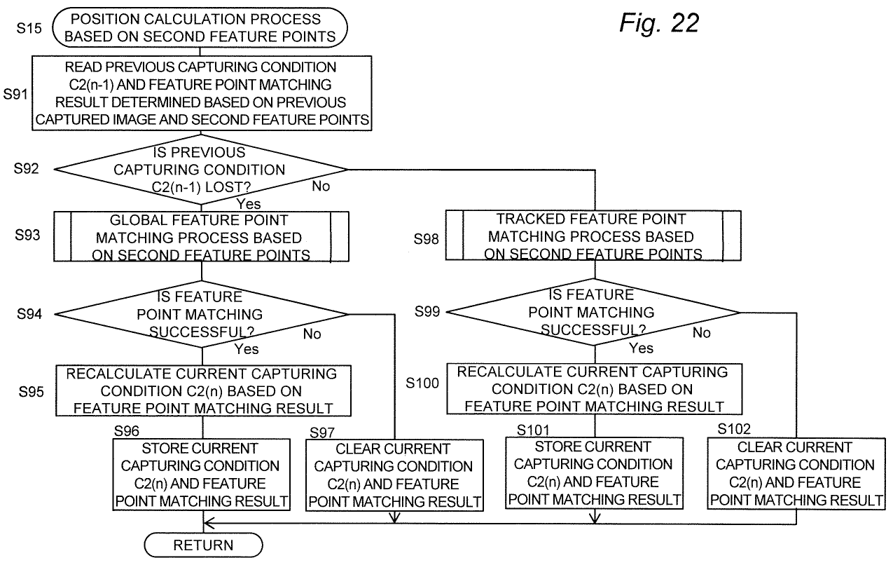

Next, the position calculator 13 executes a position calculation process based on second feature points (step S15). In this case, the position calculator 13 calculates\ a second capturing condition C2 based on the second feature points and the second feature point map, the second capturing condition C2 indicating a position and an attitude of the image capturing device 7 at which the captured image is obtained. In addition, the position calculator 13 performs matching between the second feature points detected from the captured image, and the feature points of the second feature point map. The second capturing condition calculated in step S15 is used in step S12, as will be described below. The position calculation process based on second feature points will be described below with reference to FIG. 22.

Steps S11 to S15 may be executed in parallel as illustrated in FIG. 12, or may be sequentially executed.

By executing the process in FIG. 12, it is possible to calculate the position and the direction of the screw hole 82 in the camera coordinate system.

### [Position Calculation Process Based on First Feature Points]

FIG. 14 is a flowchart illustrating a subroutine of step S12 (position calculation process based on first feature points) in FIG. 12.

The position calculator 13 reads, from the memory 13m, a first capturing condition C1(n−1) determined based on a previous captured image and first feature points, and a feature point matching result associated with the first capturing condition C1(n−1) (step S21). As described above, when steps S2 to S8 are repeatedly executed while moving the tip 5a of the power screwdriver 5 to the position of the screw hole 82, step S12 is repeatedly executed. As a result, the memory 13m of the position calculator 13 is expected to store the first capturing condition C1(n−1) and the feature point matching result corresponding to the previous captured image, determined based on the previous captured image and first feature points. Here, “n” indicates a time, or a frame number of a video captured by the image capturing device 7. In this case, the previous captured image indicates, for example, an immediately preceding frame.

Next, the position calculator 13 determines whether or not the previous first capturing condition C1(n−1) and feature point matching result are lost (step S22); if YES, the process proceeds to step S23; if NO, the process proceeds to step S30. In other words, the position calculator 13 determines whether or not it has failed to read the previous first capturing condition C1(n−1) and feature point matching result from the memory 13m.

When the previous capturing condition corresponding to the previous captured image is available, it is supposed that the current capturing condition corresponding to the current captured image can be predicted. When the current capturing condition can be predicted based on the previous capturing condition, the position and the direction of the screw hole 82 can be calculated by searching for feature points in a region smaller than the entire current captured image, the feature points corresponding to feature points included in the previous captured image. In the present specification, this process will be referred to as “tracked feature point matching process” (or “current position estimation process”). On the other hand, when the current capturing condition can not be predicted based on the previous capturing condition, it is necessary to search for feature points in the entire current captured image, the feature points corresponding to feature points included in the feature point map, in order to calculate the position and the direction of the screw hole 82. In the present specification, this process will be referred to as “global feature point matching process” (or “initial position estimation process”).

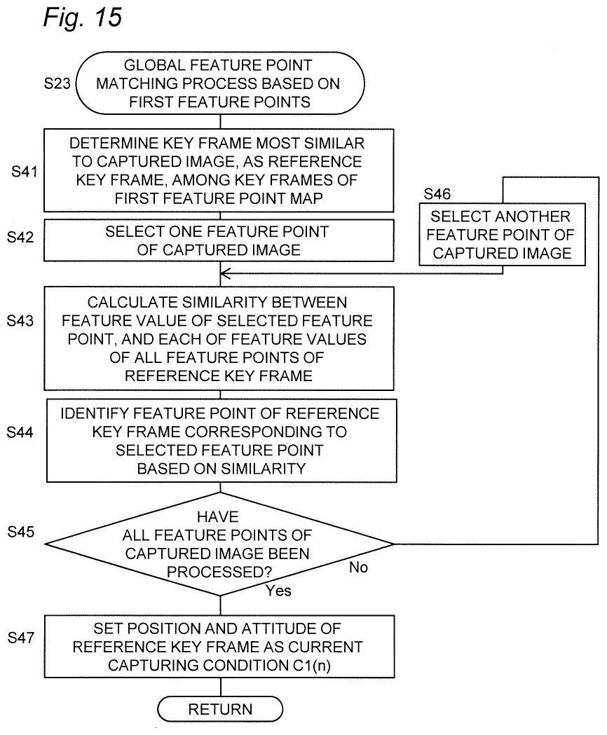

When it is determined in step S22 that the previous first capturing condition C1(n−1) and feature point matching result are lost, the position calculator 13 executes the global feature point matching process based on first feature points (step S23). In this case, the position calculator 13 estimates, as the current first capturing condition C1(n), a position and an attitude of the first key frame most similar to the current captured image, among the first key frames of the first feature point map. In addition, the position calculator 13 performs feature point matching by searching for first feature points in the entire current captured image, the first feature points corresponding to feature points included in the first key frame most similar to the current captured image. The global feature point matching process based on first feature points will be described below with reference to FIG. 15.

After executing step S23, the position calculator 13 determines whether or not the feature point matching is successful (step S24): if YES, the process proceeds to step S27; if NO, the process proceeds to step S25. The position calculator 13 determines whether or not the feature point matching is successful, based on the number of feature points corresponding to each other. For example, when the number of feature points corresponding to each other is equal to or larger than a predetermined number, for example, 25, the position calculator 13 may determine that the feature point matching is successful. When the feature point matching is successful, it is determined that the estimated current first capturing condition C1(n) correctly represents a position and an attitude of the image capturing device 7 at which the current captured image is obtained.

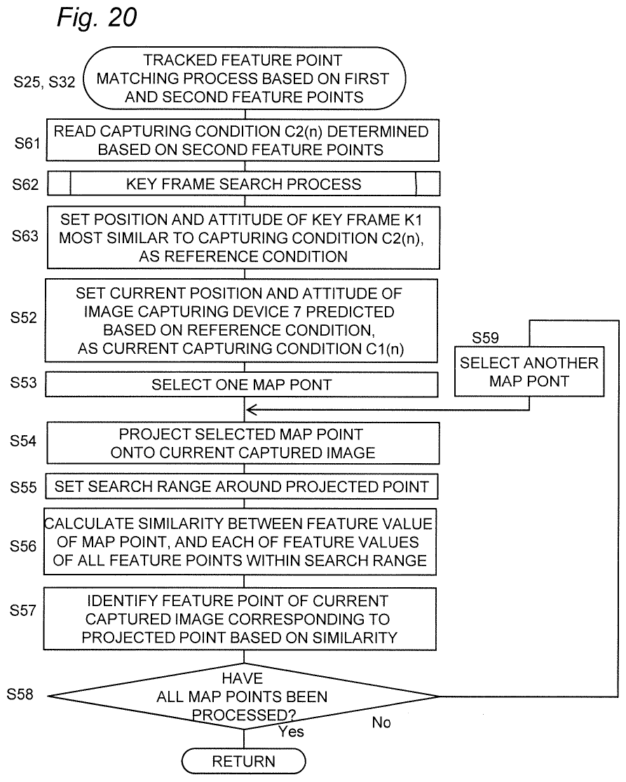

When it is determined in step S24 that the feature point matching has failed, the position calculator 13 executes the tracked feature point matching process based on first and second feature points (step S25). As described with reference to FIG. 12, step S15 (position calculation process based on second feature points) is executed in parallel to step S12, to determine the second capturing condition C2(n) corresponding to the current captured image. Therefore, when estimation and feature point matching of the first capturing condition C1(n) have failed in step S23, the position calculator 13 again performs estimation and feature point matching of the first capturing condition C1(n), with further reference to the second capturing condition C2(n). In this case, the position calculator 13 determines, as a reference key frame, a first key frame having a position and an attitude most similar to the position and the attitude of the second capturing condition C2(n), and predicts the current first capturing condition C1(n) corresponding to the current captured image, based on the reference key frame. In addition, the position calculator 13 predicts positions of projected points in the current captured image, the projected points corresponding to feature points included in the reference key frame, and performs feature point matching by searching for first feature points corresponding to the projected points, in a region including the projected points, the region being smaller than the entire current captured image. The second capturing condition C2(n) is determined based on the second feature points. Therefore, in step S25, both the first and second feature points are referred to in order to perform estimation and feature point matching of the current first capturing condition C1(n). The tracked feature point matching based on first and second feature points will be described below with reference to FIG. 20.

After executing step S25, the position calculator 13 determines whether or not the feature point matching is successful (step S26): if YES, the process proceeds to step S27; if NO, the process proceeds to step S29. The process in step S26 is similar to the process in step S24.

When it is determined in step S24 or S26 that the feature point matching is successful, the position calculator 13 recalculates the current first capturing condition C1(n) based on the feature point matching result (step S27). The feature point matching result indicates feature points of the first key frame K1 corresponding to the first feature points included in the current captured image, and indicates feature points of the map points corresponding to the feature points of the first key frame K1, using the index numbers. The position calculator 13 recalculates the current first capturing condition C1(n) by solving, for example, a perspective n point (PnP) problem based on positions (two-dimensional coordinates) of n first feature points included in the current captured image, and positions (three-dimensional coordinates) of n feature points of map points determined to correspond to the feature points of the captured image through the feature point matching. As described above, the current first capturing condition C1(n) is estimated using the first key frame in step S22, and the current first capturing condition C1(n) is predicted based on the second capturing condition in step S25, and the estimated or predicted current first capturing condition C1(n) includes an error. However, it is possible to obtain the more accurate current first capturing condition C1(n), by recalculating the current first capturing condition C1(n) based on the feature point matching result obtained from the estimated or predicted current first capturing condition C1(n).

After recalculating the current first capturing condition C1(n), the position calculator 13 stores the current first capturing condition C1(n) and feature point matching result, in the memory 13m (step S28).

When it is determined in step S26 that the feature point matching has failed, the position calculator 13 clears information of the current first capturing condition C1(n) and feature point matching result, in the memory 13m (step S29).

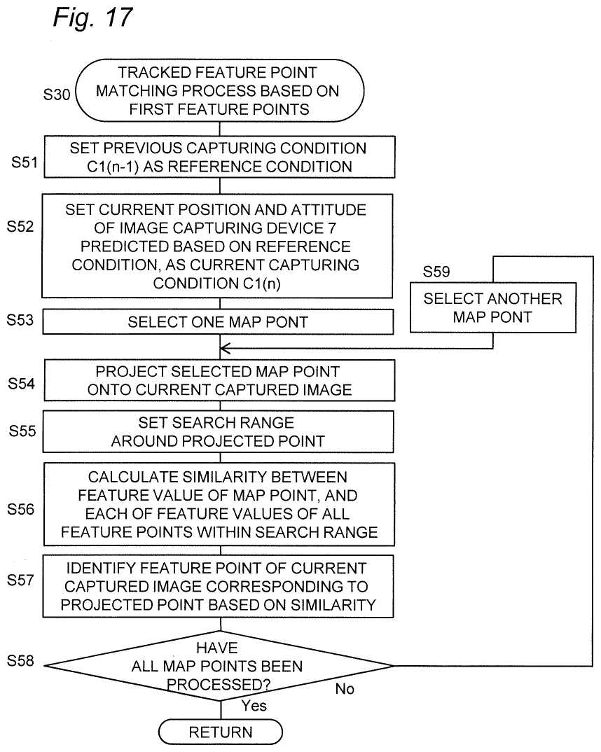

When it is determined in step S22 that the previous first capturing condition C1(n−1) and feature point matching result have been successfully read from the memory 13m, the position calculator 13 executes a tracked feature point matching process based on first feature points (step S30). In this case, the position calculator 13 predicts the current first capturing condition C1(n) based on the previous first capturing condition C1(n−1). In addition, the position calculator 13 predicts positions of projected points in the current captured image, the projected points corresponding to the first feature points included in the previous captured image, and performs feature point matching by searching for first feature points corresponding to the projected points, in a region including the projected points, the region being smaller than the entire current captured image. The tracked feature point matching process based on first feature points will be described below with reference to FIG. 17.

After executing step S30, the position calculator 13 determines whether or not the feature point matching is successful (step S31): if YES, the process proceeds to step S34; if NO, the process proceeds to step S32. The process in step S31 is similar to the process in step S24.

When it is determined in step S31 that the feature point matching has failed, the position calculator 13 executes a tracked feature point matching process based on first and second feature points (step S32). The process in step S32 is the same as the process in step S25.

After executing step S32, the position calculator 13 determines whether or not the feature point matching is successful (step S33): if YES, the process proceeds to step S34; if NO, the process proceeds to step S36. The process in step S33 is similar to the process in step S24.

When it is determined in step S31 or S33 that the feature point matching is successful, the position calculator 13 recalculates the current first capturing condition C1(n) based on the feature point matching result (step S34). The process in step S34 is similar to the process in step S27.

After recalculating the current first capturing condition C1(n), the position calculator 13 stores the current first capturing condition C1(n) and feature point matching result, in the memory 13m (step S35).

When it is determined in step S33 that the feature point matching has failed, the position calculator 13 clears information of the current first capturing condition C1(n) and feature point matching result, in the memory 13m (step S36).

In the case where the current first capturing condition C1(n) and feature point matching result corresponding to the current captured image have been determined and stored in the memory 13m, the position calculator 13 reads the information stored in the memory 13m as the previous first capturing condition C1(n−1) and feature point matching result, when executing step S12 on the next captured image. In this case, the process proceeds to step S30. On the other hand, in the case where the current first capturing condition C1(n) and feature point matching result corresponding to the current captured image can not be determined, and the information in the memory 13m has been cleared, the position calculator 13 can not read the previous first capturing condition C1(n) and feature point matching result from the memory 13m, when executing step S12 on the next captured image. In this case, the process proceeds to step S23.

### [Global Feature Point Matching Process Based on First Feature Points]

FIG. 15 is a flowchart illustrating a subroutine of step S23 (global feature point matching process based on first feature points) in FIG. 14.

The position calculator 13 determines a key frame most similar to the captured image, as a reference key frame, among the key frames of the first feature point map (step S41). In this case, the position calculator 13 may read a key frame as a similar image from the storage device 16 based on the positions and feature values of the first feature points of the captured image obtained by the image capturing device 7, the key frame including feature points having similar positions and feature values. In the case where the storage device 16 stores the captured image itself obtained to generate the map points, the position calculator 13 may read a key frame as a similar image from the storage device 16 based on the captured image obtained by the image capturing device 7, the key frame being associated with a similar captured image.

In order to calculate image similarity, the position calculator 13 may use, for example, Bag of Visual Words (BoVW). BoVW is a feature vector of an image whose local feature values are clustered in an n-dimensional space, the feature vector representing features of the image as “the number of occurrences of feature values for each cluster”. The local feature values of the image are feature vectors with distribution invariant to rotation, enlargement, and reduction. That is, it is expected that images having similar distribution of feature values are images having similar arrangement of feature points. By obtaining the similarities of images using the BoVW calculated for each image, it is possible to search for an image based on features of a captured object.

Next, the position calculator 13 selects one of the first feature points of the captured image (step S42).

Next, the position calculator 13 calculates similarity between a feature value of the selected first feature point, and each of feature values of all the feature points of the reference key frame (step S43).

Next, the position calculator 13 identifies a feature point of the reference key frame corresponding to the selected first feature point, based on the similarity (step S44).

In order to associate feature points, the position calculator 13 may use, for example, ORB feature values. In this case, the position calculator 13 calculates ORB feature values of a certain feature point in the captured image, calculates ORB feature values of all feature points in the similar image, and calculates a distance between the ORB feature value of the captured image and each ORB feature value of the similar image (for example, a Hamming distance between feature vectors). The position calculator 13 associates a pair of feature points corresponding to the feature values having the minimum distance, with each other.

Next, the position calculator 13 determines whether or not all the first feature points of the captured image have been processed (step S45): if YES, the process proceeds to step S47; ifNO, the process proceeds to step S46.

When it is determined in step S45 that not all the first feature points of the captured image have been processed, the position calculator 13 selects another one of the first feature points of the captured image (step S46), and then, repeatedly executes steps S43 to S46. Consequently, the position calculator 13 performs feature point matching by searching for first feature points in the entire current captured image, the first feature points corresponding to the feature points included in the reference key frame.

When it is determined in step S45 that all the first feature points of the captured image have been processed, the position calculator 13 sets the position and the attitude of the reference key frame, as the current first capturing condition C1(n) (step S47).

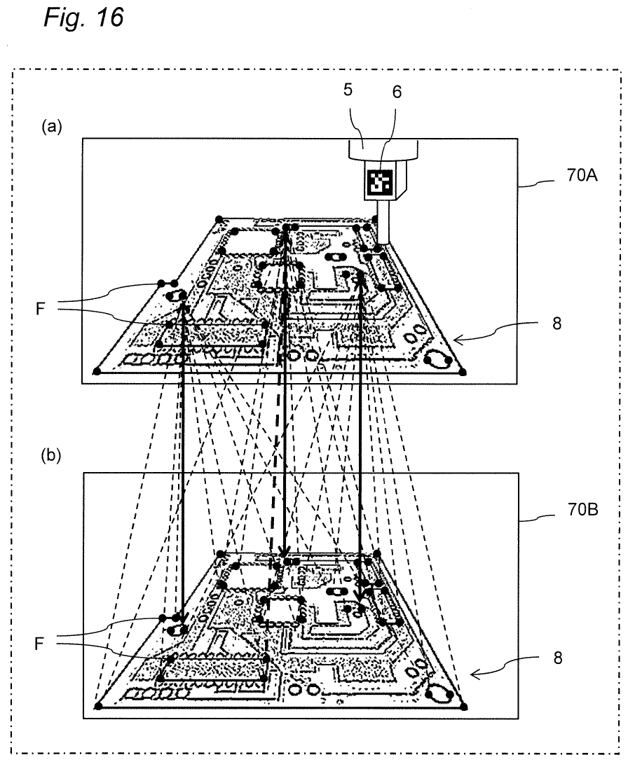

FIG. 16 is a diagram for explaining the feature point matching executed in step S23 in FIG. 14, in which (a) illustrates a captured image 70A obtained by the image capturing device 7, and (b) illustrates a similar image 70B read from the storage device 16. The similar image 70B may include only the feature points F (alternatively, the feature points F and the feature values), or may include a captured image obtained to generate the map points. In FIG. 16, dashed lines between captured image 70A and similar image 70B indicate combinations of feature points for calculating similarities, and thick arrows indicate combinations of corresponding feature points. Although FIG. 16 illustrates only some combinations of feature points, the position calculator 13 calculates the similarity between the feature value of the selected first feature point, and each of feature values of all the feature points of the key frame K1(n), as described above. In other words, the position calculator 13 searches for the first feature points corresponding to the feature points included in the key frame K1, in the entire captured image. Therefore, the process in step S23 requires much computational complexity and long processing time.

By executing the process in FIG. 15, it is possible to perform estimation and feature point matching of the current first capturing condition C1(n), based on the first feature points, without referring to the previous first capturing condition C1(n−1) and feature point matching result.

### [Tracked Feature Point Matching Based on First Feature Points]

FIG. 17 is a flowchart illustrating a subroutine of step S30 (tracked feature point matching process based on first feature points) in FIG. 14.

The position calculator 13 sets the previous first capturing condition C1(n−1) as a reference condition (step S51).

Next, the position calculator 13 determines a current position and attitude of the image capturing device 7 predicted based on the reference condition, as the current first capturing condition C1(n) (step S52).

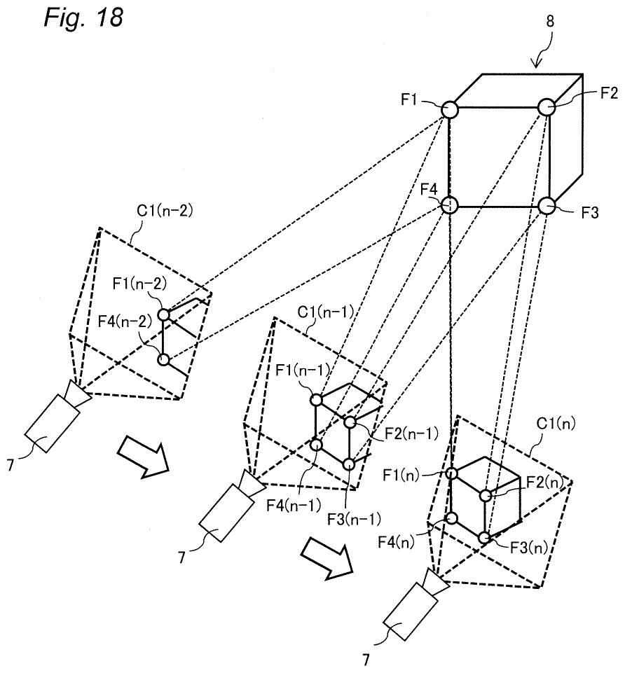

FIG. 18 is a diagram for explaining prediction of the current capturing condition based on the previous capturing condition, executed in step S52 in FIG. 17. At first, the previous capturing condition C1(n−1) is set as a reference condition. Next, the current capturing condition C1(n) corresponding to the current captured image is predicted based on the reference condition, with reference to a speed, acceleration, and the like of the image capturing device 7 at time n−1. The position calculator 13 may obtain a position and a speed of the image capturing device 7 using, for example, an inertial measurement unit (IMU) provided on the image capturing device 7 or the robot arm apparatus 4. Further, when a position and an attitude of the capturing condition C1(n−2) before the reference frame are stored in the memory 13m and available, and the image capturing device 7 is linearly moving at a constant velocity, the position calculator 13 may predict a position and an attitude of the current capturing condition C1(n), based on the positions and attitudes of the previous capturing conditions C1(n−2) and C1(n−1).

Returning to FIG. 17, the position calculator 13 selects one of the first map points associated with the reference condition (that is, the previous first capturing condition C1(n−1)) (step S53).

Next, the position calculator 13 projects the selected first map point onto the current captured image, on the assumption that the image capturing device 7 has the position and the attitude of the current capturing condition C1(n) (step S54). Hereinafter, the map point projected onto the current captured image will be referred to as a projected point. A position (two-dimensional coordinates) of the projected point in the current captured image is calculated by applying projective transformation to a position (three-dimensional coordinates) of a feature point included in the map point.

Next, the position calculator 13 sets a search range around the projected point, the search range being smaller than the entire captured image (step S55).

Next, the position calculator 13 calculates similarity between a feature value of the selected first map point, and each of feature values of all first feature points within the search range (step S56).

Next, the position calculator 13 identifies a first feature point of the current captured image corresponding to the projected point (that is, the selected first map point), based on the similarity (step S57). In this case, when the similarity in the feature value of a certain feature point within the search range is less than a predetermined threshold, the position calculator 13 determines that the feature point does not correspond to the projected point. When the similarities in the feature values of all the feature points within the search range are less than the predetermined threshold, there is no feature point corresponding to the projected point, and the feature point matching fails. When there are a plurality of feature points within the search range, having similarities equal to or more than the threshold the position calculator 13 identifies a feature point having the highest similarity, as a feature point corresponding to the projected point.

Next, the position calculator 13 determines whether or not all the first map points associated with the reference condition have been processed (step S58): if YES, the process proceeds to step S31 in FIG. 14; if NO, the process proceeds to step S59 in FIG. 17.

Next, the position calculator 13 selects another one of the first map points associated with the reference condition (step S59), and then, repeatedly executes steps S54 to S59.

By executing the process in FIG. 17, it is possible to perform estimation and feature point matching of the current first capturing condition C1(n), based on the first feature points, with reference to the previous first capturing condition C1(n−1).

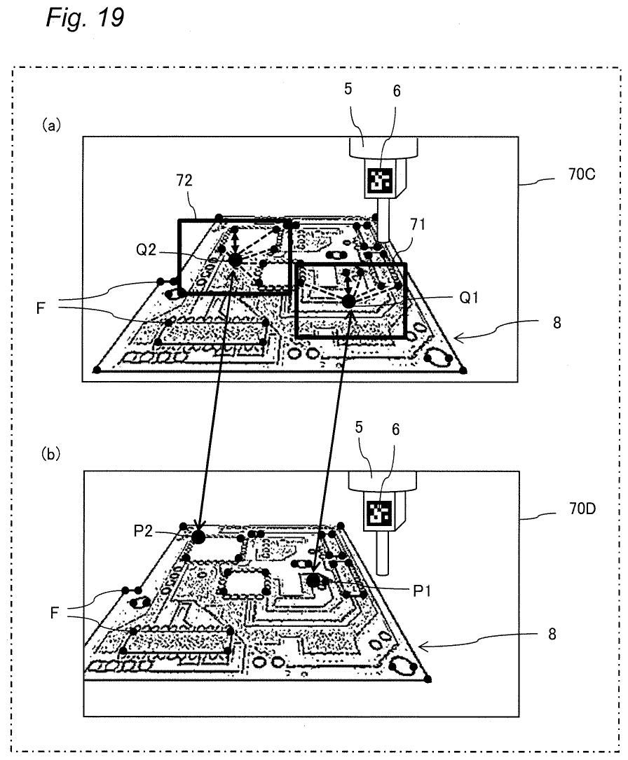

FIG. 19 is a diagram for explaining the feature point matching executed in step S30 in FIG. 14, in which (a) illustrates a current captured image 70C obtained by the image capturing device 7, and (b) illustrates a previous captured image 70D obtained by the image capturing device 7. As illustrated in FIG. 19(b), the position calculator 13 selects one map point P1 associated with the reference condition, from the first feature point map. Next, as illustrated in FIG. 19(a), the position calculator 13 projects a selected map point P1 onto a projected point Q1 on the captured image. Next, the position calculator 13 sets a search range 71 around the projected point Q1. Next, the position calculator 13 calculates similarity between a feature value of the map point P1, and each of feature values of all the feature points F within the search range 71. Similarly, the position calculator 13 selects another map point P2 associated with the reference condition, from the first feature point map. Next, the position calculator 13 projects the selected map point P2 onto a projected point Q2 on the captured image. Next, the position calculator 13 sets a search range 72 around the projected point Q2. Next, the position calculator 13 calculates similarity between a feature value of the map point P2, and each of feature values of all the feature points F within the search range 72. In FIG. 19(a), the feature points F connected from the projected points Q1 and Q2 via dashed lines indicate feature points not corresponding to the map points P1 and P2 (that is, feature points having low similarities to the feature values of the map points P1 and P2). In addition, in FIG. 19(a), the feature points F connected from the projected points Q1 and Q2 via thick arrows indicates feature points corresponding to the map points P1 and P2 (that is, feature points having the highest similarities to the feature values of the map points P1 and P2, respectively). Although FIG. 19 illustrates only some map points P1 and P2 and the corresponding search ranges 71 and 72, the position calculator 13 sets search regions for all the map points, and identifies feature points corresponding to map points in each of the search regions, as described above.

When the current first capturing condition C1(n) can be predicted based on the previous first capturing condition C1(n−1), it is possible to limit positions at which a feature point corresponding to a map point may appear, to a certain range in the current captured image. According to the process in FIG. 17, since the feature point matching is performed only within the search range, it is possible to reduce computational complexity and processing time as compared with a case where the feature point matching is performed in the entire captured image as in the global feature point matching process based on first feature points.

As exemplified in FIG. 19(a), the search range may be a rectangle having a certain size centered at the projected point P1 or P2, but is not limited thereto. For example, the search range may be a circle having a certain radius centered at the projected point.

### [Tracked Feature Point Matching Based on First and Second Feature Points]

When both the feature point matching in step S23 and the feature point matching in step S30 in FIG. 14 fail, it is not possible to perform estimation and feature point matching of the first capturing condition C1(n), based on only the first feature points and the first feature point map. Thus, the position calculator 13 performs estimation and feature point matching of the first capturing condition C1(n), by further referring to the second capturing condition C2(n) calculated based on the second feature points and the second feature point map.

FIG. 20 is a flowchart illustrating subroutines of steps S25 and S32 (tracked feature point matching process based on first and second feature points) in FIG. 14. The process in FIG. 20 includes steps S61 to S63 instead of step S51 in FIG. 17.

The position calculator 13 reads the current second capturing condition C2(n) determined based on the second feature points, from the memory 13m (step S61).

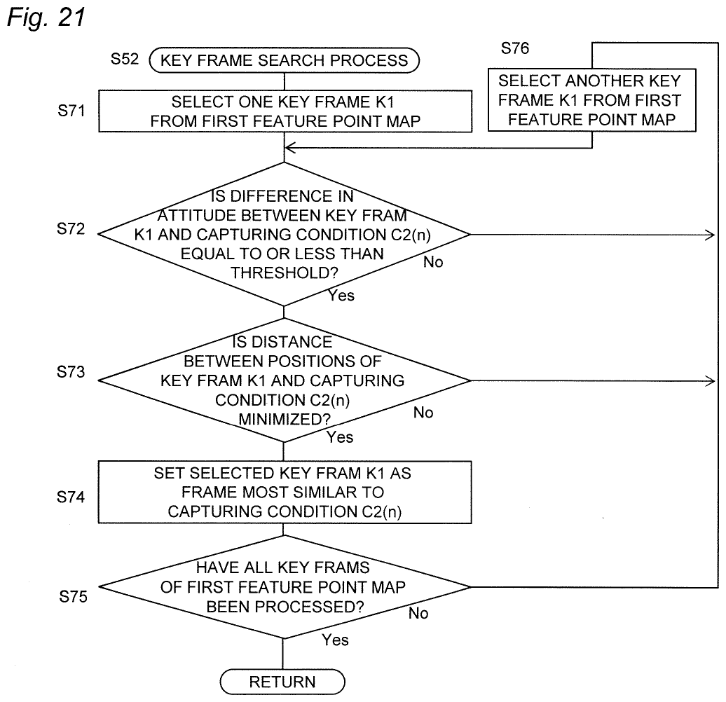

Next, the position calculator 13 executes a key frame search process to select a first key frame K1 most similar to the current second capturing condition C2(n) (step S62). The key frame search process will be described below with reference to FIG. 21.

Next, the position calculator 13 sets a position and an attitude of the first key frame K1 most similar to the second capturing condition C2(n), as a reference condition (step S63).

Thereafter, steps S52 to S59 in FIG. 20 are similar to the corresponding steps in FIG. 17.

By executing the process in FIG. 20, it is possible to perform estimation and feature point matching of the current first capturing condition C1(n), based on the first and second feature points, with further reference to the second capturing condition C2(n).

As described above, the detection of the second feature points takes a longer processing time than the detection of the first feature points. Therefore, the latest second capturing condition C2(n) stored in the memory 15m may be delayed for several frames with respect to the current captured image, and a position and an attitude of the latest second capturing condition C2(n) may be quite different from those of the current captured image. In this case, even when the second capturing condition C2(n) is read from the memory 15m, errors may occur in the position of the map point selected in steps S53 and S59, the position of the projected point in step S54, the search range set in step S55, or the feature values calculated in step S56. Due to the errors, a feature point having high similarity can not be found in step S57, and the feature point matching may fails. Therefore, in order to reduce these errors, when steps S25 and S32 are executed, the movement of the image capturing device 7 and the power screwdriver 5 may be stopped until the current first capturing condition C1 corresponding to the current captured image is stored in the memory 13m.

Since the detection of the second feature points takes a longer processing time than the detection of the first feature points, in the process in FIG. 20, the current second capturing condition is used as a reference condition representing the previous first capturing condition, and the current first capturing condition is predicted based on the current second capturing condition.

### [Key Frame Search Process]

FIG. 21 is a flowchart illustrating a subroutine of step S62 (key frame search process) in FIG. 20.

The position calculator 13 selects one of the first key frames K1 from the first feature point map (step S71).

Next, the position calculator 13 determines whether or not a difference in attitude between the first key frame K1 and the second capturing condition C2(n) is equal to or less than a threshold (step S72): if YES, the process proceeds to step S73; if NO, the process proceeds to step S76.

Next, the position calculator 13 determines whether or not a distance between the positions of the first key frame K1 and the second capturing condition C2(n) is minimized (step S73): if YES, the process proceeds to step S74; if NO, the process proceeds to step S76.

Next, the position calculator 13 sets the selected first key frame K1 as a frame most similar to the second capturing condition C2(n) (step S74).

Next, the position calculator 13 determines whether or not all the first key frames K1 of the first feature point map have been processed (step S75): if YES, the process proceeds to step S53 in FIG. 20; if NO, the process proceeds to step S76 in FIG. 21.

Next, the position calculator 13 selects another one of the first key frames K1 from the first feature point map (step S76), and then, repeatedly executes steps S72 to S76.

By executing the process in FIG. 21, it is possible to determine the first key frame K1 most similar to the current second capturing condition C2(n). In other words, it is possible to search for the optimal first key frame K1 corresponding to the current captured image.

### [Position Calculation Process Based on Second Feature Points]

FIG. 22 is a flowchart illustrating a subroutine of step S15 (position calculation process based on second feature points) in FIG. 12.

The position calculator 13 reads, from the memory 13m, a second capturing condition C2(n−1) determined based on the previous captured image and second feature point, and a feature point matching result associated with the second capturing condition C2(n−1) (step S91). Since step S12 is repeatedly executed as described above, the memory 13m of the position calculator 13 is expected to store the second capturing condition C2(n−1) and the feature point matching result corresponding to the previous captured image, determined based on the previous captured image and second feature points.

Next, the position calculator 13 determines whether or not the previous second capturing condition C2(n−1) and feature point matching result are lost (step S92): if YES, the process proceeds to step S93; if NO, the process proceeds to step S98. In other words, the position calculator 13 determines whether or not it has failed to read the previous second capturing condition C2(n−1) and feature point matching result from the memory 13m.

When it is determined in step S92 that the previous second capturing condition C2(n−1) and feature point matching result are lost, the position calculator 13 executes a global feature point matching process based on second feature points (step S93). In this case, the position calculator 13 estimates, as the current second capturing condition C2(n), a position and an attitude of the second key frame most similar to the current captured image, among the second key frames of the second feature point map. In addition, the position calculator 13 performs feature point matching by searching for second feature points in the entire current captured image, the second feature points corresponding to feature point included in the second key frame most similar to the current captured image. The global feature point matching process based on second feature points is similar to the process in step S23 described with reference to FIG. 15, except for performing estimation and feature point matching of the second capturing condition C2(n), instead of estimation and feature point matching of the first capturing condition C1(n), based on the second feature points and the second feature point map, instead of the first feature points and the first feature point map.

After executing step S93, the position calculator 13 determines whether or not the feature point matching is successful (step S94): if YES, the process proceeds to step S95; if NO, the process proceeds to step S97. The position calculator 13 determines whether or not the feature point matching is successful, based on the number of feature points corresponding to each other. For example, when the number of feature points corresponding to each other is equal to or larger than a predetermined number, for example, 50, the position calculator 13 may determine that the feature point matching is successful. As described above, in general, the feature point recognizer 12 using the deep learning model detects more feature points than the feature point recognizer 11 using the classical image processing not based on the deep learning, and thus, the threshold in step S94 is set higher than the threshold used in step S24.

When it is determined in step S94 that the feature point matching is successful, the position calculator 13 recalculates the current second capturing condition C2(n) based on the feature point matching result (step S95). The process in step S95 is similar to the process in step S27 in FIG. 14, except for recalculating the current second capturing condition C2(n), instead of the current first capturing condition C1(n).

After recalculating the current second capturing condition C2(n), the position calculator 13 stores the current second capturing condition C2(n) and feature point matching result, in the memory 13m (step S96).

When it is determined in step S94 that the feature point matching has failed, the position calculator 13 clears information on the current second capturing condition C2(n) and feature point matching result, in the memory 13m (step S97).

When it is determined in step S92 that the previous second capturing condition C2(n−1) and feature point matching result are successfully read from the memory 13m, the position calculator 13 executes a tracked feature point matching process based on second feature points (step S98). In this case, the position calculator 13 predicts the current second capturing condition C2(n) based on the previous second capturing condition C2(n−1). In addition, the position calculator 13 predicts positions of projected points in the current captured image, the projected points corresponding to the second feature points included in the previous captured image, and performs feature point matching by searching for second feature points corresponding to the projected points, in a region including the projected points, the region being smaller than the entire current captured image. The tracked feature point matching process based on second feature points is similar to the process in step S30 described with reference to FIG. 17, except for performing estimation and feature point matching of the second capturing condition C2(n), instead of estimation and feature point matching of the first capturing condition C1(n), based on the second feature points and the second feature point map, instead of the first feature points and the first feature point map.

After executing step S98, the position calculator 13 determines whether or not the feature point matching is successful (step S99): if YES, the process proceeds to step S100; if NO, the process proceeds to step S102. The process in step S99 is similar to the process in step S94.

When it is determined in step S99 that the feature point matching is successful, the position calculator 13 recalculates the current second capturing condition C2(n) based on the feature point matching result (step S100). The process of step S100 is similar to the process of step S95.

After recalculating the current second capturing condition C2(n), the position calculator 13 stores the current second capturing condition C2(n) and feature point matching result, in the memory 13m (step S101).

When it is determined in step S99 that the feature point matching has failed, the position calculator 13 clears information of the current second capturing condition C2(n) and feature point matching result, in the memory 13m (step S102).

When the current second capturing condition C2(n) and feature point matching result corresponding to the current captured image are determined and stored in the memory 13m, the position calculator 13 reads the information stored in the memory 13m as the previous second capturing condition C2(n−1) and feature point matching result, when executing step S15 on the next captured image. In this case, the process proceeds to step S98. On the other hand, when the current second capturing condition C2(n) and feature point matching result corresponding to the current captured image can not be determined, and the information in the memory 13m has been cleared, the position calculator 13 can not read the previous second capturing condition C2(n) and feature point matching result from the memory 13m, when executing step S15 on the next captured image. In this case, the process proceeds to step S93.

When the information of the current second capturing condition C2(n) and feature point matching result has been cleared in the memory 13m, steps S25 and S32 in FIG. 14 return errors, and the position calculator 13 proceeds to process the next captured image (step S2).

### [Position Calculation Process for Holdable Object]

FIG. 23 is a flowchart illustrating a subroutine of step S6 (position calculation process for holdable object) in FIG. 11.

The position calculator 15 obtains an image of the detected marker 6 from the marker recognizer 14 (step S111).

The position calculator 15 calculates a position and an attitude of the marker 6 in the camera coordinate system based on the image of the marker 6 (step S112).

The position calculator 15 calculates a direction of the power screwdriver 5 in the camera coordinate system based on the position and the attitude of the marker 6 (step S113).

The position calculator 15 calculates a position of the tip 5a of the power screwdriver 5 in the camera coordinate system, based on the known offset t_{offset} between the marker 6 and the tip 5a of the power screwdriver 5 (step S114).

By executing the process in FIG. 23, it is possible to calculate the direction of the power screwdriver 5 and the position of the tip 5a of the power screwdriver 5 in the camera coordinate system.

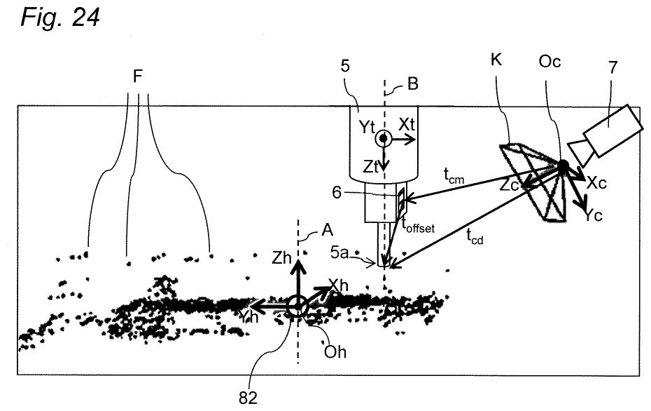

FIG. 24 is a diagram for explaining calculation of the position of the tip of the holdable object in the camera coordinate system, executed in step S114 in FIG. 23. FIG. 24 also illustrates an exemplary feature point map in a manner similar to that in FIG. 13. A direction of the power screwdriver 5 is represented by a direction of a rotation axis B of the tip 5a of the power screwdriver 5. A vector t_{cm} indicates a position of the marker 6 in the camera coordinate system (for example, a position of the center of the marker 6). Since the position of the marker 6 in the camera coordinate system is calculated in step S112, the vector t_{cm} is known. As described above, the vector t_{offset} indicates a known offset of the position of the tip 5a of the power screwdriver 5 with respect to the position of the marker 6. The vector ted indicates a position of the tip 5a of the power screwdriver 5 in the camera coordinate system. The vector t_{cd} is unknown, but is calculated according to t_{cd}=t_{cm}+t_{of}.

### [Summary of Operation of First Embodiment]

The robot arm apparatus 4 moves the tip 5a of the power screwdriver 5 to the position of the screw hole 82, such that the rotation axis B of the power screwdriver 5 matches with the axis A of the screw hole 82.

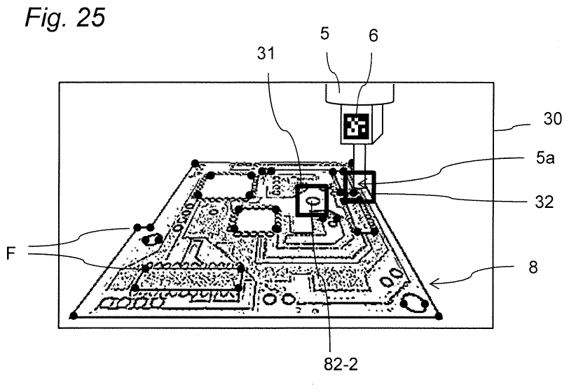

FIG. 25 is a diagram illustrating an exemplary image 30 displayed on the display device 3 in FIG. 1. The display image 30 includes a captured image, feature points F of the circuit board 8, a frame 31 indicating a recognized target object, and a frame 32 indicating a tip of a recognized holdable object. The example in FIG. 25 illustrates a case where the screw hole 82-2 is set as a target object. Therefore, the frame 31 is indicated at the position of the screw hole 82-2. The frame 32 is indicated at the position of the tip 5a of the power screwdriver 5. According to the first embodiment, even when the power screwdriver 5 and the circuit board 8 do not have fixed known positions in the world coordinate system, it is possible to control the robot arm apparatus 4 to accurately perform a work on the circuit board 8 using the power screwdriver 5, by calculating positions and directions in the world coordinate system based on the captured image. According to the first embodiment, even when at least one of the power screwdriver 5 and the circuit board 8 moves, it is possible to follow changes in their positions and directions, and control the robot arm apparatus 4 to accurately perform the work on the circuit board 8 using the power screwdriver 5.

In step S23 in FIG. 14, the first feature points corresponding to the feature points included in the key frame K1 are searched for in the entire captured image. On the other hand, in steps S25, S30, and S32, the first feature points corresponding to the first map points are searched for in the region smaller than the entire captured image. Depending on the range in which the first feature points are searched for, computational complexity and processing time in each of steps S25, S30, and S32 are smaller than computational complexity and processing time in step S23. Therefore, when the current first capturing condition C1(n) can be predicted based on the previous first capturing condition C1(n−1), it is possible to perform estimation and feature point matching of the current first capturing condition C1(n), with little computational complexity and short processing time.

In addition, in step S93 in FIG. 22, the second feature points corresponding to the feature points included in the key frame K2 are searched for in the entire captured image. On the other hand, in step S98, the second feature points corresponding to the second map points are searched for in the region smaller than the entire captured image. Depending on the range in which the second feature point is searched for, computational complexity and processing time in step S98 are smaller than computational complexity and processing time in step S93. Therefore, when the current second capturing condition C2(n) can be predicted based on the previous second capturing condition C2(n−1), it is possible to determine the current second capturing condition C2(n) with little computational complexity and short processing time.

In general, matching between the second feature points detected from the captured image and the feature points included in the second feature point map can be more accurately performed than matching between the first feature points detected from the captured image and the feature points included in the second feature point map. However, detecting the second feature points from a certain captured image requires more computational complexity and longer processing time than detecting the first feature points from the same captured image. In addition, matching between the second feature points detected from the captured image and the feature points included in the second feature point map requires more computational complexity and longer processing time than matching between the first feature points detected from the captured image and the feature points included in the second feature point map. According to the process in FIG. 14, only when the feature point matching of the global feature point matching process or the tracked feature point matching process based on only the first feature points fails, the tracked feature point matching process is performed based on both the first and second feature points. Therefore, it is less likely to prevent realtime control of the robot arm apparatus 4 due to much computational complexity and long processing time for the second feature values.

The control apparatus 1 for the robot arm apparatus 4 according to the first embodiment is characterized by a combination of detection of feature points using the classical image processing, and detection of feature points using the deep learning model, in order to calculate the position of the target object. In addition, the control apparatus 1 for the robot arm apparatus 4 according to the first embodiment is characterized by a combination of the tracked feature point matching process, that is, the feature point matching in the region smaller than the entire captured image, and the global feature point matching, that is, the feature point matching in the entire captured image, in order to calculate the position of the target object. As a result, according to the control apparatus 1 for the robot arm apparatus 4 of the first embodiment, it is possible to control the robot arm apparatus 4 to accurately move the holdable object and accurately perform the work on the work object, even when environmental conditions vary, without significantly increasing the processing time. In other words, it is possible to provide the control apparatus 1 for the robot arm apparatus 4, that is robust to variations in environmental conditions and does not impair realtime performance.

Since the second feature point map is different from the first feature point map, there is a possibility that a position of a target object can be calculated based on the second feature points, even when the position of the target object can not be calculated based on the first feature points. In addition, when the deep learning model is trained based on a plurality of images obtained by capturing the circuit board 8 from a plurality of different positions, there is a possibility that a position of a target object can be reliably calculated based on the second feature points, even when relative positions of the image capturing device 7 and the circuit board 8 vary. In addition, when the deep learning model is trained based on a plurality of images obtained by capturing the circuit board 8 with a plurality of different illuminances, there is a possibility that a position of a target object can be reliably calculated based on the second feature points, even when the illuminance around the circuit board 8 varies.

In addition, it is possible to accurately control the robot arm apparatus 4 by retraining the deep learning model based on captured images obtained by capturing the circuit board 8 under conditions close to the environmental conditions under which the robot arm apparatus 4 and the circuit board 8 are actually used.

If step S22 in FIG. 14 is NO, there is a high possibility that step S24 is also NO, and step S25 is executed. Therefore, the movements of the image capturing device 7 and the power screwdriver 5 may be restricted. The movements of the image capturing device 7 and the power screwdriver 5 may be stopped for a predetermined time, and when the feature point matching is successful, the movements of the image capturing device 7 and the power screwdriver 5 may be resumed.

In addition, when step S25, S30, or S32 in FIG. 14 is being executed, and the number of corresponding feature points has been decreased, moving speeds of the image capturing device 7 and the power screwdriver 5 may be restricted. Thereafter, when the number of corresponding feature points has increased, the moving speeds of the image capturing device 7 and the power screwdriver 5 may be increased.

### [Modified Embodiment of First Embodiment]

In general, the second feature points are less susceptible to a change in illuminance around a work object, than the first feature points. Therefore, when an environmental parameter, such as the illuminance, satisfies a predetermined condition, a position of a target object may be calculated based on the first feature points, the first feature point map, the second feature points, and the second feature point map, instead of calculating the position of the target object based on the first feature points and the first feature point map without referring to the second feature points and the second feature point map.

Environmental parameters include, for example, illuminance, time, date, weather, and the like. A condition for the environmental parameter is that it is highly likely to fail to calculate a position of a target object based on the first feature points and the first feature point map without referring to the second feature points and the second feature point map. For example, when illuminance, time, or date is used as the environmental parameter, the condition is whether or not the illuminance, the time, or the date falls within a predetermined range. When weather is used as the environmental parameter, the condition is whether the weather is fine, cloudy, or rainy.

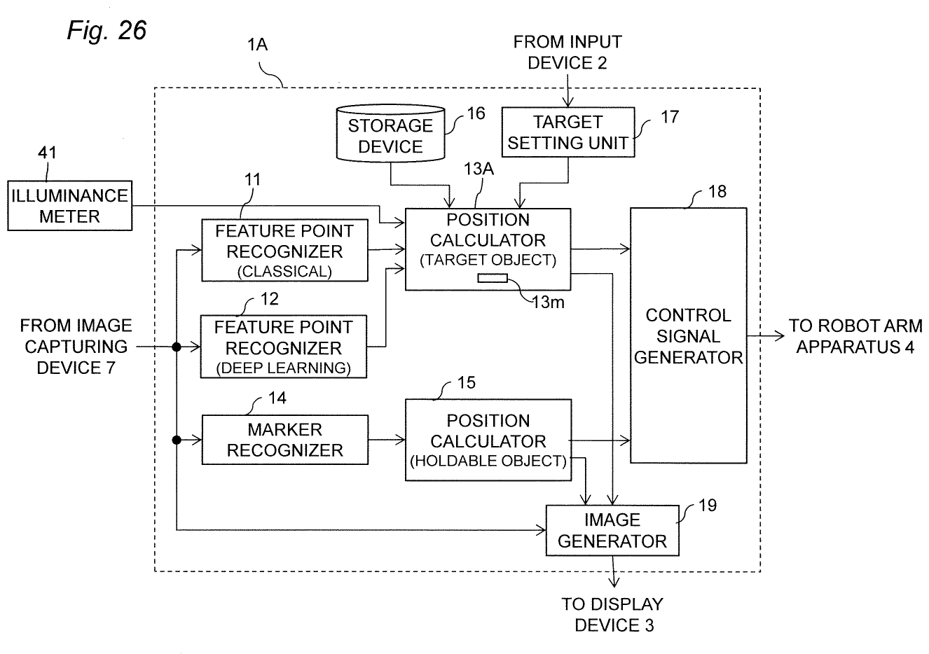

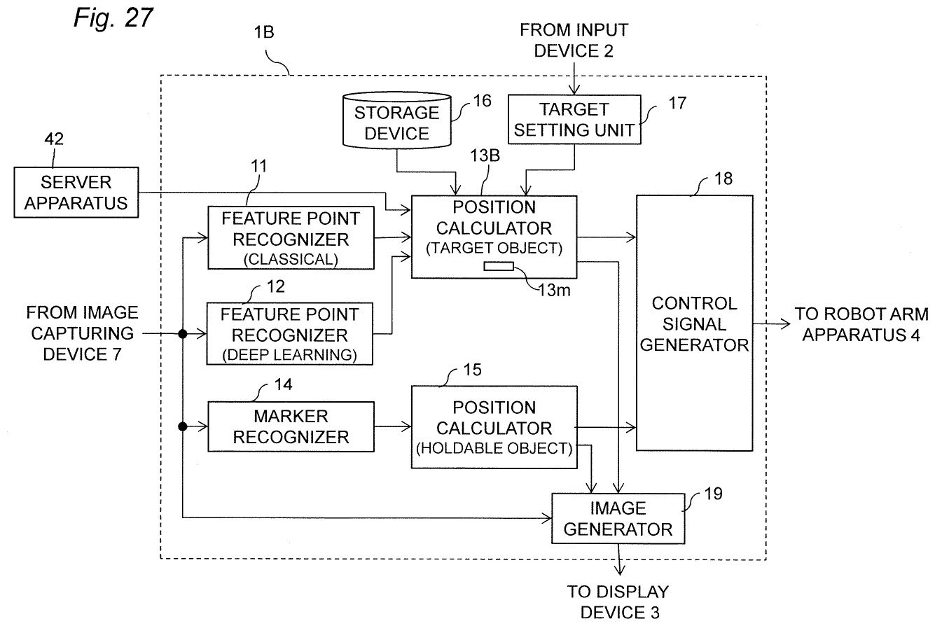

Hereinafter, control apparatuses for a robot arm apparatus, that refer to such environmental parameters, will be described with reference to FIGS. 26 and 27.

FIG. 26 is a schematic diagram illustrating a configuration of a control apparatus 1A for a robot arm apparatus 4 according to a first modified embodiment of the first embodiment. The control apparatus 1A is provided with a position calculator 13A, instead of the position calculator 13 in FIG. 5. The position calculator 13A obtains illuminance information around the circuit board 8, from an illuminance meter 41 provided near the circuit board 8. The storage device 16 stores, together with the first feature point map, the average illuminance around the circuit board 8 obtained when generating the first feature point map. The position calculator 13A obtains illuminance information around the circuit board 8 before executing step S23 or S30 in FIG. 14. Next, when the current illuminance is apart from the average illuminance obtained when generating the first feature point map, by a threshold or more, the position calculator 13A determines that a variation in illuminance occurs. In this case, the position calculator 13A skips steps S23 and S24 and executes step S25, and skips steps S30 and S31 and executes step S32.

The position calculator 13A may statistically determine conditions for skipping steps S23, S30, and the like, based on the illuminance during operation of the robot arm apparatus 4, instead of the illuminance obtained when generating the first feature point map. In this case, the position calculator 13A stores illuminance information around the circuit board 8, as well as determination results (that is, success or failure) in steps S24 and S31 in FIG. 14, in the memory 13m. Consequently, when the illuminance falls within a predetermined range, it is possible to calculate in advance the probability of success and failure in the feature point matching in step S23 or S30. The position calculator 13A obtains illuminance information around the circuit board 8 before executing step S23 or S30 in FIG. 14. Next, when the current illuminance is equal to or less than a threshold, the position calculator 13A determines that the feature point matching in step S23 or S30 fails with a certain probability, for example, 80%. In this case, the position calculator 13A skips steps S23 and S24 and executes step S25, and skips steps S30 and S31 and executes step S32.

The control apparatus 1A in FIG. 26 can accurately calculate a position and a direction of a target object by referring to the illuminance information.

In order to obtain the illuminance information around the circuit board 8, the position calculator 13A may calculate average luminance or average histogram distribution of the current captured image, instead of using the illuminance meter 41. The storage device 16 stores, together with the first feature point map, the average luminance or the average histogram distribution of the image used when generating the first feature point map. The position calculator 13A calculates average luminance or average histogram distribution of the current captured image before executing step S23 or S30 in FIG. 14. Next, when the current average luminance or average histogram distribution is apart from the average luminance or the average histogram distribution obtained when generating the first feature point map, by a threshold or more, the position calculator 13A determines that a variation in illuminance occurs. In this case, the position calculator 13A skips steps S23 and S24 and executes step S25, and skips steps S30 and S31 and executes step S32.

FIG. 27 is a schematic diagram illustrating a configuration of a control apparatus 1B for a robot arm apparatus 4 according to a second modified embodiment of the first embodiment. The control apparatus 1B is provided with a position calculator 13B, instead of the position calculator 13 in FIG. 5. The position calculator 13B obtains environmental parameters including at least one of time, date, and weather, from an external server apparatus 42. The environmental parameters may include a location and a direction of the circuit board 8. In this case, the position calculator 13B stores the environmental parameters obtained from the server apparatus 42, as well as determination results (that is, success or failure) in steps S24 and S31 in FIG. 14, in the memory 13m. Consequently, when the environmental parameter satisfies a predetermined condition, it is possible to calculate in advance a probability of success and failure in the feature point matching in step S23 or S30. The position calculator 13B obtains the environmental parameters from the server apparatus 42 before executing step S23 or S30 in FIG. 14. For example, it is assumed that when the robot arm system operates from 10:00 to 12:00 in cloudy weather, step S25 is executed with a probability of 80%. In the same weather and the same time period as these conditions, it may be determined that a large variation in illuminance is likely to occur. In this case, the position calculator 13B skips steps S23 and S24 and executes step S25, and skips steps S30 and S31 and executes step S32.

The position calculator 13B may obtain time or date information from an internal clock signal source, instead of the external server apparatus 42.

According to the control apparatus 1A in FIG. 26 and the control apparatus 1B in FIG. 27, when it is highly likely to fail in the feature point matching of step S23 in FIG. 14, steps S23 and S24 can be skipped. Similarly, when it is highly likely to fail in the feature point matching in step S30 in FIG. 14, steps S30 and S31 can be skipped. Therefore, it is possible to reduce unnecessary processing, and reduce a possibility of preventing the realtime control of the robot arm apparatus 4.

### [Advantageous Effects and Others of First Embodiment]

According to the first embodiment, a control apparatus 1 for controlling a robot arm apparatus 4 that moves a first object is provided with: a target setting unit 17, a storage device 16, a feature point recognizer 11, a feature point recognizer 12, a position calculator 13, and a control signal generator 18. The target setting unit 17 sets a position of at least one target object in a second object. The storage device 16 stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The feature point recognizer 11 detects first feature points of the second object by performing the first image processing on a captured image including at least a part of the second object obtained by an image capturing device 7. The feature point recognizer 12 detects second feature points of the second object from the captured image using the first deep learning model. The position calculator 13 calculates a position of the target object based on the first feature points and the first feature point map without referring to the second feature points and the second feature point map. When the position of the target object can not be calculated based on the first feature points and the first feature point map without referring to the second feature points and the second feature point map, the position calculator 13 calculates the position of the target object based on the first feature points, the first feature point map, the second feature points, and the second feature point map. The control signal generator 18 generates a control signal for moving the first object to the position of the target object, based on the position of the target object and the position of the first object, and outputs the control signal to the robot arm apparatus 4.

With such a configuration, it is possible to control the robot arm apparatus 4 to accurately move the first object and accurately perform the work on the second object, even when environmental conditions vary, without significantly increasing the processing time.

In addition, even when at least one of the first object and the second object does not have a known fixed position in the world coordinate system, it is possible to control the robot arm apparatus 4 to accurately perform the work on the second object using the first object. For example, even when “a deviation of second object” occurs, in which a part of the robot arm apparatus 4 or the first object strikes the second object during the work, and the second object deviates from a workbench fixed to the world coordinate system, it is possible to accurately perform the work. In addition, even when “mismatch of control” occurs, in which predicted coordinates of the tip of the robot arm apparatus 4 deviate from actual coordinates through repetition of the work, it is possible to accurately perform the work.

According to the first embodiment, the first feature point map may include a plurality of first key frames, the first key frames indicating positions and attitudes of the image capturing device 7 in a coordinate system of the second object, and indicating positions and feature values of feature points in a plurality of images of the second object. In this case, the position calculator 13 calculates a first capturing condition based on the first feature points and the first feature point map, the first capturing condition indicating a position and an attitude of the image capturing device 7 at which the captured image is obtained. When a current first capturing condition corresponding to a current captured image can be predicted based on a previous first capturing condition corresponding to a previous captured image, the position calculator 13 predicts positions of first projected points in the current captured image, the first projected points corresponding to the first feature points included in the previous captured image, and searches for the first feature points corresponding to the first projected points, in a region including the first projected points, the region being smaller than the entire current captured image. When the current first capturing condition can not be predicted based on the previous first capturing condition, the position calculator 13 searches for, in the entire current captured image, the first feature points corresponding to the feature points included in the first key frame most similar to the current captured image. The position calculator 13 determines the current first capturing condition based on a number of the first feature points corresponding to the first projected points, or a number of the first feature points corresponding to the feature points included in the first key frame, and calculates the position of the target object based on the current first capturing condition.

With such a configuration, when the current first capturing condition can be predicted based on the previous first capturing condition, it is possible to perform estimation and feature point matching of the current first capturing condition, with little computational complexity and short processing time.

According to the first embodiment, the second feature point map may include a plurality of second key frames, the second key frames indicating positions and attitudes of the image capturing device 7 in a coordinate system of the second object, and indicating positions and feature values of feature points in a plurality of images of the second object. In this case, the position calculator 13 calculates a second capturing condition based on the second feature points and the second feature point map, the second capturing condition indicating a position and an attitude of the image capturing device 7 at which the captured image is obtained. When a current second capturing condition corresponding to a current captured image can be predicted based on a previous second capturing condition corresponding to a previous captured image, the position calculator 13 predicts positions of second projected points in the current captured image, the second projected points corresponding to the second feature points included in the previous captured image, and searches for the second feature points corresponding to the second projected points, in a region including the second projected points, the region being smaller than the entire current captured image. When the current second capturing condition can not be predicted based on the previous second capturing condition, the position calculator 13 searches for, in the entire current captured image, the second feature points corresponding to the feature points included in the second key frame most similar to the current captured image. The position calculator 13 determines the current second capturing condition based on a number of the second feature points corresponding to the second projected points, or a number of the second feature points corresponding to the feature points included in the second key frame.

With such a configuration, when the current second capturing condition can be predicted based on the previous second capturing condition, it is possible to perform estimation and feature point matching of the current second capturing condition, with little computational complexity and short processing time.

According to the first embodiment, when the position of the target object can not be calculated based on the first feature points and the first feature point map without referring to the second feature points and the second feature point map, the position calculator 13 may calculate the position of the target object based on the current second capturing condition.

With such a configuration, the position of the target object is calculated based on the current second capturing condition, only when the position of the target object can not be calculated based on the first feature points and the first feature point map. Therefore, it is less likely to prevent realtime control of the robot arm apparatus 4 due to much computational complexity and long processing time for the second feature values.

According to the first embodiment, when the position of the target object can not be calculated based on the first feature points and the first feature point map without referring to the second feature points and the second feature point map, the position calculator 13 may determine, as a reference key frame, the first key frame having the position and the attitude most similar to the position and the attitude of the current second capturing condition. In this case, the position calculator 13 further predicts the current first capturing condition corresponding to the current captured image, based on the reference key frame. In this case, the position calculator 13 further predicts positions of third projected points in the current captured image, the third projected points corresponding to the feature points included in the reference key frame. In this case, the position calculator 13 further searches for the first feature points corresponding to the third projected points, in a region including the third projected points, the region being smaller than the entire current captured image. In this case, the position calculator 13 further determines the current first capturing condition based on a number of the first feature points corresponding to the third projected points, and calculates the position of the target object based on the current first capturing condition.

With such a configuration, it is possible to calculate the position of the target object based on the first feature points, the first feature point map, the second feature points, and the second feature point map.

According to the first embodiment, the first deep learning model may be trained based on the plurality of images obtained by capturing the second object from a plurality of different positions.

With such a configuration, it is less likely to be affected by variations in location and direction of the second object.

According to the first embodiment, the first deep learning model may be trained based on the plurality of images obtained by capturing the second object with a plurality of different illuminances.

With such a configuration, it is less likely to be affected by variations in illuminance around the second object.

According to the first embodiment, the position calculator 13A, 13B may obtain an environmental parameter including at least one of illuminance, time, date, and weather. In this case, when the current environmental parameter satisfies a predetermined condition, the position calculator 13A, 13B calculates the position of the target object based on the first feature points, the first feature point map, the second feature points, and the second feature point map.

With such a configuration, it is possible to reduce unnecessary processing, and reduce a possibility of preventing the realtime control of the robot arm apparatus 4.

According to the first embodiment, the captured image may further include at least a part of the first object. The control apparatus 1 may be further provided with a position calculator 15 that calculates the position of the first object based on the captured image.

With such a configuration, it is possible to obtain calculates the position of the first object from the captured image.

According to the first embodiment, the control apparatus 1 may be further provided with a marker recognizer 14 that detects a marker 6 from the captured image. In this case, the marker 6 being fixed at a known position of the first object, the marker 6 having a pattern formed such that a position of the marker 6 in a coordinate system of the image capturing device 7 can be calculated. The position calculator 15 calculates the position of the first object based on the marker 6.

With such a configuration, it is possible to calculate the position of the tip of the first object in the coordinate system of the image capturing device 7, based on the image of the marker 6.

According to the first embodiment, the position calculator 13 may further calculate a direction of the target object based on the feature points of the second object, and the position calculator 15 may further calculate a direction of the first object based on the captured image. In this case, the control signal further includes angle information based on the direction of the target object and the direction of the first object.

With such a configuration, even when at least one of the first object and the second object does not have a known fixed position in the world coordinate system, it is possible to control the robot arm apparatus 4 to accurately perform the work on the second object using the first object.

According to the first embodiment, the position calculator 13 may calculate a position of the target object in a coordinate system of the image capturing device 7, and the position calculator 15 may calculate a position of the first object in the coordinate system of the image capturing device 7. In this case, the control signal generator 18 transforms the position of the target object and the position of the first object in the coordinate system of the image capturing device 7, into positions in a coordinate system of the robot arm apparatus 4, generates a control signal for moving the first object to the position of the target object, based on the transformed position of the target object and the transformed position of the first object, and outputs the control signal to the robot arm apparatus 4.

With such a configuration, even when at least one of the first object and the second object does not have a known fixed position in the world coordinate system, it is possible to control the robot arm apparatus 4 to accurately perform the work on the second object using the first object.

According to the first embodiment, a robot arm system is provided with: the robot arm apparatus 4; the image capturing device 7; and the control apparatus 1.

With such a configuration, it is possible to control the robot arm apparatus 4 to accurately move the first object and accurately perform the work on the second object, even when environmental conditions vary, without significantly increasing the processing time.

According to the first embodiment, a control method for controlling a robot arm apparatus 4 that moves a first object is provided. the control method includes setting a position of at least one target object in a second object. The control method includes reading, from a storage device, a first feature point map including positions of feature points of the second object detected by performing first image processing on a plurality of images of the second object, the first image processing being not based on deep learning. The control method includes reading, from the storage device, a second feature point map including positions of feature points of the second object detected using a first deep learning model that is trained in advance based on a plurality of images of the second object. The control method includes detecting first feature points of the second object by performing the first image processing on a captured image including at least a part of the second object obtained by an image capturing device 7. The control method includes detecting second feature points of the second object from the captured image using the first deep learning model. The control method includes calculating a position of the target object based on the first feature points and the first feature point map without referring to the second feature points and the second feature point map, and when the position of the target object can not be calculated based on the first feature points and the first feature point map without referring to the second feature points and the second feature point map, calculating the position of the target object based on the first feature points, the first feature point map, the second feature points, and the second feature point map. The control method includes generating a control signal for moving the first object to the position of the target object, based on the position of the target object and the position of the first object, and outputting the control signal to the robot arm apparatus 4.

With such a configuration, it is possible to control the robot arm apparatus 4 to accurately move the first object and accurately perform the work on the second object, even when environmental conditions vary, without significantly increasing the processing time.

### Second Embodiment

Next, a robot arm system according to a second embodiment will be described. In the first embodiment, a position of a tip of a holdable object is calculated based on a marker fixed at a known position of the holdable object. On the other hand, in the second embodiment, a case where a position of a tip of a holdable object is calculated without using a marker will be described.

### [Configuration of Second Embodiment]

### [Overall Configuration]

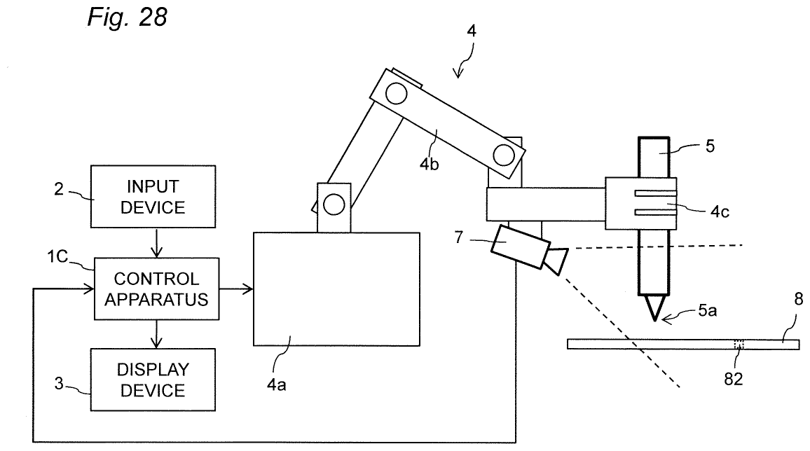

FIG. 28 is a schematic diagram illustrating a configuration of a robot arm system according to a second embodiment. The robot arm system in FIG. 28 does not include the marker 6 in FIG. 1, and is provided with a control apparatus 1C, instead of the control apparatus 1 in FIG. 1.

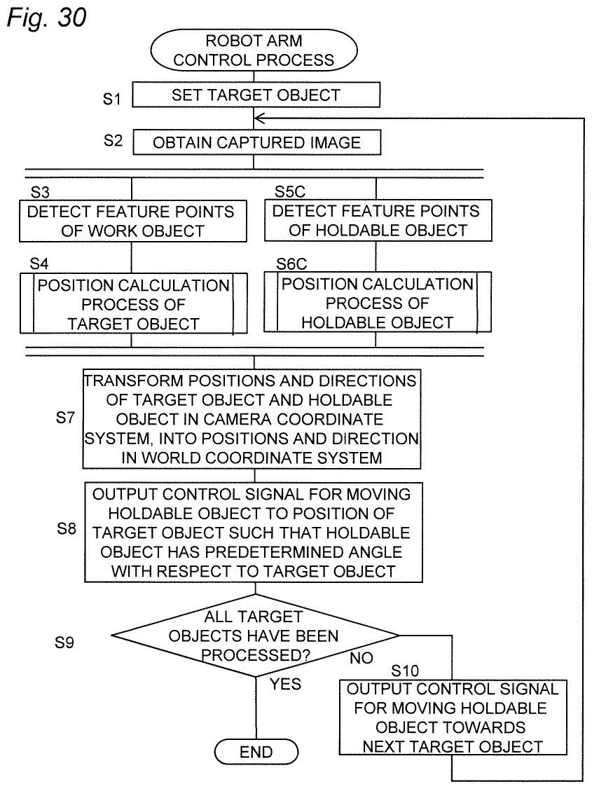

The control apparatus 1C executes a robot arm control process in FIG. 30 (that will be described below), instead of the robot arm control process in FIG. 11.

The other constituents of the robot arm system in FIG. 28 are configured in a manner similar to that of the corresponding constituents of the robot arm system in FIG. 1.

### [Configuration of Control Apparatus]

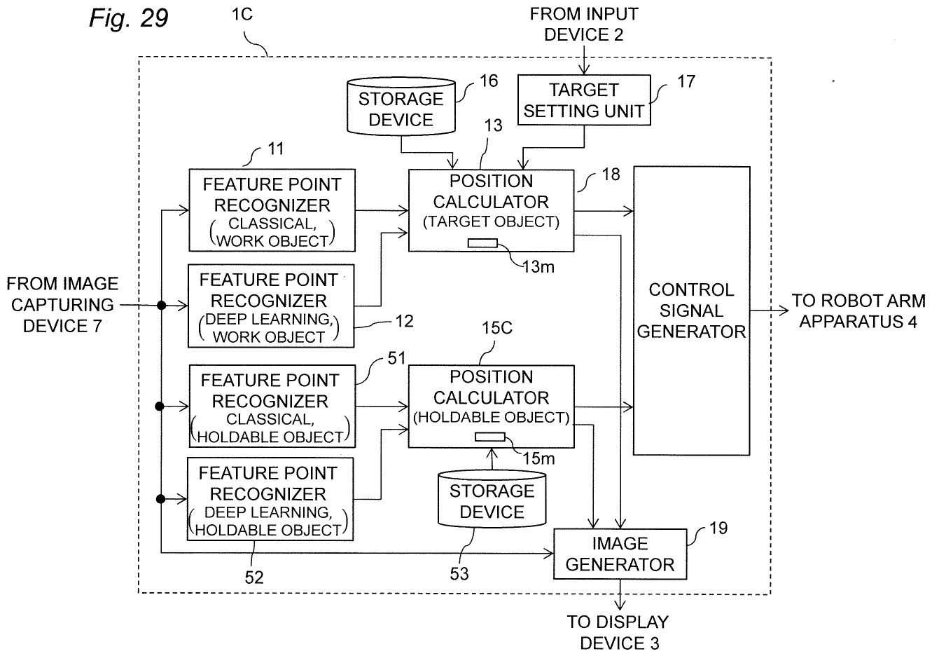

FIG. 29 is a block diagram illustrating a configuration of the control apparatus 1C in FIG. 28. The control apparatus 1C is provided with: a feature point recognizer (third feature point recognizer) 51, a feature point recognizer (fourth feature point recognizer) 52, a storage device (second storage device) 53, and a position calculator 15C, instead of the marker recognizer 14 and the position calculator 15 in FIG. 5.

The feature point recognizer 51 detects third feature points of the power screwdriver 5 by performing classical image processing on the captured image obtained by the image capturing device 7, the classical image processing being not based on deep learning, the captured image including at least a part of the circuit board 8 and the tip 5a of the power screwdriver 5. The feature point recognizer 51 may be configured, for example, in a manner similar to the feature point recognizer 11 in FIG. 6.

The feature point recognizer 52 detects fourth feature points of the power screwdriver 5 from the captured image using a deep learning model trained in advance based on a plurality of images of the power screwdriver 5. The deep learning model may be trained based on a plurality of images obtained by capturing the power screwdriver 5 from a plurality of different positions. Further, the deep learning model may be trained based on a plurality of images obtained by capturing the power screwdriver 5 with a plurality of different illuminances. The feature point recognizer 52 may be configured, for example, in a manner similar to that of the feature point recognizer 12, so as to operate as the deep neural network in FIG. 7.

The storage device 53 stores in advance a third feature point map including positions and feature values of feature points of the power screwdriver 5 detected by performing image processing on a plurality of images of the power screwdriver 5, the image processing being not based on deep learning, in a manner similar to that of the feature point recognizer 51. In addition, the storage device 53 stores in advance a fourth feature point map including positions and feature values of feature points of the power screwdriver 5 detected using the deep learning model trained in advance based on a plurality of images of the power screwdriver 5, in a manner similar to that of the feature point recognizer 52. Each of the third and fourth feature point maps includes a plurality of map points and a plurality of key frames, related to the plurality of feature points included in the power screwdriver 5. Each map point includes a position (three-dimensional coordinates) of a feature point of the power screwdriver 5 in the holdable object coordinate system, a feature value of the feature point, and an index number of the feature point. The map points are generated based on a plurality of images obtained by capturing the power screwdriver 5 from a plurality of different positions. Each key frame indicates a status of the image capturing device 7 at which when the power screwdriver 5 is captured from one of the plurality of different positions to generate the map points, and also indicates a captured image. That is, each key frame includes the position (three-dimensional coordinates) and the attitude of the image capturing device 7 in the holdable object coordinate system, the positions (two-dimensional coordinates) and the feature values of the feature points in one of the images of the power screwdriver 5, and the index numbers of the map points corresponding to the feature points in one of the images.

The third feature point map is generated from a plurality of images (also referred to as “third reference images”) of the power screwdriver 5 provided in advance. In addition, the third feature point map includes a plurality of feature points (also referred to as “third reference feature points”) to be compared (matched) with the third feature points of the captured image detected by the feature point recognizer 51. Similarly, the fourth feature point map is generated from a plurality of images (also referred to as “fourth reference images”) of the power screwdriver 5 provided in advance. In addition, the fourth feature point map includes a plurality of feature points (also referred to as “fourth reference feature points”) to be compared (matched) with the fourth feature points of the captured image detected by the feature point recognizer 52. The third and fourth feature point maps may be generated from the same set of images of the power screwdriver 5, or may be generated from different sets of images, respectively. In addition, the plurality of images of the power screwdriver 5 for generating the third and fourth feature point maps may be obtained by an image capturing device having the same model number and the same specifications as those of the image capturing device 7, or may be obtained by other one or more image capturing devices.

Hereinafter, the map points of the third feature point map will be referred to as “third map points”, and the map points of the fourth feature point map will be referred to as “fourth map points”. The key frames of the third feature point map will be referred to as “third key frames” or “key frames K3”, and the key frames of the fourth feature point map will be referred to as “fourth key frames” or “key frames K4”.

The position calculator 15C calculates a direction of the power screwdriver 5 in the camera coordinate system, and calculates a position of the tip 5a of the power screwdriver 5 in the camera coordinate system, based on the third feature points of the power screwdriver 5 detected by the feature point recognizer 51, and the fourth feature points of the power screwdriver 5 detected by the feature point recognizer 52, and with reference to the third and fourth feature point maps read from the storage device 53. At first, the position calculator 15C calculates the position and the direction of the power screwdriver 5 based on the third feature points and the third feature point map without referring to the fourth feature points and the fourth feature point map. When the position and the direction of the power screwdriver 5 can not be calculated based on the third feature points and the third feature point map without referring to the fourth feature points and the fourth feature point map, the position calculator 15C calculates the position and the direction of the power screwdriver 5 based on the third feature points, the third feature point map, the fourth feature points, and the fourth feature point map.

In addition, as will be detailed below, the position calculator 15C refers to a capturing condition indicating the position and the attitude of the image capturing device 7 at which the captured image is obtained, in order to calculate the position and the direction of the power screwdriver 5 in the camera coordinate system. To this end, based on the third feature points and the third feature point map, the position calculator 15C calculates a third capturing condition indicating the position and the attitude of the image capturing device 7 at which the captured image is obtained, and performs matching between the third feature points detected from the captured image and the feature points of the third feature point map. The third capturing condition indicates the position and the attitude of the image capturing device 7 in the holdable object coordinate system. In addition, based on the fourth feature points and the fourth feature point map, the position calculator 15C calculates a fourth capturing condition indicating the position and the attitude of the image capturing device 7 at which the captured image is obtained, and performs matching between the fourth feature points detected from the captured image and the feature points of the fourth feature point map. The fourth capturing condition also indicates the position and the attitude of the image capturing device 7 in the holdable object coordinate system. The position calculator 15C is provided with a memory 15m that stores the third and fourth capturing conditions, and feature point matching results.

The other constituents of the control apparatus 1C in FIG. 29 are configured in a manner similar to that of the corresponding constituents of the control apparatus 1 in FIG. 5.

Although FIG. 29 illustrates a case where the control apparatus 1C is provided with the two storage devices 16 and 53, these storage devices may be integrated with each other.

### [Operation of Second Embodiment]

FIG. 30 is a flowchart illustrating a robot arm control process executed by the control apparatus 1C in FIG. 28. The process in FIG. 30 includes steps S5C and S6C, instead of steps S5 and S6 in FIG. 11.

The feature point recognizer 51 detects third feature points of the power screwdriver 5 from the captured image, and the feature point recognizer 52 detects fourth feature points of the power screwdriver 5 from the captured image (step S5C).

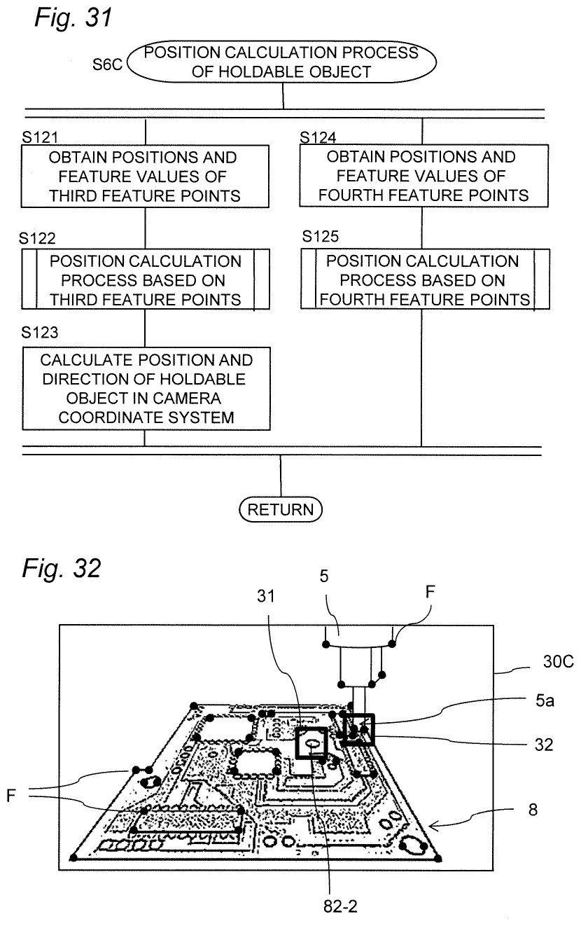

Next, the position calculator 15C executes a position calculation process for holdable object, to calculate the position and the direction of the power screwdriver 5 in the camera coordinate system (step S6C). The position calculation process for holdable object will be described below with reference to FIG. 31.

The other steps in FIG. 30 are similar to corresponding steps in FIG. 11.

FIG. 31 is a flowchart illustrating a subroutine of step S6C (position calculation process for holdable object) in FIG. 30.

The position calculator 15C obtains the positions and the feature values of the third feature points from the feature point recognizer 51 (step S121). In this case, the position calculator 15C further obtains the captured image from the feature point recognizer 51.

Next, the position calculator 15C executes a position calculation process based on third feature points (step S122). In this case, the position calculator 15C calculates a third capturing condition C3 based on the third feature points and the third feature point map, the third capturing condition C3 indicating the position and the attitude of the image capturing device 7 at which the captured image is obtained. In addition, the position calculator 15C performs matching between the third feature points detected from the captured image, and the feature points of the third feature point map. The position calculation process based on third feature points is similar to the process in step S12 described with reference to FIG. 14, except for performing estimation and feature point matching of the third capturing condition C3, instead of estimation and feature point matching of the first capturing condition C1, based on the third feature points and the third feature point map, instead of the first feature points and the first feature point map.

Next, the position calculator 15C calculates a position and a direction of the power screwdriver 5 in the camera coordinate system based on the third capturing condition C3, that is, the position and the attitude of the image capturing device 7 in the holdable object coordinate system (step S123).

In addition, the position calculator 15C obtains positions and feature values of the fourth feature points from the feature point recognizer 52 (step S124).

Next, the position calculator 15C executes a position calculation process based on fourth feature points (step S125). In this case, the position calculator 15C calculates a fourth capturing condition C4 based on the fourth feature points and the fourth feature point map, the fourth capturing condition C4 indicating the position and the attitude of the image capturing device 7 at which the captured image is obtained. In addition, the position calculator 15C performs matching between the fourth feature points detected from the captured image, and the feature points of the fourth feature point map. The position calculation process based on fourth feature points is similar to the process in step S15 described with reference to FIG. 22, except for performing estimation the feature point matching of the fourth capturing condition C4, instead of estimation and feature point matching of the second capturing condition C2, based on the fourth feature points and the fourth feature point map, instead of the second feature points and the second feature point map.

Steps S121 to S125 may be executed in parallel as illustrated in FIG. 31, or may be sequentially executed.

By executing the process in FIG. 31, it is possible to calculate the position and the direction of the power screwdriver 5 in the camera coordinate system.

FIG. 32 is a diagram illustrating an exemplary image 30C displayed on the display device 3 in FIG. 28. According to the second embodiment, even when not using a marker fixed at a known position of the power screwdriver 5, it is possible to calculate the position of the tip 5a of the power screwdriver 5, as illustrated in FIG. 32, based on the third or fourth feature points F of the power screwdriver 5 detected from the captured image.

The control apparatus 1C for the robot arm apparatus 4 according to the second embodiment is characterized by a combination of detection of feature points using the classical image processing, and detection of feature points using the deep learning model, in order to calculate the position of the holdable object. In addition, the control apparatus 1C for the robot arm apparatus 4 according to the second embodiment is characterized by a combination of the tracked feature point matching process, that is, the feature point matching in the region smaller than the entire captured image, and the global feature point matching process, that is, the feature point matching in the entire captured image, in order to calculate the position of the holdable object. As a result, according to the control apparatus 1C for the robot arm apparatus 4 of to the second embodiment, it is possible to control the robot arm apparatus 4 to accurately move the holdable object and accurately perform the work on the work object, even when environmental conditions vary, without significantly increasing the processing time. In other words, it is possible to provide the control apparatus 1C for the robot arm apparatus 4, that is robust to variations in environmental conditions and does not impair realtime performance.

### [Advantageous Effects and Others of Second Embodiment]

According to the second embodiment, a control apparatus 1C for controlling a robot arm apparatus 4 that moves a first object is provided with: a target setting unit 17, a storage device 16, a feature point recognizer 11, a feature point recognizer 12, a position calculator 13, and a control signal generator 18. The target setting unit 17 sets a position of at least one target object in a second object. The storage device 16 stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The feature point recognizer 11 detects first feature points of the second object by performing the first image processing on a captured image including at least a part of the second object obtained by an image capturing device 7. The feature point recognizer 12 detects second feature points of the second object from the captured image using the first deep learning model. The position calculator 13 calculates a position of the target object based on the first feature points and the first feature point map without referring to the second feature points and the second feature point map. When the position of the target object can not be calculated based on the first feature points and the first feature point map without referring to the second feature points and the second feature point map, the position calculator 13 calculates the position of the target object based on the first feature points, the first feature point map, the second feature points, and the second feature point map. The control signal generator 18 generates a control signal for moving the first object to the position of the target object, based on the position of the target object and the position of the first object, and outputs the control signal to the robot arm apparatus 4.

With such a configuration, it is possible to control the robot arm apparatus 4 to accurately move the first object and accurately perform the work on the second object, even when environmental conditions vary, without significantly increasing the processing time.

According to the second embodiment, the control apparatus 1C may be further provided with: a storage device 53, a feature point recognizer 51, and a feature point recognizer 52. In this case, the storage device 53 stores a third feature point map and a fourth feature point map in advance, the first feature point map the third feature point map including positions of feature points of the first object detected by performing second image processing on a plurality of images of the first object, the second image processing being not based on deep learning, and the fourth feature point map including positions of feature points of the first object detected using a second deep learning model that is trained in advance based on a plurality of images of the first object. The feature point recognizer 51 detects third feature points of the first object by performing the second image processing on the captured image. The feature point recognizer 52 detects fourth feature points of the first object from the captured image using the second deep learning model. The position calculator 15C calculates the position of the first object based on the third feature points and the third feature point map without referring to the fourth feature points and the fourth feature point map, and when the position of the first object can not be calculated based on the third feature points and the third feature point map without referring to the fourth feature points and the fourth feature point map, the position calculator 15C calculates the position of the first object based on the third feature points, the third feature point map, the fourth feature points, and the fourth feature point map.

With such a configuration, it is possible to calculate the position of the first object without using a marker. In addition, it is possible to accurately calculate the position of the first object, even when environmental conditions vary, without significantly increasing the processing time.

### Third Embodiment

Next, a robot arm system according to a third embodiment will be described. In a third embodiment, a case will be described where a robot arm apparatus directly performs a work on a work object without an intervening holdable object, and a tip of the robot arm apparatus contact with the work object has a known position in the camera coordinate system. In other words, in the third embodiment, a case where the holdable object is integrated with the robot arm apparatus will be described.

### [Configuration of Third Embodiment]

### [Overall Configuration]

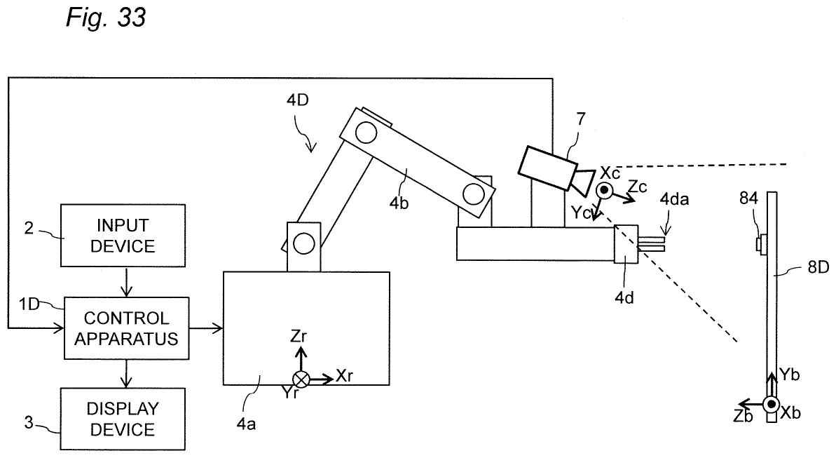

FIG. 33 is a schematic diagram illustrating a configuration of a robot arm system according to a third embodiment. The robot arm system in FIG. 33 is provided with a control apparatus 1D, a robot arm apparatus 4D, and a panel 8D, instead of the control apparatus 1, the robot arm apparatus 4, the power screwdriver 5, and the circuit board 8 in FIG. 1.

The control apparatus 1D controls the robot arm apparatus 4D based on the captured image obtained by the image capturing device 7, and/or based on user inputs obtained via the input device 2.

The panel 8D is, for example, a control panel provided with one or more switches 84. The switches 84 include, for example, a push switch, a toggle switch, a rotary switch, and the like.

The robot arm apparatus 4D is provided with an end effector 4d, instead of the hand 4c of the robot arm apparatus 4 in FIG. 1. The end effector 4d is configured to contact with the switch 84 at a tip 4da thereof, and to be operable to perform pressing, gripping, rotating, or the like, according to a configuration of the switch 84.

The image capturing device 7 obtains a captured image including the tip 4da of the end effector 4d and at least a part of the panel 8D.

The image capturing device 7 is fixed at a known position with respect to the tip 4da of the end effector 4d. In this case, the image capturing device 7 is fixed to the same link as the one to which the end effector 4d is connected, among the plurality of links of the arm 4b. As a result, there is no movable part, such as a joint of the arm 4b, between the image capturing device 7 and the end effector 4d, and therefore, the relative position of the image capturing device 7 with respect to the tip 4da of the end effector 4d is fixed. Consequently, the tip 4da of the end effector 4d has a known position in the camera coordinate system.

The robot arm apparatus 4D moves the tip (or “first object”) of the robot arm apparatus 4D to a position of at least one target object in a work object (or “second object”), under the control of the control apparatus 1D. In the example in FIG. 33, the panel 8D is a work object to be directly worked by the robot arm apparatus 4D. When at least one switch 84 in the panel 8D is set as a target object, the robot arm apparatus 4D moves the tip 4da of the end effector 4d to the position of the switch 84, and operates the switch 84 using the end effector 4d. The robot arm apparatus 4D is an example of a conveyance apparatus that moves the first object to the position of the target object in the second object.

In the present specification, the tip 4da of the end effector 4d is regarded as a tip of the robot arm apparatus 4D (also referred to as “arm tip”).

### [Configuration of Control Apparatus]

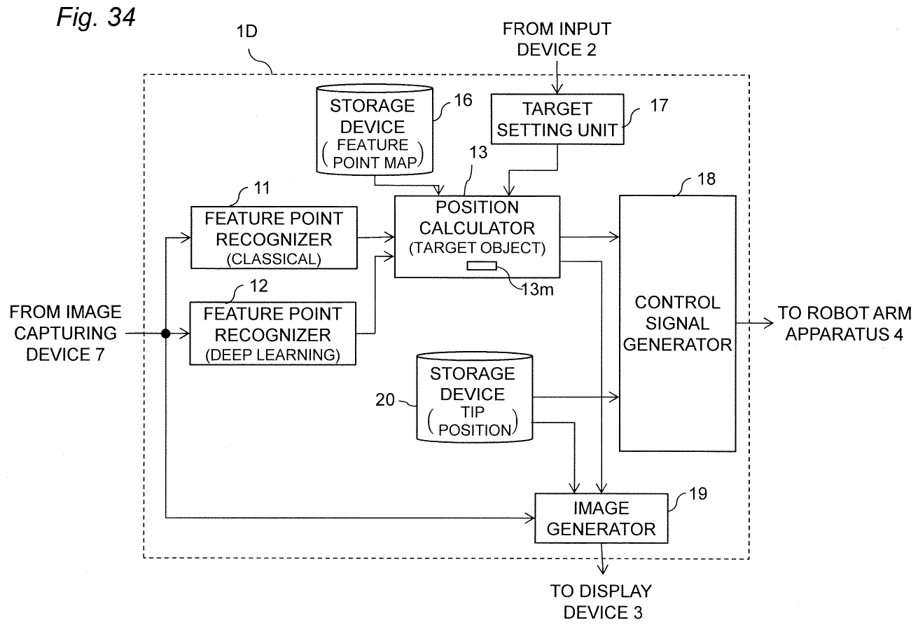

FIG. 34 is a block diagram illustrating a configuration of the control apparatus 1D in FIG. 33. The control apparatus 1D is provided with a storage device 20, instead of the marker recognizer 14 and the position calculator 15 in FIG. 5.

The storage device 20 stores in advance a position and a direction of the tip 4da of the end effector 4d in the camera coordinate system. The position and the direction are calculated based on, for example, design data of the robot arm apparatus 4D.

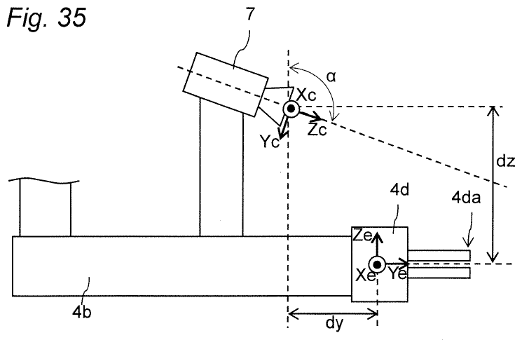

FIG. 35 is an enlarged view illustrating the tip of the arm 4b in FIG. 33. Calculation of a position and a direction of the tip 4da of the end effector 4d in the camera coordinate system will be described with reference to FIG. 35.

In order to describe a position and a direction of the tip 4da of the end effector 4d in the camera coordinate system, a coordinate system of the end effector 4d will be referred to as illustrated in FIG. 35. The end effector 4d has a three-dimensional coordinate system based on the position and the attitude of the end effector 4d. The coordinate system of the end effector 4d has coordinate axes Xe, Ye, and Ze. For example, an origin of the coordinate system of the end effector 4d is provided within a housing of the end effector 4d, and a direction of the coordinate system of the end effector 4d is set such that one of the coordinate axes passes through the tip 4da of the end effector 4d.

Coordinate transformation from the position (xe, ye, ze) in the coordinate system of the end effector 4d to the position (xc, yc, zc) in the camera coordinate system is expressed, for example, using a homogeneous coordinate transformation matrix, as follows.

$$\begin{matrix}[ Mathematical Expression 6 ] & \\ ( \begin{matrix}x c \\ y c \\ zc \\ 1\end{matrix} ) = {( \begin{matrix}{R}_{e c} & {t}_{e c} \\ 0 & 1\end{matrix} )}^{- 1} ( \begin{matrix}x e \\ y e \\ z e \\ 1\end{matrix} ) & ( 6 )\end{matrix}$$

Here, R_{ec} is a matrix indicating the direction of the camera coordinate system with reference to the direction of the coordinate system of the end effector 4d, and t_{ec} is a vector indicating the position (dx, dy, dz) of the origin of the camera coordinate system in the coordinate system of the end effector 4d. The matrix R_{ec} can be expressed by, for example, a product of matrices R_{α}, R_{β}, and R_{γ} representing rotation angles α, β, and γ around the X axis, the Y axis, and the Z axis, respectively.

The position and the direction of the tip 4da of the end effector 4d in the coordinate system of the end effector 4d are known from the design data of the robot arm apparatus 4D. Therefore, the position and the direction of the tip 4da of the end effector 4d in the camera coordinate system can be calculated using Mathematical Expression (6) based on the position and the direction of the tip 4da of the end effector 4d in the coordinate system of the end effector 4d.

Even when the end effector 4d is provided with a movable part(s), a trajectory of the tip 4da in the coordinate system of the end effector 4d is known, and therefore, the tip 4da has a known position and direction in the camera coordinate system.

The feature point recognizer 11, the feature point recognizer 12, the position calculator 13, the storage device 16, and the target setting unit 17 in FIG. 34 are configured and operate in a substantially similar manner to that of the corresponding constituents in FIG. 5. It should be noted that the constituents 11 to 13, 16, and 17 in FIG. 34 calculate a position and a direction of the switch 84 of the panel 8D, instead of the position and the direction of the screw hole 82 of the circuit board 8.

The control signal generator 18 transforms the position and the direction of the switch 84 in the camera coordinate system calculated by the position calculator 13, into a position and a direction in the world coordinate system. In addition, the control signal generator 18 transforms the position and the direction of the tip 4da of the end effector 4d in the camera coordinate system read from the storage device 20, into a position and a direction in the world coordinate system. In addition, the control signal generator 18 outputs a control signal to the robot arm apparatus 4D, based on the transformed position and direction of the switch 84, and the transformed position and direction of the tip 4da of the end effector 4d, the control signal for moving the tip 4da of the end effector 4d to the position of the switch 84. Consequently, the control apparatus 1D automatically controls the robot arm apparatus 4D.

The image generator 19 outputs the captured image to the display device 3. In addition, the image generator 19 may output the feature points of the panel 8D, the position of the switch 84, and the position of the tip 4da of the end effector 4d, to the display device 3, such that the feature points of the panel 8D, the position of the switch 84, and the position of the tip 4da of the end effector 4d overlap the captured image.

Although FIG. 34 illustrates a case where the control apparatus 1D is provided with two storage devices 16 and 20, these storage devices may be integrated with each other.

### [Operation of Third Embodiment]

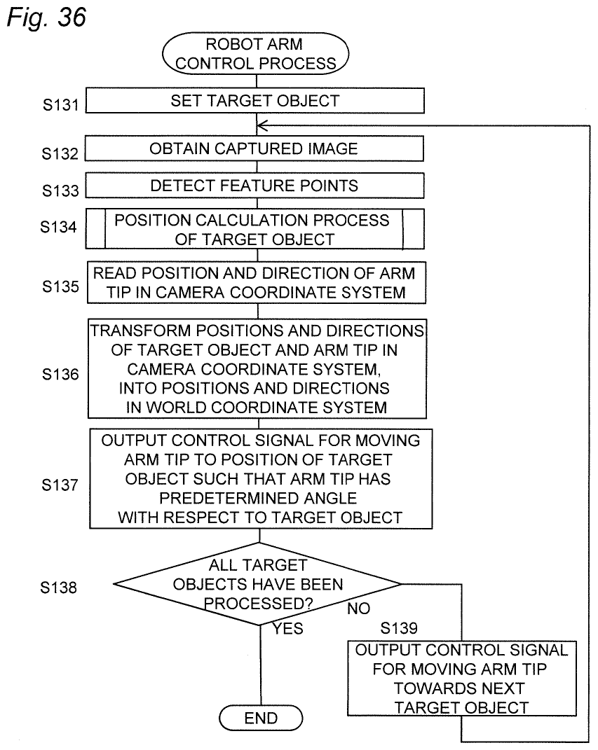

FIG. 36 is a flowchart illustrating a robot arm control process executed by the control apparatus 1D in FIG. 33.

The target setting unit 17 sets at least one switch 84 in the panel 8D as a target object (step S131).

The control apparatus 1D obtains a captured image from the image capturing device 7 (step S132).

The feature point recognizer 11 detects first feature points of the panel 8D from the captured image, and the feature point recognizer 12 detects second feature points of the panel 8D from the captured image (step S133).

The position calculator 13 executes a position calculation process for target object, to calculate a position and a direction of the switch 84 in the camera coordinate system (step S134).

Step S134 is substantially similar to the process in step S4 described with reference to FIG. 12, except for calculating the position and the direction of the switch 84 of the panel 8D, instead of the position and the direction of the screw hole 82 of the circuit board 8.

The control signal generator 18 reads the position and the direction of the tip 4da of the end effector 4d in the camera coordinate system, from the storage device 20 (step S135).

The control signal generator 18 transforms the positions and the directions of the switch 84 and the tip 4da of the end effector 4d in the camera coordinate system, into positions and directions in the world coordinate system (step S136).

The control signal generator 18 outputs a control signal for moving the tip 4da of the end effector 4d to the position of the switch 84, such that the tip 4da of the end effector 4d has a predetermined angle with respect to the switch 84 (for example, the switch 84 as a push switch is vertically pressed down by the end effector 4d) (step S137).

The control apparatus 1D may repeatedly execute steps S132 to S137, while moving the tip 4da of the end effector 4d to the position of the switch 84.

When a plurality of switches 84 in the panel 8D are set as target objects, the control signal generator 18 determines whether or not all the target objects have been processed (step S138): if YES the process ends; if NO, the process proceeds to step S139.

The control signal generator 18 outputs a control signal for moving the tip 4da of the end effector 4d toward the next switch 84 (step S139). Thereafter, the control apparatus 1D repeatedly executes steps S132 to S139.

According to the third embodiment, even when the panel 8D does not have a fixed known position in the world coordinate system, it is possible to control the robot arm apparatus 4D to accurately perform the work on the panel 8D, by calculating the position and the direction in the world coordinate system based on the captured image. According to the third embodiment, even when the panel 8D moves, it is possible to follow the changes in their positions and directions, and control the robot arm apparatus 4D to accurately perform the work on the panel 8D.

The control apparatus 1D for the robot arm apparatus 4D according to the third embodiment is characterized by a combination of detection of feature points using the classical image processing, and detection of feature points using the deep learning model, in order to calculate the position of a target object. In addition, the control apparatus 1D for the robot arm apparatus 4D according to the third embodiment is characterized by a combination of the tracked feature point matching process, that is, the feature point matching in the region smaller than the entire captured image, and the global feature point matching process, that is, the feature point matching in the entire captured image, in order to calculate the position of a target object. As a result, according to the control apparatus 1D for the robot arm apparatus 4D of the third embodiment, it is possible to control the robot arm apparatus 4D to accurately move the holdable object and accurately perform the work on the work object, even when environmental conditions vary, without significantly increasing the processing time. In other words, it is possible to provide the control apparatus 1D for the robot arm apparatus 4D, that is robust to variations in environmental conditions and does not impair realtime performance.

### [Advantageous Effects and Others of Third Embodiment]

According to the third embodiment, a control apparatus 1D for controlling a robot arm apparatus 4D that moves a first object is provided with: a target setting unit 17, a storage device 16, a feature point recognizer 11, a feature point recognizer 12, a position calculator 13, and a control signal generator 18. The target setting unit 17 sets a position of at least one target object in a second object. The storage device 16 stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The feature point recognizer 11 detects first feature points of the second object by performing the first image processing on a captured image including at least a part of the second object obtained by an image capturing device 7. The feature point recognizer 12 detects second feature points of the second object from the captured image using the first deep learning model. The position calculator 13 calculates a position of the target object based on the first feature points and the first feature point map without referring to the second feature points and the second feature point map. When the position of the target object can not be calculated based on the first feature points and the first feature point map without referring to the second feature points and the second feature point map, the position calculator 13 calculates the position of the target object based on the first feature points, the first feature point map, the second feature points, and the second feature point map. The control signal generator 18 generates a control signal for moving the first object to the position of the target object, based on the position of the target object and the position of the first object, and outputs the control signal to the robot arm apparatus 4D.

With such a configuration, it is possible to control the robot arm apparatus 4D to accurately move the first object and accurately perform the work on the second object, even when environmental conditions vary, without significantly increasing the processing time.

In addition, even when work object does not have a known fixed position in the world coordinate system, it is possible to control the robot arm apparatus 4D to accurately perform the work on the work object. For example, even when “a deviation of work object” occurs, in which a part of the robot arm apparatus 4D strikes the work object during the work, and the work object deviates from a workbench fixed to the world coordinate system, it is possible to accurately perform the work. In addition, even when “mismatch of control” occurs, in which predicted coordinates of the tip of the robot arm apparatus 4D deviate from actual coordinates through repetition of the work, it is possible to accurately perform the work.

According to the third embodiment, the first object may be an end effector 4d fixed to a predetermined part of the robot arm apparatus 4D. In this case, the image capturing device 7 is fixed at a known position with respect to the end effector 4d.

With such a configuration, even when the first object is integrated with the robot arm apparatus 4D, it is possible to control the robot arm apparatus 4D to accurately move the first object and accurately perform the work on the second object.

### Fourth Embodiment

Next, a conveyance system according to a fourth embodiment will be described. The technique according to the first to third embodiments, that is, the technique of detecting the first feature points of the captured image by performing the classical image processing not based on deep learning, and further detecting the second feature points from the captured image using the deep learning model, is applicable not only to the robot arm apparatus, but also to any other conveyance apparatus that moves some object. In the fourth embodiment, a case where the technique according to the first to third embodiments is applied to a crane apparatus will be described.

### [Configuration of Fourth Embodiment]

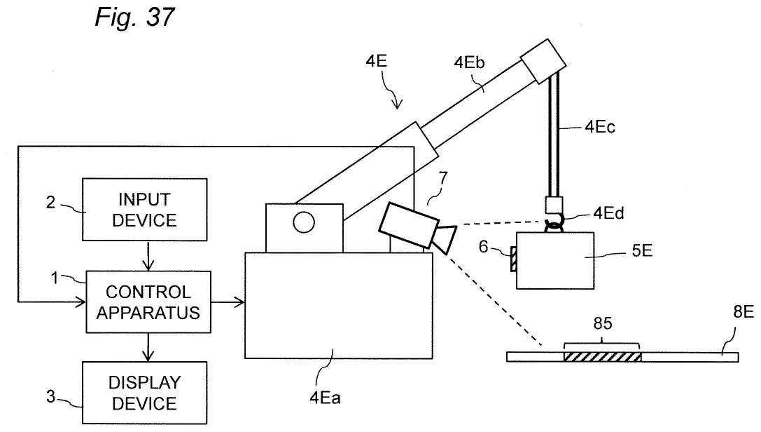

FIG. 37 is a schematic diagram illustrating a configuration of a conveyance system according to the fourth embodiment. The conveyance system in FIG. 37 is provided with a crane apparatus 4E, a load 5E, and a yard 8E, instead of the robot arm apparatus 4, the power screwdriver 5, and the circuit board 8 in FIG. 1.

The crane apparatus 4E is provided with: a main body 4Ea, a boom 4Eb, a wire 4Ec, and a hook 4Ed. The main body 4Ea is fixed to the ground. The boom 4Eb is supported by the main body 4Ea at a variable azimuth angle and a variable elevation angle, and further extends and contracts. The hook 4Ed is suspended from a tip of the boom 4Eb via the wire 4Ec. Thus, the crane apparatus 4E conveys the load 5E by suspending the load 5E using the hook 4Ed.

The control apparatus 1, the input device 2, and the display device 3 are configured in a manner similar to that of the corresponding constituents in FIG. 1. The image capturing device 7 is fixed to the crane apparatus 4E, such that when the crane apparatus 4E suspends the load 5E, the image capturing device 7 can capture the load 5E. The marker 6 is fixed to the load 5E, such that when the crane apparatus 4E suspends the load 5E, the image capturing device 7 can capture the marker 6.

The yard 8E has a target region 85.

The crane apparatus 4E moves the load 5E (or “first object”) to a target object in the yard 8E (or “second object”), under the control of the control apparatus 1. In the example in FIG. 37, the target region 85 is set as a target object. The crane apparatus 4E is an example of a conveyance apparatus that moves the first object to the position of the target object in the second object.

The control apparatus 1 in FIG. 37 moves the load 5E to the target region 85 by executing a substantially similar process to the process in FIG. 11, except for controlling the crane apparatus 4E instead of the robot arm apparatus 4.

According to the fourth embodiment, even when the target region 85 does not have a known position fixed in the world coordinate system, it is possible to control the crane apparatus 4E to accurately move the load 5E, by calculating a position and a direction in the world coordinate system based on the captured image. According to the fourth embodiment, even when the target region 85 is changed, it is possible to follow changes in a position and a direction thereof, and control the crane apparatus 4E to accurately move the load 5E.

The control apparatus 1 for the crane apparatus 4E according to the fourth embodiment is characterized by a combination of detection of feature points using the classical image processing, and detection of feature points using the deep learning model, in order to calculate the position of the target object. In addition, the control apparatus 1 for the crane apparatus 4E according to the fourth embodiment is characterized by a combination of the tracked feature point matching process, that is, the feature point matching in the region smaller than the entire captured image, and the global feature point matching process, that is, the feature point matching in the entire captured image, in order to calculate the position of the target object. Consequently, according to the control apparatus 1 for the crane apparatus 4E of the fourth embodiment, it is possible to control the crane apparatus 4E to accurately move the holdable object and accurately perform the work on the work object, even when environmental conditions vary, without significantly increasing the processing time. In other words, it is possible to provide the control apparatus 1 for the crane apparatus 4E, that is robust to variations in environmental conditions and does not impair realtime performance.

### [Advantageous Effects and Others of Fourth Embodiment]

According to the fourth embodiment, a control apparatus 1 for controlling a conveyance apparatus 4E that moves a first object is provided with: a target setting unit 17, a storage device 16, a feature point recognizer 11, a feature point recognizer 12, a position calculator 13, and a control signal generator 18. The target setting unit 17 sets a position of at least one target object in a second object. The storage device 16 stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The feature point recognizer 11 detects first feature points of the second object by performing the first image processing on a captured image including at least a part of the second object obtained by an image capturing device 7. The feature point recognizer 12 detects second feature points of the second object from the captured image using the first deep learning model. The position calculator 13 calculates a position of the target object based on the first feature points and the first feature point map without referring to the second feature points and the second feature point map. When the position of the target object can not be calculated based on the first feature points and the first feature point map without referring to the second feature points and the second feature point map, the position calculator 13 calculates the position of the target object based on the first feature points, the first feature point map, the second feature points, and the second feature point map. The control signal generator 18 generates a control signal for moving the first object to the position of the target object, based on the position of the target object and the position of the first object, and outputs the control signal to the crane apparatus 4E.

With such a configuration, it is possible to control the conveyance apparatus to accurately move the first object, even when environmental conditions vary, without significantly increasing the processing time.

The technique of the first to third embodiment can be applied not only to the crane apparatus, but also to any other conveyance apparatus, such as, a belt conveyer, a folk lift, and the like.

### Fifth Embodiment

Next, a vehicle according to a fifth embodiment will be described. The technique according to the first to fourth embodiments, that is, the technique of detecting first feature points of the captured image by performing the classical image processing not based on the deep learning, and further detecting second feature points from the captured image using the deep learning model, can be applied not only to the robot arm apparatus and the crane apparatus, but also to any other conveyance apparatus that moves some object. An object to be moved may be a conveyance apparatus itself. In the fifth embodiment, a case where the technique according to the first to fourth embodiments is applied to a vehicle, such as an automatic guided vehicle, will be described.

### [Configuration of Fifth Embodiment]

### [Overall Configuration]

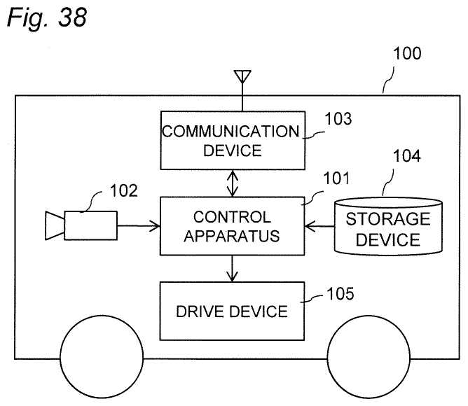

FIG. 38 is a block diagram illustrating a configuration of a vehicle 100 according to the fifth embodiment. The vehicle 100 is provided with: a control apparatus 101, an image capturing device 102, a communication device 103, a storage device 104, and a drive device 105.

The control apparatus 101 controls entire operations of the vehicle 100. The image capturing device 102 captures objects, such as roads and obstacles around the vehicle 100, to generate a captured image. The communication device 103 communicates with an external server apparatus, and receives control signals, including a destination of the vehicle 100 and others, from the server apparatus. The storage device 104 stores a map of surroundings of a place where the vehicle 100 travels. The drive device 105 controls traveling of the vehicle 100 based on a position of the vehicle 100 determined by the control apparatus 101.

The vehicle 100 may be a manned or unmanned automatic guided vehicle. The vehicle 100 may transmit an information signal indicating the position, status, and the like of the vehicle 100, to an external server apparatus.

The vehicle 100 moves the vehicle 100 itself (or “first object”) to a target object on a road or a building (or “second object”), under the control of the control apparatus 101. The vehicle 100 is an example of a conveyance apparatus that moves the first object to the position of the target object in the second object.

### [Configuration of Control Apparatus]

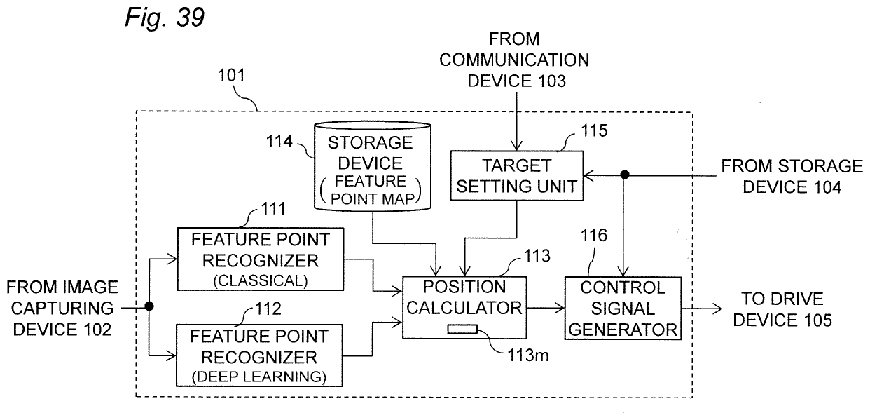

FIG. 39 is a block diagram illustrating a configuration of the control apparatus 101 in FIG. 38. The control apparatus 101 is provided with: a feature point recognizer 111, a feature point recognizer 112, a position calculator 113, a storage device 114, a target setting unit 115, and a control signal generator 116.

The feature point recognizer 111 detects first feature points of roads and obstacles around the vehicle 100 by performing classical image processing on the captured image obtained by the image capturing device 102, the classical image processing being not based on deep learning. The feature point recognizer 111 may be configured, for example, in a manner similar to that of the feature point recognizer 11 in FIG. 6.

The feature point recognizer 112 detects second feature points of roads and obstacles around the vehicle 100 from the captured image using a deep learning model trained in advance based on a plurality of images of the roads and obstacles. The deep learning model may be trained based on a plurality of images obtained by capturing various roads or obstacles from a plurality of different positions. Further, the deep learning model may be trained based on a plurality of images obtained by capturing various roads or obstacles with a plurality of different illuminances. The feature point recognizer 112 may be configured, for example, in a manner similar to that of the feature point recognizer 12, so as to operate as the deep neural network in FIG. 7.

The storage device 114 stores in advance a first feature point map including positions and feature values of feature points of the roads or obstacles detected by performing image processing on a plurality of images of the roads or obstacles, the image processing being not based on deep learning, in a manner similar to that of the feature point recognizer 111. In addition, the storage device 114 stores in advance a second feature point map including positions and feature values of feature points of the roads or obstacles detected using a deep learning model trained in advance based on a plurality of images of the roads and obstacles, in a manner similar to that of the feature point recognizer 112. Each of the first and second feature point maps includes a plurality of map points and a plurality of key frames, related to the plurality of feature points included in the roads or obstacles. Each map point includes a position (three-dimensional coordinates) of a feature point of the road or obstacle in a world coordinate system (that is, a coordinate system of a fixed object, such as roads), a feature value of the feature point, and an index number of the feature point. The map points are generated based on a plurality of images obtained by capturing the roads or obstacles from a plurality of different positions. Each key frame indicates a status of the image capturing device 102 at which the roads or obstacles is captured from one of the plurality of different positions to generate the map points, and also indicates a captured image. That is, each key frame includes the position (three-dimensional coordinates) and the attitude of the image capturing device 102 in the world coordinate system, the positions (two-dimensional coordinates) and the feature values of the feature points in one of the images of the roads or obstacles, and the index numbers of the map points corresponding to the feature points in one of the images.

The target setting unit 115 sets some object near the vehicle 100 and expected to be included in a captured image obtained by the image capturing device 102, as a target object to which the vehicle 100 proceeds. The target object may include, for example, an intersection, a stop line on a road, a building, or other landmark. The target setting unit 115 may set a target object by referring to the map of surroundings of the vehicle 100 stored in the storage device 104, based on a control signal received from the external server apparatus via the communication device 103, the control signal including a destination of the vehicle 100 or others. The target setting unit 115 may store information regarding the target object setting, in the storage device 114.

The position calculator 113 calculates the position of the object in a camera coordinate system, based on the first feature points of the roads or obstacles detected by the feature point recognizer 111, and the second feature points of the roads or obstacles detected by the feature point recognizer 112, and with reference to the first and second feature point maps read from the storage device 114. At first, the position calculator 113 calculates the position of the object based on the first feature points and the first feature point map without referring to the second feature points and the second feature point map. When the position of the object can not be calculated based on the first feature points and the first feature point map without referring to the second feature points and the second feature point map, the position calculator 113 calculates the position of the object based on the first feature points, the first feature point map, the second feature points, and the second feature point map.

In addition, the position calculator 113 refers to a capturing condition indicating a position and an attitude of the image capturing device 102 at which the captured image is obtained, in order to calculate positions and directions of the roads or obstacles in the camera coordinate system. To this end, based on the first feature points and the first feature point map, the position calculator 113 calculates a first capturing condition indicating the position and the attitude of the image capturing device 102 at which the captured image is obtained, and performs matching between the first feature points detected from the captured image, and the feature points of the first feature point map. The first capturing condition indicates a position and an attitude of the image capturing device 102 in a work object coordinate system. In addition, based on the second feature points and the second feature point map, the position calculator 113 calculates a second capturing condition indicating the position and the attitude of the image capturing device 102 at which the captured image is obtained, and performs matching between the second feature points detected from the captured image, and the feature points of the second feature point map. The second capturing condition also indicates a position and an attitude of the image capturing device 102 in the work object coordinate system. The position calculator 113 includes a memory 113m that stores the first and second capturing conditions, and feature point matching results.

The control signal generator 116 refers to the map of surroundings of the vehicle 100 stored in the storage device 104, and outputs a control signal to the drive device 105, the control signal for moving the vehicle 100 to the position of the target object. As a result, the control apparatus 101 automatically controls the vehicle 100.

### [Operation of Fifth Embodiment]

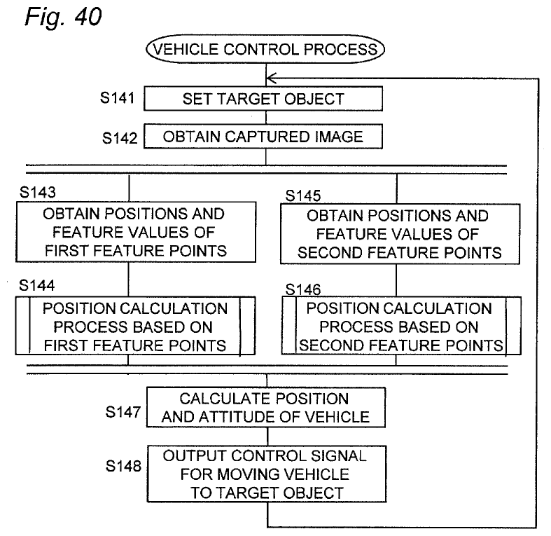

FIG. 40 is a flowchart illustrating a vehicle control process executed by the position calculator 113 in FIG. 39.

The position calculator 113 sets some object near the vehicle 100 and expected to be included in a captured image obtained by the image capturing device 102, as a target object to which the vehicle 100 proceeds (step S141).

The position calculator 113 obtains a captured image from the image capturing device 102 via the feature point recognizer 111 (step S142).

The position calculator 113 obtains positions and feature values of first feature points from the feature point recognizer 111 (step S143).

Next, the position calculator 113 executes a position calculation process based on first feature points (step S144). In this case, the position calculator 113 calculates a first capturing condition C1 based on the first feature points and the first feature point map, the first capturing condition C1 indicating the position and the attitude of the image capturing device 102 at which the captured image is obtained. In addition, the position calculator 113 performs matching between the first feature points detected from the captured image, and the feature points of the first feature point map. Step S144 is similar to the process in step S12 described with reference to FIG. 14, except for processing the first feature points and the first feature point map of the roads or obstacles, instead of the first feature points and the first feature point map of the circuit board 8.

In addition, the position calculator 113 obtains positions and feature values of second feature points from the feature point recognizer 112 (step S145).

Next, the position calculator 113 executes a position calculation process based on second feature points (step S146). In this case, the position calculator 113 calculates a second capturing condition C2 based on the second feature points and the second feature point map, the second capturing condition C2 indicating the position and the attitude of the image capturing device 102 at which the captured image is obtained. In addition, the position calculator 113 performs matching between the second feature points detected from the captured image, and the feature points of the second feature point map. Step S146 is similar to the process in step S15 described with reference to FIG. 22, except for processing the second feature points and the second feature point map of the roads or obstacles, instead of the second feature points and the second feature point map of the circuit board 8.

Steps S143 to S146 may be executed in parallel as illustrated in FIG. 40, or may be sequentially executed.

Next, the position calculator 113 calculates a position of the vehicle 100 in the world coordinate system (step S147).

Next, the control signal generator 116 outputs a control signal to the drive device 105, the control signal for moving the vehicle 100 to the position of the target object (step S148).

The control apparatus 101 according to the fifth embodiment is characterized by a combination of detection of feature points using the classical image processing, and detection of feature points using the deep learning model, in order to calculate the position of the object. In addition, the control apparatus 101 according to the fifth embodiment is characterized by a combination of the tracked feature point matching process, that is, the feature point matching in the region smaller than the entire captured image, and the global feature point matching process, that is, the feature point matching in the entire captured image, in order to calculate the position of the object. Consequently, according to the control apparatus 101 of the fifth embodiment, it is possible to accurately determine the position of the vehicle 100, even when the environmental conditions vary, without significantly increasing the processing time. In other words, it is possible to provide the control apparatus 101, that is robust to variations in environmental conditions and does not impair realtime performance.

### [Advantageous Effects and Others of Fifth Embodiment]

According to the fifth embodiment, a control apparatus 101 for controlling a conveyance apparatus that moves a first object is provided with: a target setting unit 115, a storage device 114, a feature point recognizer 111, a feature point recognizer 112, a position calculator 113, and a control signal generator 116. The target setting unit 115 sets a position of at least one target object in a second object. The storage device 114 stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The feature point recognizer 111 detects first feature points of the second object by performing the first image processing on a captured image including at least a part of the second object obtained by an image capturing device. The feature point recognizer 112 detects second feature points of the second object from the captured image using the first deep learning model. The position calculator 113 calculates a position of the target object based on the first feature points and the first feature point map without referring to the second feature points and the second feature point map. When the position of the target object can not be calculated based on the first feature points and the first feature point map without referring to the second feature points and the second feature point map, the position calculator 113 calculates the position of the target object based on the first feature points, the first feature point map, the second feature points, and the second feature point map. The control signal generator 116 generates a control signal for moving the first object to the position of the target object, based on the position of the target object and the position of the first object, and outputs the control signal to the conveyance apparatus.

With such a configuration, it is possible to control the robot arm apparatus to accurately determine the position of a moving object, such as a vehicle 100, and accurately move the moving object, even when environmental conditions vary, without significantly increasing the processing time.

According to the fifth embodiment, a vehicle 100 is provided with: a control apparatus 101, an image capturing device 102, and a drive device 105. The first object is the vehicle 100 itself.

With such a configuration, it is possible to accurately control traveling of the vehicle 100, even when environmental conditions vary, without significantly increasing the processing time.

### Other Embodiments

The input device and the display device may be integrated with the control apparatus for the robot arm apparatus. The control apparatus, the input device, and the display device may be integrated with the robot arm apparatus.

The image generator may output the three-dimensional plot of the feature point map as illustrated in FIG. 13, to the display device, such that the three-dimensional plot overlapped the captured image.

In the examples of the first and second embodiments, the holdable object is the power screwdriver 5, and the target object in the work object is the screw hole in the circuit board. However, the holdable object, the work object, and the target object are not limited thereto. The holdable object may be, for example, a soldering iron, a multimeter, a test tube, a pipette, a cotton swab, or the like. In the case where the holdable object is the soldering iron, the work object may be a circuit board, and the target object may be a circuit board or an electrode of an electronic component. In the case where the holdable object is a probe of the multimeter, the work object may be an electronic device, and the target object may be an electrode. In the case where the holdable object is the test tube, the work object may be a rack for test tubes, and the target object may be a hole in the rack for test tubes. In the case where the holdable object is the pipette, the work object may be a container into which a medicine or the like is put in or taken out by the pipette, and the target object may be an opening of the container. In the case where the holdable object is the cotton swab, the work object may be a patient in contact with the cotton swab, and the target object may be a site of the patient in contact with the cotton swab. Also in these cases, even when at least one of the holdable object and the work object does not have a known fixed position in the world coordinate system, it is possible to control the robot arm apparatus to accurately perform the work on the work object using the holdable object.

In the above description, the case where the holdable object is held such that the direction of the holdable object (power screwdriver 5) matches the direction of the target object (screw hole 82) has been described. Alternatively, the holdable object may be held such that the holdable object has other predetermined angles with respect to the target object. For example, in the case where the holdable object is the soldering iron or the multimeter, the holdable object may be held obliquely with respect to the circuit board or the electrode.

When the work object is flat, and the holdable object moves translationally with respect to the work object without changing the direction, the step of calculating the directions of the work object and the holdable object may be omitted.

In the present specification, the “tip of the holdable object” is not limited to a sharp portion like the tip 5a of the power screwdriver 5, but the term means a distal end of the holdable object as seen from the main body of the robot arm apparatus 4. The tip of the holdable object may be a hammer head, a bottom surface of a container such as a beaker, a bottom surface of a rectangular member, or the like, depending on the shape of the holdable object.

In the example of the third embodiment, the case where the target object in the work object is the switch of the panel has been described, but the work object and the target object are not limited thereto. For example, the work object may be a circuit board, and the target object may be a screw hole or an electrode. In addition, the work object may be a container, and the target object may be an opening of the container. In addition, the work object may be a patient, and the target object may be a site of the patient. According to the types of the work object and the target object, the robot arm apparatus is provided with a device (such as a power screwdriver) integrated with the tip of the arm.

In the first to third embodiments, the case where the tip 5a of the power screwdriver 5 or the tip 4da of the end effector 4d is moved to the position of the target object has been described. However, the technique according to these embodiments is also applicable to a case where any portion of a holdable object or an arm is moved to the position of the target object.

In the first to third embodiments, one image capturing device fixed to the robot arm apparatus has been used. Alternatively, one or more image capturing devices fixed to a position(s) other than the robot arm apparatus, for example, ceiling, floor, or wall, may be used. For example, the plurality of image capturing devices may be disposed to capture different portions of a work object. In this case, the control apparatus can selectively obtain a captured image including at least a part of the work object and at least a part of the holdable object, from the plurality of image capturing devices. Therefore, it is possible to improve the degree of freedom in obtaining a captured image, compared with the case of using only one image capturing device.

In the first to third embodiments, the case where the control apparatus automatically controls the robot arm apparatus has been described. Alternatively, the positions of the work object and the holdable object calculated by the control apparatus may be used to support a user's manual control of the robot arm apparatus. In this case, the image generator generates a radar chart indicating a distance of the tip of the holdable object with respect to the target object, and outputs the radar chart to the display device such that the radar chart overlaps the captured image. By referring to the radar chart displayed on the display device, a user can provide user inputs to the control apparatus via the input device, the user inputs for moving the tip of the holdable object to the position of the target object. As described in the first embodiment and others, the control signal generator outputs a first control signal to the robot arm apparatus based on the captured image obtained by the image capturing device, the first control signal for moving the tip of the holdable object to the position of the target object. Further, the control signal generator outputs a second control signal to the robot arm apparatus based on the user inputs obtained via the input device, the second control signal for moving the tip of the holdable object to the position of the target object.

In the fifth embodiment, the control apparatus may be provided outside a vehicle. In this case, the control apparatus may obtain a captured image from the image capturing device of the vehicle via a wireless communication line, calculate a position of a target object, and transmit a control signal to a drive device of the vehicle via the wireless communication line, the control signal for moving the vehicle to the position of the target object.

The above-described embodiments and modified embodiments may be combined in any manner.

If the robot arm apparatus can hold the holdable object such that the image capturing device has a known position with respect to the tip of the robot arm apparatus, the control apparatus according to the third embodiment may control a robot arm apparatus provided with a hand that holds the holdable object. The robot arm apparatus may hold the holdable object such that the image capturing device has a known position with respect to the tip of the robot arm apparatus, for example, by providing the hand with a guide to be engaged with the holdable object. In this case, the control apparatus reads the position and the direction of the holdable object stored in the storage device in advance, instead of calculating the position and the direction of the holdable object based on the captured image.

### [Summary of Embodiments]

According to a first aspect of the present disclosure, a control apparatus for controlling a conveyance apparatus that moves a first object is provided with: a target setting unit, a first storage device, a first feature point recognizer, a second feature point recognizer, a first position calculator, and a control signal generator. The target setting unit sets a position of at least one target object in a second object. The first storage device stores a first feature point map and a second feature point map in advance, the first feature point map including positions of feature points of the second object detected by performing first image processing on a plurality of images of the second object, the first image processing being not based on deep learning, and the second feature point map including positions of feature points of the second object detected using a first deep learning model trained in advance based on a plurality of images of the second object. The first feature point recognizer detects first feature points of the second object by performing the first image processing on a captured image including at least a part of the second object obtained by an image capturing device. The second feature point recognizer detects second feature points of the second object from the captured image using the first deep learning model. The first position calculator calculates a position of the target object based on the first feature points and the first feature point map without referring to the second feature points and the second feature point map. When the position of the target object can not be calculated based on the first feature points and the first feature point map without referring to the second feature points and the second feature point map, the first position calculator calculates the position of the target object based on the first feature points, the first feature point map, the second feature points, and the second feature point map. The control signal generator generates a control signal for moving the first object to the position of the target object, based on the position of the target object and the position of the first object, and outputs the control signal to the conveyance apparatus.

According to a second aspect of the present disclosure, in the first aspect of the present disclosure, the first feature point map includes a plurality of first key frames, the first key frames indicating positions and attitudes of the image capturing device in a coordinate system of the second object, and indicating positions and feature values of feature points in a plurality of images of the second object. The first position calculator calculates a first capturing condition based on the first feature points and the first feature point map, the first capturing condition indicating a position and an attitude of the image capturing device at which the captured image is obtained. When a current first capturing condition corresponding to a current captured image can be predicted based on a previous first capturing condition corresponding to a previous captured image, the first position calculator predicts positions of first projected points in the current captured image, the first projected points corresponding to the first feature points included in the previous captured image, and searches for the first feature points corresponding to the first projected points, in a region including the first projected points, the region being smaller than the entire current captured image. When the current first capturing condition can not be predicted based on the previous first capturing condition, the first position calculator searches for, in the entire current captured image, the first feature points corresponding to the feature points included in the first key frame most similar to the current captured image. The first position calculator determines the current first capturing condition based on a number of the first feature points corresponding to the first projected points, or a number of the first feature points corresponding to the feature points included in the first key frame, and calculates the position of the target object based on the current first capturing condition.

According to a third aspect of the present disclosure, in the second aspect of the present disclosure, the second feature point map includes a plurality of second key frames, the second key frames indicating positions and attitudes of the image capturing device in a coordinate system of the second object, and indicating positions and feature values of feature points in a plurality of images of the second object. The first position calculator calculates a second capturing condition based on the second feature points and the second feature point map, the second capturing condition indicating a position and an attitude of the image capturing device at which the captured image is obtained. When a current second capturing condition corresponding to a current captured image can be predicted based on a previous second capturing condition corresponding to a previous captured image, the first position calculator predicts positions of second projected points in the current captured image, the second projected points corresponding to the second feature points included in the previous captured image, and searches for the second feature points corresponding to the second projected points, in a region including the second projected points, the region being smaller than the entire current captured image. When the current second capturing condition can not be predicted based on the previous second capturing condition, the first position calculator searches for, in the entire current captured image, the second feature points corresponding to the feature points included in the second key frame most similar to the current captured image. The first position calculator determines the current second capturing condition based on a number of the second feature points corresponding to the second projected points, or a number of the second feature points corresponding to the feature points included in the second key frame.

According to a fourth aspect of the present disclosure, in the third aspect of the present disclosure, when the position of the target object can not be calculated based on the first feature points and the first feature point map without referring to the second feature points and the second feature point map, the first position calculator calculates the position of the target object based on the current second capturing condition.

According to a fifth aspect of the present disclosure, in the fourth aspect of the present disclosure, when the position of the target object can not be calculated based on the first feature points and the first feature point map without referring to the second feature points and the second feature point map, the first position calculator determines, as a reference key frame, the first key frame having the position and the attitude most similar to the position and the attitude of the current second capturing condition. In this case, the first position calculator further predicts the current first capturing condition corresponding to the current captured image, based on the reference key frame. In this case, the first position calculator further predicts positions of third projected points in the current captured image, the third projected points corresponding to the feature points included in the reference key frame. In this case, the first position calculator further searches for the first feature points corresponding to the third projected points, in a region including the third projected points, the region being smaller than the entire current captured image. In this case, the first position calculator further determines the current first capturing condition based on a number of the first feature points corresponding to the third projected points, and calculates the position of the target object based on the current first capturing condition.

According to a sixth aspect of the present disclosure, in one of the first to fifth aspects of the present disclosure, the first deep learning model is trained based on the plurality of images obtained by capturing the second object from a plurality of different positions.

According to a seventh aspect of the present disclosure, in one of the first to sixth aspects of the present disclosure, the first deep learning model is trained based on the plurality of images obtained by capturing the second object with a plurality of different illuminances.

According to an eighth aspect of the present disclosure, in one of the first to seventh aspects of the present disclosure, the first position calculator obtains an environmental parameter including at least one of illuminance, time, date, and weather. When the current environmental parameter satisfies a predetermined condition, the first position calculator calculates the position of the target object based on the first feature points, the first feature point map, the second feature points, and the second feature point map.

According to a ninth aspect of the present disclosure, in one of the first to eighth aspects of the present disclosure, the captured image further includes at least a part of the first object. The control apparatus is further provided with a second position calculator that calculates the position of the first object based on the captured image.

According to a tenth aspect of the present disclosure, in the ninth aspect of the present disclosure, the control apparatus is further provided with a marker recognizer that detects a marker from the captured image, the marker being fixed at a known position of the first object, the marker having a pattern formed such that a position of the marker in a coordinate system of the image capturing device can be calculated. The second position calculator calculates the position of the first object based on the marker.

According to an eleventh aspect of the present disclosure, in the ninth aspect of the present disclosure, the control apparatus is further provided with: a second storage device, a third feature point recognizer, and a fourth feature point recognizer. The second storage device stores a third feature point map and a fourth feature point map in advance, the first feature point map the third feature point map including positions of feature points of the first object detected by performing second image processing on a plurality of images of the first object, the second image processing being not based on deep learning, and the fourth feature point map including positions of feature points of the first object detected using a second deep learning model that is trained in advance based on a plurality of images of the first object. The third feature point recognizer detects third feature points of the first object by performing the second image processing on the captured image. The fourth feature point recognizer detects fourth feature points of the first object from the captured image using the second deep learning model. The second position calculator calculates the position of the first object based on the third feature points and the third feature point map without referring to the fourth feature points and the fourth feature point map, and when the position of the first object can not be calculated based on the third feature points and the third feature point map without referring to the fourth feature points and the fourth feature point map, the second position calculator calculates the position of the first object based on the third feature points, the third feature point map, the fourth feature points, and the fourth feature point map.

According to a twelfth aspect of the present disclosure, in one of the ninth to eleventh aspects of the present disclosure, the first position calculator further calculates a direction of the target object based on the feature points of the second object. The second position calculator further calculates a direction of the first object based on the captured image. The control signal further includes angle information based on the direction of the target object and the direction of the first object.

According to a thirteenth aspect of the present disclosure, in one of the ninth to twelfth aspects of the present disclosure, the first position calculator calculates a position of the target object in a coordinate system of the image capturing device. The second position calculator calculates a position of the first object in the coordinate system of the image capturing device. The control signal generator transforms the position of the target object and the position of the first object in the coordinate system of the image capturing device, into positions in a coordinate system of the conveyance apparatus, generates a control signal for moving the first object to the position of the target object, based on the transformed position of the target object and the transformed position of the first object, and outputs the control signal to the conveyance apparatus.

According to a fourteenth aspect of the present disclosure, in one of the first to eighth aspects of the present disclosure, the first object is fixed to a predetermined part of the conveyance apparatus. The image capturing device is fixed at a known position with respect to the predetermined part of the conveyance apparatus.

According to a fifteenth aspect of the present disclosure, a conveyance system is provided with: a conveyance apparatus; an image capturing device; and the control apparatus according to one of the first to fourteenth aspects of the present disclosure.

According to a sixteenth aspect of the present disclosure, in the fifteenth aspect of the present disclosure, the conveyance apparatus is a robot arm apparatus that holds the first object.

According to a seventeenth aspect of the present disclosure, in the fifteenth aspect of the present disclosure, the conveyance apparatus is a vehicle provided with a drive device. The first object is the conveyance apparatus.

According to an eighteenth aspect of the present disclosure, a control method for controlling a conveyance apparatus that moves a first object is provided. the control method includes setting a position of at least one target object in a second object. The control method includes reading, from a storage device, a first feature point map including positions of feature points of the second object detected by performing first image processing on a plurality of images of the second object, the first image processing being not based on deep learning. The control method includes reading, from the storage device, a second feature point map including positions of feature points of the second object detected using a first deep learning model that is trained in advance based on a plurality of images of the second object. The control method includes detecting first feature points of the second object by performing the first image processing on a captured image including at least a part of the second object obtained by an image capturing device. The control method includes detecting second feature points of the second object from the captured image using the first deep learning model. The control method includes calculating a position of the target object based on the first feature points and the first feature point map without referring to the second feature points and the second feature point map, and when the position of the target object can not be calculated based on the first feature points and the first feature point map without referring to the second feature points and the second feature point map, calculating the position of the target object based on the first feature points, the first feature point map, the second feature points, and the second feature point map. The control method includes generating a control signal for moving the first object to the position of the target object, based on the position of the target object and the position of the first object, and outputting the control signal to the conveyance apparatus.

The control apparatuses and the conveyance systems according to respective aspects of the present disclosure are applicable to industrial or medical robot arm apparatuses, automatic guided vehicles, and the like.

What is claimed is:

1. A control apparatus for controlling a conveyance apparatus that moves a first object, the control apparatus comprising: a processing circuit and a storage device,
wherein the storage device stores a first feature point map and a second feature point map in advance, the first feature point map including positions of feature points of a second object detected by performing first image processing on a plurality of images of the second object, the first image processing being not based on deep learning, and the second feature point map including positions of feature points of the second object detected using a first deep learning model trained in advance based on a plurality of images of the second object;
wherein the processing circuit sets a position of at least one target object in the second object;
wherein the processing circuit detects first feature points of the second object by performing the first image processing on a captured image including at least a part of the second object obtained by an image capturing device;
wherein the processing circuit detects second feature points of the second object from the captured image using the first deep learning model;
wherein the processing circuit calculates a position of the target object based on the first feature points and the first feature point map without referring to the second feature points and the second feature point map, and when the position of the target object can not be calculated based on the first feature points and the first feature point map without referring to the second feature points and the second feature point map, the processing circuit calculates the position of the target object based on the first feature points, the first feature point map, the second feature points, and the second feature point map; and
wherein the processing circuit generates a control signal for moving the first object to the position of the target object, based on the position of the target object and the position of the first object, and outputs the control signal to the conveyance apparatus.

2. The control apparatus as claimed in claim 1,
wherein the first feature point map includes a plurality of first key frames, the first key frames indicating positions and attitudes of the image capturing device in a coordinate system of the second object, and indicating positions and feature values of feature points in a plurality of images of the second object,
wherein the processing circuit calculates a first capturing condition based on the first feature points and the first feature point map, the first capturing condition indicating a position and an attitude of the image capturing device at which the captured image is obtained;
wherein, when a current first capturing condition corresponding to a current captured image can be predicted based on a previous first capturing condition corresponding to a previous captured image, the processing circuit predicts positions of first projected points in the current captured image, the first projected points corresponding to the first feature points included in the previous captured image, and searches for the first feature points corresponding to the first projected points, in a region including the first projected points, the region being smaller than the entire current captured image;
wherein, when the current first capturing condition can not be predicted based on the previous first capturing condition, the processing circuit searches for, in the entire current captured image, the first feature points corresponding to the feature points included in the first key frame most similar to the current captured image; and
wherein the processing circuit determines the current first capturing condition based on a number of the first feature points corresponding to the first projected points, or a number of the first feature points corresponding to the feature points included in the first key frame, and calculates the position of the target object based on the current first capturing condition.

3. The control apparatus as claimed in claim 2,
wherein the second feature point map includes a plurality of second key frames, the second key frames indicating positions and attitudes of the image capturing device in a coordinate system of the second object, and indicating positions and feature values of feature points in a plurality of images of the second object,
wherein the processing circuit calculates a second capturing condition based on the second feature points and the second feature point map, the second capturing condition indicating a position and an attitude of the image capturing device at which the captured image is obtained;
wherein, when a current second capturing condition corresponding to a current captured image can be predicted based on a previous second capturing condition corresponding to a previous captured image, the processing circuit predicts positions of second projected points in the current captured image, the second projected points corresponding to the second feature points included in the previous captured image, and searches for the second feature points corresponding to the second projected points, in a region including the second projected points, the region being smaller than the entire current captured image;
wherein, when the current second capturing condition can not be predicted based on the previous second capturing condition, the processing circuit searches for, in the entire current captured image, the second feature points corresponding to the feature points included in the second key frame most similar to the current captured image; and
wherein the processing circuit determines the current second capturing condition based on a number of the second feature points corresponding to the second projected points, or a number of the second feature points corresponding to the feature points included in the second key frame.

4. The control apparatus as claimed in claim 3,
wherein, when the position of the target object can not be calculated based on the first feature points and the first feature point map without referring to the second feature points and the second feature point map, the processing circuit calculates the position of the target object based on the current second capturing condition.

5. The control apparatus as claimed in claim 4,
wherein, when the position of the target object can not be calculated based on the first feature points and the first feature point map without referring to the second feature points and the second feature point map, the processing circuit:
determines, as a reference key frame, the first key frame having the position and the attitude most similar to the position and the attitude of the current second capturing condition;
predicts the current first capturing condition corresponding to the current captured image, based on the reference key frame;
predicts positions of third projected points in the current captured image, the third projected points corresponding to the feature points included in the reference key frame;
searches for the first feature points corresponding to the third projected points, in a region including the third projected points, the region being smaller than the entire current captured image; and
determines the current first capturing condition based on a number of the first feature points corresponding to the third projected points, and calculates the position of the target object based on the current first capturing condition.

6. The control apparatus as claimed in claim 1,
wherein the first deep learning model is trained based on the plurality of images obtained by capturing the second object from a plurality of different positions.

7. The control apparatus as claimed in claim 1,
wherein the first deep learning model is trained based on the plurality of images obtained by capturing the second object with a plurality of different illuminances.

8. The control apparatus as claimed in claim 1,
wherein the processing circuit obtains an environmental parameter including at least one of illuminance, time, date, and weather, and
wherein, when the current environmental parameter satisfies a predetermined condition, the processing circuit calculates the position of the target object based on the first feature points, the first feature point map, the second feature points, and the second feature point map.

9. The control apparatus as claimed in claim 1,
wherein the captured image further includes at least a part of the first object, and
wherein the processing circuit further calculates the position of the first object based on the captured image.

10. The control apparatus as claimed in claim 9,
wherein the processing circuit further detects a marker from the captured image, the marker being fixed at a known position of the first object, the marker having a pattern formed such that a position of the marker in a coordinate system of the image capturing device can be calculated, and
wherein the processing circuit calculates the position of the first object based on the marker.

11. The control apparatus as claimed in claim 9,
wherein the storage device further stores a third feature point map and a fourth feature point map in advance, the first feature point map the third feature point map including positions of feature points of the first object detected by performing second image processing on a plurality of images of the first object, the second image processing being not based on deep learning, and the fourth feature point map including positions of feature points of the first object detected using a second deep learning model that is trained in advance based on a plurality of images of the first object,
wherein the processing circuit further detects third feature points of the first object by performing the second image processing on the captured image,
wherein the processing circuit further detects fourth feature points of the first object from the captured image using the second deep learning model, and
wherein the processing circuit further calculates the position of the first object based on the third feature points and the third feature point map without referring to the fourth feature points and the fourth feature point map, and when the position of the first object can not be calculated based on the third feature points and the third feature point map without referring to the fourth feature points and the fourth feature point map, the processing circuit further calculates the position of the first object based on the third feature points, the third feature point map, the fourth feature points, and the fourth feature point map.

12. The control apparatus as claimed in claim 9,
wherein the processing circuit further calculates a direction of the target object based on the feature points of the second object,
wherein the processing circuit further calculates a direction of the first object based on the captured image, and
wherein the control signal further includes angle information based on the direction of the target object and the direction of the first object.

13. The control apparatus as claimed in claim 9,
wherein the processing circuit calculates a position of the target object in a coordinate system of the image capturing device, and
wherein the processing circuit calculates a position of the first object in the coordinate system of the image capturing device, and
wherein the processing circuit transforms the position of the target object and the position of the first object in the coordinate system of the image capturing device, into positions in a coordinate system of the conveyance apparatus, generates a control signal for moving the first object to the position of the target object, based on the transformed position of the target object and the transformed position of the first object, and outputs the control signal to the conveyance apparatus.

14. The control apparatus as claimed in claim 1,
wherein the first object is fixed to a predetermined part of the conveyance apparatus, and
wherein the image capturing device is fixed at a known position with respect to the predetermined part of the conveyance apparatus.

15. A conveyance system comprising:
a conveyance apparatus;
an image capturing device; and
a control apparatus for controlling the conveyance apparatus that moves a first object, the control apparatus comprising: a processing circuit and a storage device,
wherein the storage device stores a first feature point map and a second feature point map in advance, the first feature point map including positions of feature points of a second object detected by performing first image processing on a plurality of images of the second object, the first image processing being not based on deep learning, and the second feature point map including positions of feature points of the second object detected using a first deep learning model trained in advance based on a plurality of images of the second object;
wherein the processing circuit sets a position of at least one target object in the second object;
wherein the processing circuit detects first feature points of the second object by performing the first image processing on a captured image including at least a part of the second object obtained by an image capturing device;
wherein the processing circuit detects second feature points of the second object from the captured image using the first deep learning model;
wherein the processing circuit calculates a position of the target object based on the first feature points and the first feature point map without referring to the second feature points and the second feature point map, and when the position of the target object can not be calculated based on the first feature points and the first feature point map without referring to the second feature points and the second feature point map, the processing circuit calculates the position of the target object based on the first feature points, the first feature point map, the second feature points, and the second feature point map; and
wherein the processing circuit generates a control signal for moving the first object to the position of the target object, based on the position of the target object and the position of the first object, and outputs the control signal to the conveyance apparatus.

16. The conveyance system as claimed in claim 15,
wherein the conveyance apparatus is a robot arm apparatus that holds the first object.

17. The conveyance system as claimed in claim 15,
wherein the conveyance apparatus is a vehicle comprising a drive device, and
wherein the first object is the conveyance apparatus.

18. A control method for controlling a conveyance apparatus that moves a first object, the control method comprising:
setting a position of at least one target object in a second object;
reading, from a storage device, a first feature point map including positions of feature points of the second object detected by performing first image processing on a plurality of images of the second object, the first image processing being not based on deep learning;
reading, from the storage device, a second feature point map including positions of feature points of the second object detected using a first deep learning model that is trained in advance based on a plurality of images of the second object;
detecting first feature points of the second object by performing the first image processing on a captured image including at least a part of the second object obtained by an image capturing device;
detecting second feature points of the second object from the captured image using the first deep learning model;
calculating a position of the target object based on the first feature points and the first feature point map without referring to the second feature points and the second feature point map, and when the position of the target object can not be calculated based on the first feature points and the first feature point map without referring to the second feature points and the second feature point map, calculating the position of the target object based on the first feature points, the first feature point map, the second feature points, and the second feature point map; and
generating a control signal for moving the first object to the position of the target object, based on the position of the target object and the position of the first object, and outputting the control signal to the conveyance apparatus.
